(19) United States
(12) Patent Application Publication
(10) Pub. No.: US 2026/0052146 A1
(43) Pub. Date: Feb. 19, 2026

(54) PROXY-BASED TECHNIQUES FOR AUTHORIZING CROSS-REALM REQUESTS

(71) Applicant: Oracle International Corporation, Redwood Shores, CA (US)

(72) Inventors: Ayush Ruia, Kirkland, WA (US); Girish Nagaraja, Sammamish, WA (US); Christian Augustine Csar, Seattle, WA (US); Shrey Arora, Seattle, WA (US); Thomas James Andrews, Seattle, WA (US); Shoaib Sheriff, Jacksonville, FL (US); Martinus Petrus Lambertus van den Dungen, Snohornish, WA (US)

(73) Assignee: Oracle International Corporation, Redwood Shores, CA (US)

(21) Appl. No.: 19/296,761

(22) Filed: Aug. 11, 2025

Related U.S. Application Data
(60) Provisional application No. 63/682,717, filed on Aug. 13, 2024.

(51) Int. Cl. H04L 9/40

(52) U.S. Cl. CPC H04L 63/0869; H04L 63/0281; H04L 63/102

(57) ABSTRACT

Techniques are disclosed for using a proxy service to generate resource principals corresponding to a cross-realm request. A request to perform an operation in a target realm (TR) may be received by the proxy service of a host realm (HR). The request may comprise identity data that indicates an identifier of the requestor in one or more identity realms (e.g., in at least the TR). The proxy service of the HR may establish a trusted connection with a proxy service of the TR. The proxy service of the HR may transmit request data that indicates the identity of the requestor within the TR, causing the proxy service in the TR to generate a resource principal object corresponding to the identity of the requestor in the TR, whereby the resource principal object is used to execute (or to attempt execution of) the requested operation in the TR.

### CROSS-REFERENCE TO RELATED APPLICATIONS

This non-provisional patent application claims priority to U.S. Provisional Patent Application 63/682,717, filed Aug. 13, 2024, entitled “Enforcing Access Management Policies across Identity Boundaries,” the disclosure of which is herein incorporated by reference in its entirety for all purposes.

### BACKGROUND

In a distributed computing environment such as an environment that includes a computing platform operating under an IaaS cloud service model, various entities may request access permission to protected resources. The level of access can vary among entities. For instance, different users within a tenancy may have access privileges that depend on their user role (e.g., human resources, administrators, sales, etc.). Thus, access control can be based upon user identity. In addition to human users, entities that require access to resources may include compute instances (e.g., virtual or bare metal machines). Compute instances can be provisioned and managed through the cloud infrastructure, such as Oracle Cloud Infrastructure (OCI).

As another example, a resource within a particular tenancy or logical container may at times request access to another resource within the tenancy/logical container, where the other resource is protected. Like human users, instances can have identities assigned to them. Within an identity and access management (IAM) service provided as part of a cloud platform, such entities are sometimes referred to as “principals.” A principal is an entity that can be permitted, based on the identity of the principal, to interact with other resources in a cloud computing environment (e.g., to perform a read, a write, or a service-related operation).

Identity of an entity is managed by a single IAM system within an identity boundary (e.g., a realm). The entity is not known within other realms. However, there are use cases in which it may be desirable for a resource in one realm (e.g., a corporate realm) to request access a resource within a different realm (e.g., a target realm). These cross-realm requests are problematic as the requesting resource's identity is unknown within the target realm. Previous attempts to address these problems lack the ability to enact fine-grained authorization policies for authorizing these access requests.

### BRIEF SUMMARY

In the following description, for the purposes of explanation, specific details are set forth in order to provide a thorough understanding of certain embodiments. However, it will be apparent that various embodiments may be practiced without these specific details. The figures and description are not intended to be restrictive.

Some embodiments may include a method. The method may comprise receiving, by a computing component of a target realm of a cloud-computing environment, a cross-realm request to perform an operation in a tenancy of the target realm. In some embodiments, the operation is associated with a service resource. The cross-realm request may be initiated from a second computing component of a host realm that is different from the target realm. The method may comprise generating, by the computing component of the target realm, a resource principal checker corresponding to the computing component and the service resource. The method may comprise authorizing, by the computing component of the target realm, the operation of the cross-realm request based at least in part on determining, using the resource principal checker and a set of predefined policies, that the computing component is authorized to generate a resource principal for the service resource within the tenancy of the target realm. The method may comprise generating, by the computing component of the target realm, the resource principal for the service resource. The method may comprise performing, by the computing component, the operation requested by the cross-realm request using the resource principal for the service resource.

In some embodiments, generating the resource principal checker comprises 1) generating a resource principal token (RPT) corresponding to the computing component and the service resource, and 2) exchanging the RPT for a corresponding resource principal session token (RPST) based at least in part on authenticating an identity of the computing component using the RPT. In some embodiments, the resource principal checker comprises the RPST.

In some embodiments, authorizing the operation comprises 1) generating a resource principal token (RPT) corresponding to the service resource, 2) exchanging the RPT for a corresponding resource principal session token (RPST), and 3) determining, using the RPT and the one or more access policies, that the service resource is authorized to manage resources within the tenancy of the target realm.

In some embodiments, the computing component is a regional component of an infrastructure and application release service. In some embodiments, the operation of the cross-realm request is associated with performing an infrastructure release or an application release within the tenancy of the target realm.

In some embodiments, the tenancy and the service resource are associated with a service.

In some embodiments, the cross-realm request may be received during a data center build that is associated with building a plurality of services in the target realm. In some embodiments, the cross-realm request is received from a control plane component of the host realm.

In some embodiments, the service resource is 1) a flock configuration file specifying a desired state corresponding to an infrastructure release or application release that is associated with a service, or 2) a Service Plan and Manifest that specifies infrastructure releases and application releases to be performed when building the service.

A second method is disclosed. The second method may comprise receiving, by a first service in a target realm of a cloud-computing environment, a request to perform an operation in the target realm. In some embodiments, the request may be initiated by a calling entity in a host realm that differs from the target realm. In some embodiments, the request comprises an identifier of the calling entity in the target realm. The second method may comprise generating, by the first service in the target realm utilizing the identifier of the calling entity from the request, a resource principal token corresponding to the calling entity. The second method may comprise requesting, by the first service in the target realm utilizing the resource principal token corresponding to the calling entity, a resource principal session token corresponding to the calling entity and comprising a custom claim that specifies the identifier for the calling entity in the target realm. The second method may comprise determining, by the first service in the target realm using the resource principal session token corresponding to the calling entity, that the calling entity is authorized to perform the operation in the target realm. The second method may comprise executing the operation in the target realm, the operation being executed by the first service on behalf of the calling entity.

In some embodiments, determining that the calling entity is authorized to perform the operation comprises: 1) transmitting the resource principal token corresponding to the calling entity to an identity access management service of the target realm, and 2) receiving the resource principal session token from the identity access management service of the target realm.

In some embodiments, the identifier of the request is provided in a map or a header. In some embodiments, the resource principal token generated by the first service and corresponding to the calling entity comprises the custom claim that includes the identifier for the calling entity in the target realm, the identifier for the calling entity being obtained from the map.

In some embodiments, the request is transmitted to the first service by a second service of the host realm, the second service being different from the calling entity that initiated the request.

In some embodiments, the second service overwrites a field of an authentication header of the request with the identifier for the calling entity in the target realm. In some embodiments, the second service selects the identifier for the calling entity from a plurality of identifiers associated with the calling entity and corresponding to a plurality of corresponding realms that comprises the target realm. In some embodiments, the plurality of identifiers associated with the calling entity is provided to the second service by the calling entity in the host realm.

A third method is disclosed. The third method may comprise receiving, by a proxy service of a first identity realm, a request to perform an operation in a second identity realm. In some embodiments, the request comprises identity data that is associated with a requestor of the request. The identity data may indicate a respective identity of the requestor in one or more identity realms. The third method may comprise establishing, by the proxy service of the first identity realm with a proxy service of the second identity realm, a trusted connection. The third method may comprise identifying, by the proxy service of the first identity realm and from the identity data, an identity of the requestor in the second identity realm. The third method may comprise transmitting, by the proxy service of the first identity realm to the proxy service of the second identity realm, request data indicating the identity of the requestor in the second identity realm and the operation being requested. In some embodiments, transmitting the request data causes the proxy service of the second identity realm to generate a resource principal object with which execution of the operation is attempted. The resource principal object may correspond to the identity of the requestor in the second identity realm.

In some embodiments, the proxy service of the first identity realm and the proxy service of the second identity realm are associated with a centralized cross-realm service.

In some embodiments, the trusted connection is established based at least in part on mutual authentication of the proxy service of the first identity realm and the proxy service of the second identity realm. In some embodiments, the mutual authentication may be performed based at least in part on a first credential that is associated with the centralized cross-realm service or a second credential that is provided by the requestor.

In some embodiments, the proxy service of the second identity realm provides the resource principal object to a second service of the second identity realm. In some embodiments, the second service of the second identity realm authorizes the execution of the operation using the resource principal object generated by the proxy service in the second identity realm.

In some embodiments, the third method comprises 1) receiving, by the proxy service of the first identity realm, the resource principal object generated by the proxy service of the second identity realm, and 2) providing, by the proxy service of the first identity realm to the requestor. In some embodiments, the resource principal object is generated by the proxy service of the second identity realm. In some embodiments, providing the requestor with the resource principal object configures the requestor to perform subsequent operations with the second service of the second identity realm via an additional trusted connection between the requestor and the second service of the second identity realm.

In some embodiments, the identity data is provided in the request as a map or a custom claim.

A computing device is disclosed. The computing device may comprise one or more processors and one or more memories storing computer-executable instructions that, when executed by the one or more processors, cause the one or more processors to perform any suitable method or operation described herein.

A non-transitory computer-readable medium is disclosed. The non-transitory computer-readable medium may comprise one or more memories storing computer-executable instructions that, when executed by one or more processors, cause the one or more processors to perform any suitable method or operation described herein.

Systems, computing devices, and non-transitory computer-readable media are disclosed, each of which may comprise one or more memories on which computer-executable instructions corresponding to the methods disclosed herein may be stored. The instructions may be executed by one or more processors of the disclosed systems and devices to execute the methods disclosed herein. One or more computer programs can be configured to perform particular operations or actions corresponding to the described methods by virtue of including computer-executable instructions that, when executed by one or more processors, cause the one or more processors to perform the actions.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an environment in which an example Cloud Infrastructure Orchestration System (CIOS may operate to dynamically bootstrap services in a region, in accordance with at least one embodiment.

FIG. 2 is a block diagram for illustrating an environment and method for building a virtual bootstrap environment (ViBE), in accordance with at least one embodiment.

FIG. 3 is a block diagram for illustrating an environment and method for bootstrapping services to a target region utilizing the ViBE, in accordance with at least one embodiment.

FIG. 4 is a block diagram of an environment in which another example Cloud Infrastructure Orchestration System (CIOS may operate to dynamically bootstrap services in a region), in accordance with at least one embodiment.

FIG. 5 is a block diagram for illustrating an environment and another method for building a virtual bootstrap environment (ViBE), in accordance with at least one embodiment.

FIG. 6 is a block diagram for illustrating another environment and another method for bootstrapping services to a target region utilizing the ViBE, in accordance with at least one embodiment.

FIG. 7 is a block diagram depicting relationships between portions of a service plan and manifest, in accordance with at least one embodiment.

FIG. 8 is a simplified block diagram of an example cloud computing environment, in accordance with at least one embodiment.

FIG. 9 is a block diagram illustrating an example environment in which a user's identity is provided in two realms, in accordance with at least one embodiment.

FIG. 10 is a flow diagram illustrating an example method for authorizing modifications by an entity within a given execution tenancy, in accordance with at least one embodiment.

FIG. 11 is a flow diagram illustrating another example method 1100 for authorizing modifications by an entity within a given execution tenancy, in accordance with at least one embodiment.

FIG. 12 is a block diagram illustrating an example mapping, in accordance with at least one embodiment.

FIG. 13 is a block diagram depicting a conventional approach to cross-realm communication.

FIG. 14 is a block diagram depicting a process for projecting an identity of an entity across identity boundaries (e.g., between two identity realms), in accordance with at least one embodiment.

FIG. 15 is a block diagram depicting a process for projecting an identity of a machine caller across identity boundaries (e.g., between two identity realms), in accordance with at least one embodiment.

FIG. 16 is a block diagram depicting an example of the process of FIG. 13 for projecting an identity of a machine caller across identity boundaries (e.g., between two identity realms), in accordance with at least one embodiment.

FIG. 17 is a block diagram depicting an example of the process for projecting an identity of a user across identity boundaries (e.g., between two identity realms), in accordance with at least one embodiment.

FIG. 18 is a block diagram depicting an example of the process using a Centralized Cross-Realm Service to project identity of entities across identity boundaries (e.g., between two identity realms), in accordance with at least one embodiment.

FIG. 19 is a block diagram illustrating an example method for authorizing a cross-realm call using a resource principal checker, in accordance with at least one embodiment.

FIG. 20 is a block diagram illustrating an example method for authorizing a cross-realm call, in accordance with at least one embodiment.

FIG. 21 is a block diagram illustrating an example method for utilizing a proxy service for cross-realm communications, in accordance with at least one embodiment.

FIG. 22 is a block diagram illustrating one pattern for implementing a cloud infrastructure as a service system, according to at least one embodiment.

FIG. 23 is a block diagram illustrating another pattern for implementing a cloud infrastructure as a service system, according to at least one embodiment.

FIG. 24 is a block diagram illustrating another pattern for implementing a cloud infrastructure as a service system, according to at least one embodiment.

FIG. 25 is a block diagram illustrating another pattern for implementing a cloud infrastructure as a service system, according to at least one embodiment.

FIG. 26 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Example Automated Data Center Build (Region Build) Infrastructure

The adoption of cloud services has seen a rapid uptick in recent times. Various types of cloud services are now provided by various cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

Data centers provided by a CSP may be hosted in different regions. A region is a localized geographic area and may be identified by a region name. Regions are generally independent of each other and can be separated by vast distances, such as across countries or even continents. Regions are grouped into realms. Examples of regions for a CSP may include

US West, US East, Australia East, Australia Southeast, and the like.

A region can include one or more data centers, where the data centers are located within a certain geographic area corresponding to the region. As an example, the data centers in a region may be located in a city within that region. For example, for a particular CSP, data centers in the US West region may be located in San Jose, California; data centers in the US East region may be located in Ashburn, Virginia; data centers in the Australia East region may be located in Sydney, Australia; data centers in the Australia Southeast region may be located in Melbourne, Australia; and the like.

Data centers within a region may be organized into one or more availability domains, which are used for high availability and disaster recovery purposes. An availability domain can include one or more data centers within a region. Availability domains within a region are isolated from each other, fault tolerant, and are architected in such a way that data centers in multiple availability domains are very unlikely to fail simultaneously. For example, the availability domains within a region may be structured in a manner such that a failure at one availability domain within the region is unlikely to impact the availability of data centers in other availability domains within the same region.

When a customer or subscriber subscribes to or signs up for one or more services provided by a CSP, the CSP creates a tenancy for the customer. The tenancy is like an account that is created for the customer. In certain implementations, a tenancy for a customer exists in a single realm and can access all regions that belong to that realm. The customer's users can then access the services subscribed to by the customer under this tenancy.

As indicated above, a CSP builds or deploys data centers to provide cloud services to its customers. As a CSP's customer base grows, the CSP typically builds new data centers in new regions or increases the capacity of existing data centers to service the customers' growing demands and to better serve the customers. Preferably, a data center is built in close geographical proximity to the location of customers serviced by that data center. Geographical proximity between a data center and customers serviced by that data center lends to more efficient use of resources and faster and more reliable services being provided to the customers. Accordingly, a CSP typically builds new data centers in new regions in geographical areas that are geographically proximal to the customers serviced by the data centers. For example, for a growing customer base in Germany, a CSP may build one or more data centers in a new region in Germany.

Building a data center (or multiple data centers) in a region is sometimes also referred to as building a region. The term “region build” is used to refer to building one or more data centers in a region. Building a data center in a region involves provisioning or creating a set of new resources that are needed or used for providing a set of services that the data center is configured to provide. The end result of the region build process is the creation of a data center in a region, where the data center is capable of providing a set of services intended for that data enter and includes a set of resources that are used to provide the set of services.

Building a new data center in a region is a very complex activity requiring coordination between various service teams. At a high level, this involves the performance and coordination of various tasks such as: identifying the set of services to be provided by the data center, identifying various resources that are needed for providing the set of services, creating, provisioning, and deploying the identified resources, wiring the resources properly so that they can be used in an intended manner, and the like. Each of these tasks further have subtasks that need to be coordinated, further adding to the complexity. Due to this complexity, presently, the building of a data center in a region involves several manually initiated or manually controlled tasks that require careful manual coordination. As a result, the task of building a new region (i.e., building one or more data centers in a region) is very time consuming. It can take time, for example, many months to build a data center. Additionally, the process is very error prone, sometimes requiring several iterations before a desired configuration of the data center is achieved, which further adds to the time taken to build a data center. These limitations and problems severely limit a CSP's ability to grow in a timely manner responsive to increasing customer needs.

Bootstrapping operations have been coordinated and orchestrated by an orchestrator (e.g., a Multi-Flock Orchestrator, an orchestration service, etc.). In previous implementations, the orchestrator attempted to automatically detect dependencies between operations. The orchestrator utilized various versions of configuration files and/or software artifacts and attempted to intelligently and automatically identify the artifacts and manner in which a data center build was performed. As a data center was built, the orchestrator utilized capabilities (e.g., tags that could be toggled on or off to indicate availability of a resource or functionality) to drive these operations. However, both the automatic detection techniques and the use of capabilities included drawbacks.

Previous implementations of an orchestrator also lacked an exact plan of the work that may be needed (or is needed) to build a data center ahead of the actual build. The orchestrator utilized service build definitions that were spread across multiple flock configuration files (“flock configs”) and interpreted by the orchestrator at runtime. This caused the orchestrator to execute a non-predetermined number of releases, in a non-predetermined order, each of which published a non-predetermined number of capabilities per release. To compensate for this indeterministic behavior, manually curated micro-schedules were generated and used to track the work and order of operations necessary to build the data center. These micro-schedules were not machine executable nor derived from code. Service teams were not prevented from changing their build automation which could cause the existing micro-schedules to be invalidated. Additionally, it was not possible to determine exact behavior of a service build when configuration files for that service rely on external data.

In previous implementations, tasks were triggered by publishing capabilities. Capability availability was not held constant over a release leading to non-determinism in the planned activity if any optional capabilities were published mid-release. The use of optional capabilities made it difficult to determine when a release was expected to publish a certain capability of if a resource was ever going to be created. Service teams could also introduce changes that created unsatisfiable cyclic dependencies between services causing the build to deadlock or depend upon a capability that would never be published. For at least these reasons, it was impossible to determine when dependent releases would be unblocked. Heterogeneity in different regions also meant that there was no single plan for how a service should be bootstrapped. Rather, a different plan existed for each region furthering compounding the difficulty in understanding how the service is built, as capabilities might be depended upon or published in certain types of regions and not others.

Service plans and manifests (SPAMs) may serve as a deterministic specification for the bootstrapping process of a single service. A service plan and manifest (SPAM) provides a complete service build description that specifies the releases and the deterministic/explicit order of those releases that may be necessary (or are necessary) to build a service. The SPAM may include clear expectations for the progress expected by each transition (e.g., each release execution corresponding to a particular phase/execution target). One or more services (e.g., all services to be bootstrapped within the region) may be associated with a corresponding SPAM.

Information provided by these SPAMs may be utilized to eliminate various errors that can occur in a data center build by identifying issues early in the build lifecycle (e.g., upon SPAM submission) rather than at build time. SPAMs may be composed together by an orchestrator (e.g., a Multi-Flock Orchestrator, a region orchestration service, etc.) and used to form a directed acyclic graph (DAG) of work (e.g., releases) that identifies the expected order of release executions that may be needed (or in some instances, is needed) to build the data center and capability dependencies between those releases. The defined graph may be pre-validated for abnormalities such as cycles on creation and on subsequent region updates. The graph may be used to support improved error detection both prior to and during a build. The graph generated from SPAMs may be used to drive region build operations and/or it may be used to validate a different graph (e.g., one generated from flock configs as in previous implementations) that is used to drive the region build. The SPAM provides a deterministic specification of a build implementation for a given service that reduces, if not eliminates, the non-deterministic drawbacks present in previous implementations that utilized multiple flock configs to identify the releases that may be needed (or is needed) to build a service. This improves observability and understanding of the region build and reduces the time and complexity of identifying root cause when an error is experienced during region build.

Capabilities may be used with, or may be replaced with, skills as a mechanism with which build progress may be tracked. A “skill” may represent a functional unit that a service exposes and offers to consumers (e.g., other services). This functional unit (also referred to as “service functionality”) can include all or a subset of the total functionality associated with a service. In some embodiments, skills may be scoped where access is controlled based on access and/or authorization policies and/or based on an association with a particular namespace. A skill may be provided in multiple versions in which one or more aspects of the skill differs from other versions, where each skill version represents a specific implementation of the skill. Each skill version may be identifiable using a unique skill identifier. Skills may enable enhanced and more accurate progress tracking of a region build over the tracking previously provided with capabilities, as well as improved root cause analysis functionality when errors or unexpected events occur in the build.

Service plans used by the region orchestrator to drive orchestration tasks may specify any suitable number of preconditions (e.g., required skill dependencies) and post-conditions (e.g., skill publications) that are expected to be met upon reaching different points (referred to as “execution target (ET) checkpoints”). The order of release execution may be identified in the service plan. In some embodiments, the releases may be expressed using ET checkpoint transitions. Each ET checkpoint transition (e.g., a transition from one ET checkpoint to another ET checkpoint) may be mapped to a corresponding infrastructure release or application release of the build. ET checkpoints may be associated with corresponding build flags that may be used to identify progress of the build. Executing a release may transition the ET from one ET checkpoint to another. Upon successful transition, one or more build flags that are associated with the release being executed at the ET may be set to indicate that the release was successfully executed (e.g., the corresponding infrastructure or application change corresponding to the release was successfully performed). The current ET checkpoint and build flags may be associated with a resource (e.g., an execution target resource) that is managed by the system. ET checkpoints and their use are discussed in more detail in U.S. Non-provisional application Ser. No. 18/661,396, filed May 10, 2024, entitled “Building a Data Center using Execution Target Checkpoints,” the disclosure of which is incorporated by reference in its entirety for all purposes.

Using a SPAM enables an improved and deterministic plan to be generated for a region build. Tracking the ET checkpoints defined within the SPAM enables the region orchestrator to identify, at any suitable time, the progress already achieved and/or the amount and order of remaining work to be performed in an ongoing service and/or region/data center build.

A single region orchestrator may be executed for each region under build (e.g., each data center being built). In some embodiments, each instance of the region orchestrator may execute within a service cell. A “service cell” refers to an isolated hosting environment that is hosted on infrastructure that is dedicated to the service cell. A service cell may be isolated in that it does not share hosts or virtual machines with other service cells. In previous orchestrator implementations, data plane resources (e.g., instances in a computing cluster, etc.) were managed by a regional control plane. Any suitable orchestration tasks (e.g., provisioning, removing, modifying a node of the cluster, etc.) across for any given region were performed by the same regional control plane. The present disclosure relates to utilizing a service cell that is specific to the region, the data center, or the build. This enables multiple builds to be performed concurrently with separate instances of the region orchestrator managing each build.

In some embodiments

### Certain Definitions

A “region” is a logical abstraction corresponding to a geographical location. A region can include any suitable number of one or more execution targets.

A “phase” refers to a group of execution targets that can be execute at the same time.

An “execution target” refers to a unit (e.g., a set of devices, a tenancy, etc.) against which a release may be executed. In some embodiments, an execution target may be the smallest granular unit against which CIOS can execute a release. An execution target may be specific to a region and a tenancy. Execution targets may be aggregated into one or more phases. For some services, an execution target represents an “instance” of a service. A single service can be bootstrapped to each of one or more execution targets. An execution target may be associated with a set of devices (e.g., a data center).

A “release” refers to a representation of an intent to orchestrate a specific change to a service (e.g., deploy version 8, “add an internal DNS record,” etc.). In some embodiments, a release corresponds to a change type that indicates the release is an infrastructure change (e.g., provisioning) or an application change (e.g., a deployment). A release may target one or more phases or execution targets.

“Bootstrapping” is intended to refer to the collective tasks associated with provisioning and deployment of any suitable number of resources (e.g., infrastructure components, artifacts, etc.) corresponding to a single service.

A “service” refers to functionality provided by a set of resources. A set of resources for a service includes any suitable combination of infrastructure, platform, or software (e.g., an application) hosted by a cloud provider that can be configured to provide the functionality of a service. A service can be made available to users through the Internet.

An “artifact” refers to code being deployed to an infrastructure component (e.g., a physical or virtual host) or a Kubernetes engine cluster, this may include, but is not limited to, software (e.g., an application), configuration information (e.g., a configuration file) for an infrastructure component, or the like.

A “flock configuration file” or “flock config,” for brevity refers to a configuration file that describes a set of resources (e.g., infrastructure components and artifacts, also referred to as a “flock”) associated with a single service. A flock config may correspond to a single release (e.g., provisioning and/or deployment tasks that are to be performed as a unit). A flock config may correspond to an infrastructure release or an application release. A service may be built using any suitable number of releases and corresponding flock configs. A flock config may include declarative statements that specify one or more aspects corresponding to a desired state of the resources of the service for that release.

A “flock” refers to a set of CIOS managed resources or a set of execution targets that can be deployed as a unit. A flock may exist within an organizational unit referred to as a “project.”

A “service cell” may refer to an isolated hosting environment that is hosted on infrastructure that is dedicated to the service cell. A service cell may be isolated in that it does not share hosts or virtual machines with other service cells. A service cell may be a kind of logical data center (e.g., a logical grouping of performance isolation and fault isolation) within a single availability domain, region, or data center.

“Service state” refers to a point-in-time snapshot of every resource (e.g., infrastructure resources, artifacts, etc.) associated with the service. The service state indicates status corresponding to provisioning and/or deployment tasks associated with service resources.

IaaS provisioning (or “provisioning”) refers to acquiring computers or virtual hosts for use and even installing needed libraries or services on them. The phrase “provisioning a device” refers to evolving a device to a state in which it can be utilized by an end-user for their specific use. A device that has undergone the provisioning process may be referred to as a “provisioned device.” Preparing the provisioned device (installing libraries and daemons) may be part of provisioning; this preparation is different from deploying new applications or new versions of an application onto the prepared device. In most cases, deployment does not include provisioning, and the provisioning may need to be performed first. Once prepared, the device may be referred to as “an infrastructure component.”

IaaS deployment (or “deployment”) refers to the process of providing and/or installing a new application, or a new version of an application, onto a provisioned infrastructure component. Once the infrastructure component has been provisioned (e.g., acquired, assigned, prepared, etc.), additional software may be deployed (e.g., provided to and installed on the infrastructure component). The infrastructure component can be referred to as a “resource” after provisioning and deployment has concluded. Examples of resources may include, but are not limited to, virtual machines, databases, object storage, block storage, load balancers, and the like.

A “virtual bootstrap environment” (ViBE) refers to a virtual cloud network that is provisioned in the overlay of an existing region (e.g., a “host region”). Once provisioned, a ViBE is connected to a new region using a communication channel (e.g., an IPsec Tunnel VPN). Certain essential core services (or “seed” services) like a deployment orchestrator, a public key infrastructure (PKI) service, and the like can be provisioned in a ViBE. These services can provide the capabilities required to bring the hardware online, establish a chain of trust to the new region, and deploy the remaining services in the new region. Utilizing the virtual bootstrap environment can prevent circular dependencies between bootstrapping resources by utilizing resources of the host region. Services can be staged and tested in the ViBE prior to the physical region (e.g., the target region) being available.

A “Cloud Infrastructure Orchestration Service” (CIOS) may refer to a system configured to manage provisioning and deployment operations for any suitable number of services as part of a region build.

A “host region” refers to a region that hosts a virtual bootstrap environment (ViBE). A host region may be used to bootstrap a ViBE.

A “target region” refers to a region under build.

A “capability” identifies is a legacy resource previously used during region build that signaled that another resource, service, or feature was available, or that an event had occurred. By way of example, a capability could be published indicating that a resource is available for authorization/authentication processing (e.g., a subset of the functionality to be provided by a service). As another example, a capability could be published indicating the full functionality of the service is available. Capabilities were used to identify functionality on which a resource or service depended and/or functionality of a resource or service that was available for use. A capability was associated with an alphanumeric identifier and was used to indicate the capability is available or unavailable. Capabilities and their use in orchestration is discussed in more detail in U.S. Non-provisional application Ser. No. 18/661,401, filed May 10, 2024, entitled “Managing Data Center Orchestration using Service Plans and Manifests,” the disclosure of which is incorporated by reference in its entirety for all purposes.

“Publishing a capability” refers to “publishing” as used in a “publisher-subscriber” computing design or otherwise providing an indication that a particular capability is available (or unavailable). In capabilities-based orchestration implementations, capabilities were “published” (e.g., collected by a Capabilities Service, provided to a Capabilities Service, pushed, pulled, etc.) to provide an indication that functionality of a resource/service was available or that an event had occurred. In some embodiments, capabilities may have been published/transmitted via an event, a notification, a data transmission, a function call, an API call, or the like. An event (or other notification/data transmission/etc.) indicating availability of a particular capability could be broadcasted/addressed (e.g., published) to a Capabilities Service.

A “Capabilities Service” may be a service configured to monitor and maintain capabilities data that indicates which capabilities are current available in a region. A Capabilities Service may be provided within a Cloud Infrastructure Orchestration System and may be used to identify what capabilities, services, features have been made available in a region, or which events have occurred within the region. The described Capabilities Service may service as a central repository/authority of all capabilities that have been published in the region (e.g., during a region build).

An “Orchestrator” is intended to refer to a service or system that initiates tasks involved in bootstrapping one or more services during a region build. A Multi-Flock Orchestrator (MFO), an example of an orchestrator, may be a computing component (e.g., a service) configured to coordinate events between components of the CIOS to provision and deploy services to a target region (e.g., a new region). An orchestrator may track relevant events (e.g., indicated through capabilities and/or skills as described herein) for each service of the region build and takes actions in response to those events (e.g., based on determining upstream dependencies have been met for a given release/skill, etc.).

A “Region Orchestrator” is intended to refer to a service or system that initiates tasks involved in bootstrapping one or more services during a region build. A region orchestrator may be specific to a particular region or data center and may be configured to manage all bootstrapping operations within that region/data center. A region orchestrator may be a computing component (e.g., a cloud-computing service) configured to coordinate events between components of the CIOS to provision and deploy services to a target region (e.g., a new region). A region orchestrator may track relevant events (e.g., indicated through skills as described herein) for each service of the region build and takes actions in response to those events (e.g., based on determining upstream dependencies have been met for a given release/skill, etc.).

A “Real-time Regional Data Distributor” (RRDD) may be a service or system configured to manage region data. This region data can be injected into flock configs to dynamically create execution targets for new regions.

A “Telemetry Service” may be a service or system that is configured to manage/monitor time series data associated with one or more services/resources and trigger (e.g., publish, store, etc.) various alarms and/or corresponding alarm states based at least in part on analyzing the time series data.

A “Skills Service” (also referred to as “Puffin”) may be a service or system that is configured to store planned and/or actual dependency relationships between services, resources, or units of functionality (also referred to as “service functionality”). Puffin may be configured as a central registry with which service teams may register their services/microservices. It should be appreciated that the unit of functionality may relate to functionality provided by a computing component other than a service.

A “skill” may represent a functional unit that a service exposes and offers to consumers (e.g., other services). This functional unit (also referred to as “service functionality” or “functionalities”) can include all or a subset of the total functionality associated with a service. In some embodiments, skills may be scoped where access is controlled based on access and/or authorization policies and/or based on an association with a particular namespace. A skill may be provided in multiple versions in which one or more aspects of the skill differs from other versions, where each skill version represents a specific implementation of the skill. Each skill version may be identifiable using a unique skill identifier. Skills are intended to replace the capabilities of previous implementations (e.g., labels/tags that could be toggled on and off) and to enable enhanced and more accurate progress tracking of a region build as well as improved root cause analysis functionality when errors or unexpected events occur in the build. A skill may be monitored for health and may be configured to maintain health data. A “skill” may collectively refer to any suitable number of data structures in which data defining the skill may be maintained. Skills may be associated with an identifier (e.g., a phonebookID) that identifies one or more entities or contacts. Services may specify a skill's run-time dependencies using one or more user interfaces provided by Puffin, while build-time skill dependencies may be declared within a SPAM and reflected in one or more user interfaces hosted by Puffin.

A “fleet” refers to a logical environment (e.g., preproduction, production, etc.) to which a skill can be scoped. By way of example, a skill associated with a production fleet may be separate from a skill of the same name utilized with a preproduction fleet. A “project” may be similarly utilized to scope skills. In some embodiments, a skill may be scoped/applied to a particular environment based at least in part on any suitable combination of attributes such as skillID, skillversionID, compartmentID, namespaceID, producerServiceID, skillName, fleet, project, or the like, that collectively identify a particular application of a skill.

A “service plan specification” or “service plan,” for brevity, refers to any suitable document or data that specifies a build implementation of a given service. A service plan may include any suitable combination of build milestones, execution units, and flock configurations. In some embodiments, service plans describe preconditions (e.g., via skill dependencies) and post-conditions (e.g., skills published/installed) for each step along of path of installing a service.

A service plan may detail specific releases that may be needed (or that are needed) to build a service and the order by which the releases are to be performed to build the service. A service plan may separate inter-service coordination and intra-service coordination and/or may specify the expected state of a service at any suitable point of a region build.

A “service manifest” or “manifest,” for brevity, identifies the versions for flock configs and artifacts that are to be used to build a service. A service manifest may include a collection of service manifest items, each service manifest item identifying a particular flock config or artifact that may be needed (or is needed) to build a service. In some embodiments, a service manifest item may be associated with a git commit hash of the flock and all version declarations for any artifact that is required in application releases for that service's build.

A “SPAM” (also referred to as a “service build description”) refers to a combination of a service plan and a manifest that collectively provide a deterministic specification of the process for building a service and, in some cases, uninstalling the service to revert to an earlier working state. In some embodiments, a SPAM details a combination and order of releases that may be needed (or is needed) to build the service. A manifest of the SPAM may define all resources to be used for the releases, while the service plan specifies an order of release execution based on capability dependencies. A SPAM may be used to track compliance of a region build. A SPAM details the releases that may be necessary (or are necessary) to build a service where each release may be associated with pre-conditions and post-conditions. The preconditions may refer to skills that may (or in some instances, must) be present such that a release can be created that will result in the postconditions being satisfied. The post-conditions may be skills that should (or in some cases, must) be published as a consequence of the release succeeding. SPAMs may be created by service teams and are derived from YAML files they author. The SPAM may be delineated into discrete sections, including execution units which define transitions between well-defined points in the service's build, known as “build milestones.” A service may transition from one build milestone to the next by performing the releases defined by an execution unit. Execution units may specify the external dependencies (capabilities) that may be (or are) required to perform the releases defined within the unit. Build milestones may specify the capabilities published by the service that should (or in some cases, must) be made available once the service has reached that milestone. In some embodiments, the capabilities specified by a build milestone include capabilities that are intended for consumption by other services.

A “SPAM set” refers to a collection on SPAMs that are mutually compatible and/or that are previously associated with one another. A SPAM set may be used to derive a version set with which a directed acyclic graph may be generated and used to drive operations for building a data center. In some embodiments, a SPAM set may be associated with a scope and/or a regional context.

A “build strategy” may include cross-SPAM rules that may be enforced by a Region Orchestrator to ensure specific orderings of particular build steps. Build strategies, which may be defined globally, may be used to describe and validate complex laddering that occurs to bring up mutually dependent services at runtime as well as broader rules around the ordering of services during region build. Build strategies may act as guardrails on dependencies between tightly coupled skills/services and enable the system to catch violations of contracts earlier than region build. In some embodiments, build strategies may be developed and updated by architects from affected service teams. A build strategy may include a set of rules with each rule having pre-conditions, post-conditions, and a name or other suitable identifier. Pre and/or post conditions of a rule may be declared as being implemented by a SPAM (e.g., an execution unit of a SPAM) or by another build strategy. A build strategy may be versioned (e.g., using major/minor/patch designations). A minor version changes may add new rules, patch version changes may include updates to non-functional portions of the build strategy.

A “build milestone” (also referred to as a “stage”) refers to an entity defined in a service plan that identifies a synchronization point between the service build (e.g., the process for building a particular service) and the rest of the data center build. Build milestones refer to stages involved in the deployment of a service in a region under build (e.g., a data center being built within a region). Build milestones may be defined coarsely to limit their number and provide a high-level overview of the process for building a service. As a non-limiting example, a set of build milestones for a service may include “absent” (e.g., a default starting milestone), “service functionality X available,” “service available,” and “service build complete.”

An “execution unit” refers to another entity of a service plan. One or more execution units may describe the process for transitioning from one build milestone to the next via a directed acyclic graph of CIOS releases (e.g., infrastructure and/or application releases).

Execution units may represent a series of infrastructure and application installations/changes (e.g., bring up a load-balancer) to transition from one build milestone to the nest, or to un-install infrastructure or applications (e.g., tear down the load-balancer). An execution unit may define releases across one or more execution targets. In some embodiments, build dependencies (expressed as skills that depend on another skill) may be met (and in some cases, must be met) before an execution unit can be invoked. Execution unit definitions may be used to describe the workflow to transition a service from one build milestone to another along with the required preconditions (e.g., installed and available skills) and postconditions (e.g., skills that will be installed and made available through execution the releases of the execution unit). In some embodiments, an execution unit can declare that it implements one or more build strategy rules.

“Execution context” refers to one or more inputs of a region build planner that may be used to override execution of specific steps within one or more SPAMs of a SPAM set. The execution context (e.g., input data to the region build planner) may define specific milestones to reach for one or more SPAMs and may specify plan concurrency (e.g., SPAMs which may be concurrently executed).

An “execution target checkpoint” or “ET checkpoint,” for brevity, refers to a defined point in the data center build of a given execution target (e.g., a set of devices, a tenancy, etc.). An ET checkpoint may be associated with certain preconditions (e.g., required capability dependencies) and postconditions (capability publications) that are expected to have been met upon reaching that ET checkpoint. In some embodiments, steps identified within an execution unit may reference ET checkpoint transitions that may map logically to expected CIOS releases (e.g., infrastructure releases or application releases).

A “region archetype” or “region type” may represent an overall structure of a region (e.g., an ONSR region, a single-availability-domain-region, a first region in a realm) that could be used to impact a service's installation. In some embodiments, a service plan may reference dimensions of a region archetype to conditionally change the service plan definition.

A “version set” may be used to define all flock configuration file and artifact versions across all services in a specific regional context (e.g., given a specific region such as “region1” and a specific version set identifier such as “golden” or “break glass”). A version set may be composed of many version set items, each of which may specify a flock and the artifacts for that flock. These entities may identify the existence of SPAMs and SPAM sets. By way of example, in some embodiments, a version set may be associated with a corresponding SPAM set. Any suitable version set item may be associated with a SPAM from which it was derived and/or corresponding to a common service.

“Static analysis” refers to an execution of a static analysis of code (e.g., that identifies data center infrastructure components as objects using a declarative configuration language) to infer publications and/or dependencies (e.g., skill and/or publications and/or dependencies). In some embodiments, a static flock analysis may be performed utilizing an infrastructure-as-code software tool (e.g., Terraform®). In some embodiments, this software tool may generate one or more data structures (e.g., directed acyclic graphs) that represent these dependencies/publications. Each node in the graph may correspond to a flock config and/or a release, with edges identifying capability publications and/or dependencies between releases.

In some examples, techniques for implementing a Cloud Infrastructure Orchestration Service (CIOS) are described herein. Such techniques, as described briefly above, can be configured to manage bootstrapping (e.g., provisioning and deploying software to) infrastructure components within a cloud environment (e.g., a region). In some instances, the CIOS can include computing components (e.g., a CIOS Central and a CIOS Regional) that may be configured to manage bootstrapping tasks (provisioning and deployment) for a given service and an Orchestrator (e.g., a multi-flock orchestrator) configured to initiate/manage region builds (e.g., bootstrapping operations corresponding to multiple services in a region/data center).

CIOS enables region/data center building and world-wide infrastructure provisioning and code deployment with minimal manual run-time effort from service teams (e.g., beyond an initial approval and/or physical transportation of hardware, in some instances). The high-level responsibilities of CIOS include, but are not limited to, coordinating region builds in an automated fashion with minimal human intervention, providing users with a view of the current state of resources managed by the CIOS (e.g., of a region, across regions, world-wide, etc.), and managing bootstrapping operations for bootstrapping resources within a region.

The CIOS may provide view reconciliation, where a view of a desired state (e.g., a desired configuration) of resources may be reconciled with a current/actual state (e.g., a current configuration) of the resources. In some instances, view reconciliation may include obtaining state data to identify what resources are actually running and their current configuration and/or state. Reconciliation can be performed at a variety of granularities, such as at a service level.

CIOS can perform plan generation, where differences between the desired and current state of the resources are identified. Part of plan generation can include identifying the operations that would need to be executed to bring the resources from the current state to the desired state. Once the user is satisfied with a plan, the plan can then be marked as approved or rejected. Thus, users can spend less time reasoning about the plan and the plans are more accurate because they are machine generated. Plans are almost too detailed for human consumption; however, CIOS can provide this data via a sophisticated user interface (UI).

In some examples, CIOS can handle execution of change management by automatically executing the approved plan. Once an execution plan has been created and approved, engineers may no longer need to participate in change management unless CIOS initiates roll-back. CIOS can handle rolling back to a previous service version by automatically generating a plan that returns the service to a previous (e.g., pre-release) state (e.g., when CIOS detects service health degradation while executing).

CIOS can measure service health by monitoring alarms and executing integration tests. CIOS can help teams quickly define roll-back behavior in the event of service degradation, which it can later execute automatically. CIOS can automatically generate and display plans and can track approval. CIOS can combine the functionality of provisioning and deployment in a single system that coordinates these tasks across a region build. CIOS can discover dependencies between execution tasks at every level (e.g., resource level, execution target level, phase level, service level, etc.) through a static analysis (e.g., including parsing and processing content) of one or more configuration files. Using these dependencies, CIOS can generate various data structures from these dependencies that can be used to drive task execution (e.g., tasks regarding provisioning of infrastructure resources and deployment of artifacts across the region).

Today, during Large Scale Events (LSEs) (e.g., events in which a substantial error, blockage, or delay is experienced in a region build), incident management and region build operators frequently incur wide-spread overhead and sometimes delays, e.g., in collecting status, attribution of the issue, assessment of impacts, and the recovery of services, due to the heavily human-based and non-systemic approach of conventional approaches. Due to the complexity of the various dependencies between services, it can be extremely difficult and time intensive for operators to identify the contributing cause of the event. This causes delays in remediation as well as the ability to assess when an event has concluded. Similarly, building a region includes challenges in which human involvement may be utilized to troubleshoot and/or detect of failures or blocking situations. Conventionally, it is difficult for service teams to determine what dependencies exist for their service. Both the dependencies the service may have on other services, and vice versa. Additionally, service teams have incomplete indicators ahead of an actual region build as to whether their region build design will have critical issues (such as cyclic dependencies) that prevent or delay the build of their service.

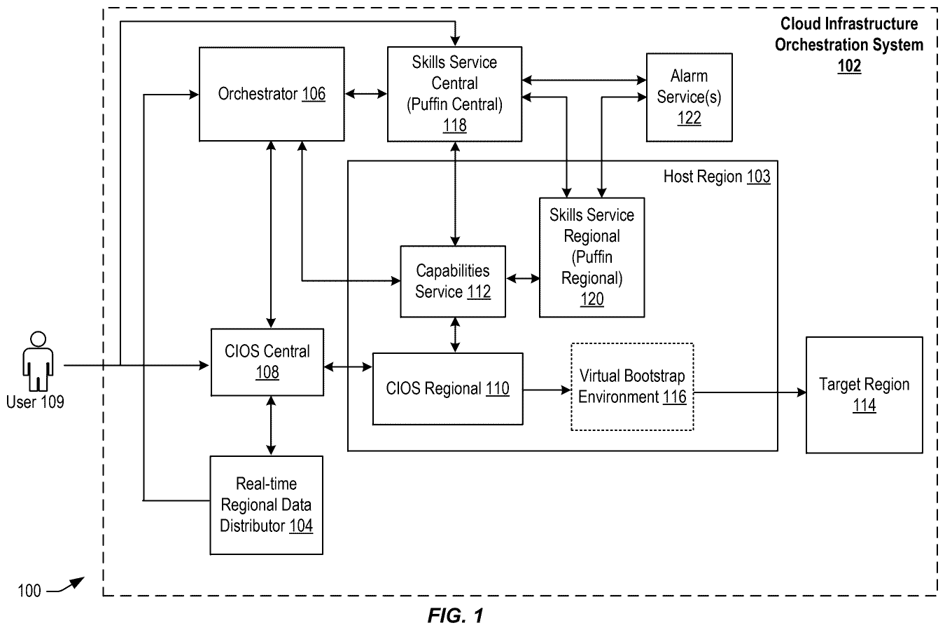

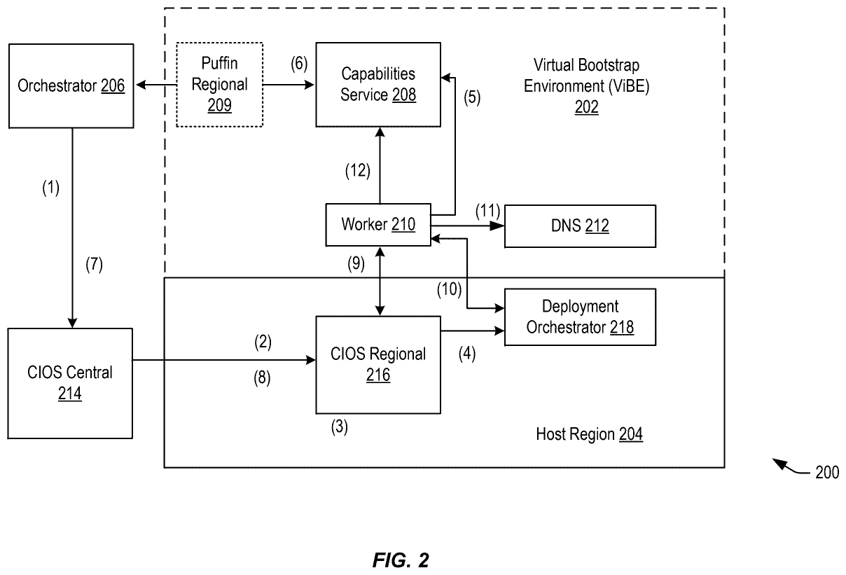

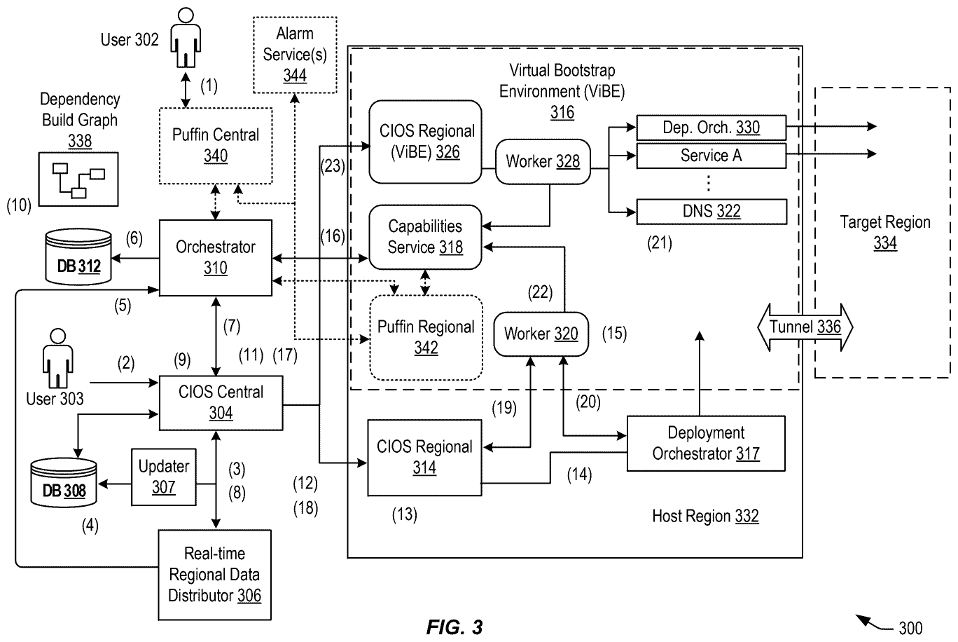

FIG. 1 is a block diagram of an environment 100 in which a Cloud Infrastructure Orchestration System (CIOS) 102 in which a Cloud Infrastructure Orchestration System (CIOS may operate to dynamically bootstrap services in a region/data center, according to at least one embodiment. CIOS 102 can include, but is not limited to, the following components: Real-time Regional Data Distributor (RRDD) 104, Orchestrator 106, CIOS Central 108, CIOS Regional 110, Capabilities Service 112, Virtual Bootstrap Environment 116, Puffin Central 118, Puffin Regional 120, and Alarm Service(s) 122. Specific functionality provided by CIOS Central 108 and CIOS Regional 110 is described in more detail in U.S. application Ser. No. 17/016,754, entitled “Techniques for Deploying Infrastructure Resources with a Declarative Provisioning Tool,” the entire contents of which are incorporated in its entirety for all purposes. In some embodiments, any suitable combination of the components of CIOS 102 may be provided as a service. In some embodiments, some portion of CIOS 102 may be deployed to a region (e.g., a data center represented by host region 103). In some embodiments, CIOS 102 may include any suitable number of cloud services (not depicted in FIG. 1) discussed in further detail below with respect to FIGS. 2 and 3.

Real-time Regional Data Distributor (RRDD) 104 may be configured to maintain and provide region data that identifies realms, regions, execution targets, and availability domains. In some cases, the region data may be in any suitable form (e.g., JSON format, data objects/containers, XML, etc.). Region data maintained by RRDD 104 may include any suitable number of subsets of data which can individually be referenceable by a corresponding identifier. By way of example, an identifier “all_regions” can be associated with a data structure (e.g., a list, a structure, an object, etc.) that includes a metadata for all defined regions. As another example, an identifier such as “realms” can be associated with a data structure that identifies metadata for a number of realms and a set of regions corresponding to each realm. In general, the region data may maintain any suitable attribute of one or more realm(s), region(s), availability domains (ADs), execution target(s) (ETs), and the like, such as identifiers, DNS suffixes, states (e.g., a state of a region), and the like. The RRDD 104 may be configured to manage region state as part of the region data. A region state may include any suitable information indicating a state of bootstrapping within a region. By way of example, some example region states can include “initial,” “building,” “production,” “paused,” or “deprecated.” The “initial” state may indicate a region that has not yet been bootstrapped. A “building” state may indicate that bootstrapping of one or more flocks within the region has commenced. A “production” state may indicate that bootstrapping has been completed, and the region is ready for validation. A “paused” state may indicate that CIOS Central 108 or CIOS Regional 110 has paused internal interactions with the regional stack, likely due to an operational issue. A “deprecated” state may indicate the region has been deprecated and is likely unavailable and/or will not be contacted again.

CIOS Central 108 is configured to provide any suitable number of user interfaces with which users (e.g., user 109) may interact with CIOS 102. By way of example, users can make changes to region data via a user interface provided by CIOS Central 108. CIOS Central 108 may additionally provide a variety of interfaces that enable users to: view changes made to flock configs and/or artifacts, generate and view plans, approve/reject plans, view status on plan execution (e.g., corresponding to tasks involving infrastructure provisioning, deployment, region build, and/or desired state of any suitable number of resources managed by CIOS 102. CIOS Central 108 may implement a control plane configured to manage any suitable number of CIOS Regional 110 instances. CIOS Central 108 can provide one or more user interfaces for presenting region data, enabling the user 109 to view and/or change region data. CIOS Central 108 can be configured to invoke the functionality of RRDD 104 via any suitable number of interfaces. Generally, CIOS Central 108 (also referred to as a “provisioning and deployment manager”) may be configured to manage region data, either directly or indirectly (e.g., via RRDD 104). CIOS Central 108 may be configured to compile flock configs (and/or SPAMs) to inject region data as variables within the flock configs (and/or SPAMs). CIOS Central 108 may be instructed (e.g., by Orchestrator 106) to perform one or more releases (e.g., infrastructure or application releases) corresponding to flock configs.

Each instance of CIOS Regional 110 may correspond to a module configured to execute bootstrapping tasks that are associated with a single service of a region (e.g., a data center such as host region 103). CIOS Regional 110 can receive desired state data from CIOS Central 108. In some embodiments, desired state data may include a flock config that declares (e.g., via declarative statements) a desired state of resources associated with a service. CIOS Central 108 can maintain current state data indicating any suitable aspect of the current state of the resources associated with a service. In some embodiments, CIOS Regional 110 can identify, through a comparison of the desired state data and the current state data, that changes that may be (or are) needed to one or more resources. For example, CIOS Regional 110 can determine that one or more infrastructure components need to be provisioned, one or more artifacts deployed, or any suitable change that may be (or is) needed to the resources of the service to bring the state of those resources in line with the desired state. As CIOS Regional 110 performs bootstrapping operations, it may publish data indicating various capabilities of a resource as they become available. A “capability” identifies a unit of functionality associated with a service. The unit could be a portion, or all of the functionality to be provided by the service. By way of example, a capability can be published indicating that a resource is available for authorization/authentication processing (e.g., a subset of the functionality to be provided by the resource). As another example, a capability can be published indicating the full functionality of the service is available. Capabilities can be used to identify functionality on which a resource or service depends and/or functionality of a resource or service that is available for use. In some embodiments, CIOS Regional 110 may transmit data indicating a state transition of a skill. By way of example, in some embodiments, CIOS Regional 110 performs bootstrapping operations which result in publishing a skill (e.g., transmitting skill metadata including a skill state value indicating the skill is installed). The skill metadata may be transmitted to Puffin (e.g., Puffin Regional 120) and used to update the skill state of the corresponding skill.

Capabilities Service 112 is configured to maintain capabilities data that indicates 1) what capabilities of various services are currently available, 2) whether any resource/service is waiting on a particular capability, 3) what particular resources and/or services are waiting on a given capability, or any suitable combination of the above. Capabilities Service 112 may provide an interface with which capabilities data may be requested. Capabilities Service 112 may provide one or more interfaces (e.g., application programming interfaces) that enable it to transmit capabilities data to Orchestrator 106, CIOS Regional 110 (e.g., each instance of CIOS Regional 110), Puffin Regional 120, and/or Puffin Central 118. In some embodiments, Capabilities Service 112 may store capabilities data in a data store that is accessible to one or more components of CIOS 102. Orchestrator 106, CIOS Regional 110 (e.g., each instance of CIOS Regional 110), Puffin Regional 120, and/or Puffin Central 118, and/or any suitable component or module of CIOS Regional 110 may be configured to request capabilities data from Capabilities Service 112 or otherwise obtain capabilities data (e.g., from a data store configured to store capabilities data generated by the Capabilities Service 112). Although the Capabilities Service 112 is depicted as being a separate component of CIOS 102, it should be appreciated that, in some embodiments, the functionality provided by Capabilities Service 112 may be provided, in whole or in part, as part of the Skills Service via any suitable combination of Puffin Central 118 and Puffin Regional 120.

In some embodiments, each regional component such as CIOS Regional 110, Capabilities Service 112, Puffin Regional 120, and/or Virtual Bootstrap Environment 116 may be one of many regional components. Each regional component may be specific to a given region (e.g., as depicted in FIG. 1, Host Region 103). Therefore, another region may include similar, but separate, components that are specific to that region. In some embodiments, central components (e.g., Orchestrator 106, CIOS Central 108, RRDD 104, and Puffin Central 118) may include one or more components that are configured to manage build operations corresponding to one or more regions. By way of example only, a single orchestrator (Orchestrator 106) may be utilized to manage bootstrapping operations for building any suitable number of data centers, or multiple instances of Orchestrator 106 may be utilized, each driving the bootstrapping operations for a subset of those data centers or a single data center.

In some embodiments, Orchestrator 106 (an example of which may be a multi-flock orchestrator, an orchestration service, etc.) may be configured to drive region build efforts. In some embodiments, Orchestrator 106 can manage information that describes which flock config versions and/or artifact versions are to be utilized to bootstrap a given service within a region (or to make a unit of change to a target region). In some embodiments, Orchestrator 106 may manage any suitable combination of flock configs and/or service plans. In some embodiments, Orchestrator 106 may be configured to monitor (or be otherwise notified of) changes to the region data managed by Real-time Regional Data Distributor 104. In some embodiments, receiving an indication that region data has been changed may cause a region build to be triggered by Orchestrator 106. In some embodiments, Orchestrator 106 may collect various flock configs, artifacts, and/or SPAMs to be used for a region build. Some, or all, of the flock configs and/or SPAMs may be configured to be region agnostic. That is, the flock configs and/or SPAMs may not explicitly identify what regions to which the flock is to be bootstrapped. In some embodiments, Orchestrator 106 may trigger a data injection process through which the collected flock configs and/or SPAMs are recompiled (e.g., by CIOS Central 108). During recompilation, operations may be executed (e.g., by CIOS Central 108) to cause the region data maintained by Real-time Regional Data Distributor 104 to be injected into the config files and/or SPAMs. Flock configs and/or SPAMs can reference region data through variables/parameters without requiring hard-coded identification of region data. The flock configs and/or SPAMs can be dynamically modified at run time using this data injection rather than having the region data be hardcoded, and therefore, and more difficult to change.

In some embodiments, Orchestrator 106 can perform a static flock analysis in which the flock configs and/or service plans are parsed to identify dependencies between resources, execution targets, execution target checkpoints, phases, and flocks, and in particular to identify circular dependencies that need to be removed. In some embodiments static flock analysis (SFA) data corresponding to this analysis may be stored (e.g., via DB 312) for subsequent use. In some embodiments, Orchestrator 106 can generate any suitable number of data structures based on the dependencies identified. These data structures (e.g., directed acyclic graph(s), linked lists, etc.) may be utilized by CIOS 102 to drive operations for performing a region build. By way of example, these data structures may collectively define an order by which services are bootstrapped within a region. An example of such a data structure is discussed further below with respect to Build Dependency Graph 338 of FIG. 3. If circular dependencies (e.g., service A requires service B and vice versa) exist and are identified through the static flock analysis and/or graph, Orchestrator 106 may be configured to notify any suitable service teams that changes are required to the corresponding flock config to correct these circular dependencies. Orchestrator 106 can be configured to traverse one or more data structures to manage an order by which services are bootstrapped to a region. Orchestrator 106 can identify (e.g., using data obtained from Capabilities Service 112) capabilities available within a given region at any given time. Orchestrator 106 may utilize this data to identify when it can bootstrap a service, when bootstrapping is blocked, and/or when bootstrapping operations associated with a previously blocked service can resume. Based on this traversal, Orchestrator 106 can perform a variety of releases in which instructions are transmitted by Orchestrator 106 to CIOS Central 108 to perform bootstrapping operations corresponding to any suitable number of flock configs. In some examples, Orchestrator 106 may be configured to identify that one or more flock configs may require multiple releases due to circular dependencies found within the graph. As a result, Orchestrator 106 may transmit multiple instruction sets to CIOS Central 108 for a given flock config to break the circular dependencies identified in the graph.

In some embodiments, one or service plan and manifests (SPAMs) may be utilized by the Orchestrator 106. A service plan and manifest may provide a deterministic specification of a build description for a service than previously provided by one or more flock configs. While flock configs specify aspects of a single release associated with a single service, a service plan may provide a single specification of the order and conditional requirements for executing all of the releases that may be needed (or are needed) to build a given service. Previous implementations of flock configs included optional dependencies which allowed for a degree of indeterministic behavior with respect to the order of operations performed during a region build. The inclusion of optional dependencies may require the Orchestrator 106 to perform multiple passes of the build dependency graph, resulting in wasteful processing. These types of dependencies make it difficult, if not impossible, for the system to track region build progress, identify remaining operations yet to be performed, and/or identify build completion. Service plans and manifests (SPAMs) may be utilized to eliminate at least some of the drawbacks to previous indeterministic approaches.

SPAMs (one SPAM corresponding to one service to be bootstrapped in the region) allow service teams to describe the corresponding operations that may be needed (or are needed) to build their service and may allow for separation between internal coordination (e.g., coordination of operations internal to the service) and external coordination (e.g., coordination of operations between components of different services). A number of visualizations may be provided (e.g., via Orchestrator 106 or any suitable component of CIOS 102) via one or more user interfaces. One visualization may depict a directed acyclic graph describing the build operations internal to a given service, and a separate visualization may depict a directed acyclic graph describing the order of build operations corresponding to multiple services (e.g., all services of the region/data center). As a specific example, one or more visualization can present a region-level directed acyclic graph (DAG) including only external coordination (e.g., an order of operations corresponding to coordination between services) while omitting operations that are internal with respect to each service. This DAG, for example, may depict nodes corresponding to one service's capabilities (or skills) on which other services depend, while excluding nodes corresponding to capability (or skill) dependencies between service components/functional units of the same service.

A SPAM may include an external interaction interface that includes a service build definition that includes a number of build milestones. Each build milestone may be associated with a set of capabilities (and/or skills) that the service is expected to publish upon reaching a given milestone. To transition between build milestones, the SPAM may include execution units that encapsulate a directed acyclic graph (DAG) of one or more releases, each release being equivalent to operations previously defined with a single flock config. Each execution unit may define a set of build time dependencies that identify one or more capabilities (and/or skills) that are required by at least one of the releases of the execution unit.

A SPAM may include a service build implementation. An execution unit of the SPAM may describe one or more releases that may be needed (or are needed) to build a service, with potentially multiple execution units being defined. Each execution unit may be associated with one or more execution target checkpoint transitions, each of which may be used to specify the expected capabilities that should be available before the time of the release and the capabilities that should be published as the result of performing the release.

In some embodiments, the Orchestrator 106 may be configured to aggregate SPAMs corresponding to each service to be deployed in a region to generate a larger directed acyclic graph (e.g., the Build Dependency Graph 338 of FIG. 3) which may capture all of the operations necessary to build a region/data center. The collection of SPAMs identified from this aggregation may be referred to as a “SPAM set.” In some embodiments, the Orchestrator 106 may utilize the DAG generated from a SPAM set to validate a DAG and/or operations performed using flock configs, while the DAG generated from flock configs is used to drive build operations/release execution. Alternatively, the Orchestrator 106 may utilize the DAG generated from the SPAM set to drive build operations/release execution. The utilization of a SPAM/SPAM set may be utilized by the system to generate a deterministic execution plan with which the region build may be executed.

In some embodiments, Puffin Central 118 may provide a number of user interfaces with which one or more skills can be defined. A skill may be used with, or in lieu of, previously capabilities and enables improvements over previous capabilities-based implementations. In contrast with capabilities, skills may be scoped (e.g., controllable through access and authorization policies), versioned, and attributed to a particular service and/or contact. Skills may be associated with a lifecycle and may be monitored for health and are designed to be more highly visible/accessible than capabilities. Puffin Central 118 may provide an authoritative registry for skills. Various user interfaces managed by Puffin Central 118 may be utilized to define, maintain, and manage skills that each service offers, as well as their dependency relationships with other services. Puffin Central 118 may be utilized to declare and persist strongly defined metadata of services in a versioned manner. This metadata may be used to generate a blueprint for build-time and run-time dependencies. These blueprints can be used to validate build plans, to drive orchestration decisions during region build, and to improve time-to-engage and time-to-diagnose measures during region build and/or Large-Scale Events (LSEs).

Puffin Central 118 may be configured to serve as a source of truth for services and may maintain metadata including each service's upstream and downstream dependencies and service team contact information and methods for each service across regions and realms (e.g., a set of regions). Each skill may represent a function unit that a service exposes and offers to consumers (e.g., other services). In some embodiments, skills may be scoped where access is controlled based on access and/or authorization policies and/or based on an association with a particular namespace. A skill may be associated with multiple versions in which one or more aspects of the skill differs from previous versions, where each skill version represents a specific implementation of the skill. Each skill version may be identifiable using a unique skill identifier. In some embodiments, Puffin Central 118 may be configured to generate a skill corresponding to a previously defined capability in order to provide backward compatibility with previous capabilities-based region build implementations.

In some embodiments, Puffin may maintain compatibility between skills and capabilities, such that any suitable combination of the two may be utilized to define a process by which a service is to be built. Based on maintaining a mapping between skills and/or capabilities a service publishes, Puffin may ensure that a skill may be transitioned based on capabilities and/or a capability may be published due to a state change of a corresponding skill. In some embodiments, Puffin may generate “shadow skills” (e.g., system-generated skills that represent corresponding capabilities) and/or shadow capabilities (e.g., system-generated capabilities that publish when a corresponding skill is transitioned to an installed state). These features, provided by Puffin, enable the orchestrator to use any suitable combination of skills and/or capabilities to drive orchestration during a region build (e.g., during a process for building a data center).

In some embodiments, a skill may be mapped to one or more capabilities. Puffin Regional 120 may be configured to publish and/or store skills metadata based on capabilities data published (or stored) by the Capabilities Service 112. In some embodiments, Puffin Regional 120 may publish capabilities data to the Capabilities Service 112 and/or store such data based at least in part on publishing a skill or identifying a skill has transitioned to or is otherwise associated with a particular state. In some embodiments, some services may utilize flock configurations that express progress using capabilities, while other services may utilize a service plan and manifest that defines a deterministic build process in which progress is expressed with capabilities and/or skills. Using the mapping (or multiple mappings) between skills and capabilities, Puffin Regional 120 may enable a region build to be performed using any suitable combination of capabilities and/or skills to indicate that 1) service or resource functionality is available, 2) a particular event has transpired, 3) a particular fact is true, 4) a condition has been met, or any suitable combination of the above. This mapping or mappings enable CIOS 102 to perform a region build/data center build using any suitable combination of capabilities and/or skills, enabling service teams to transition from capabilities-based implementations to skills-based implementations gradually.

In some embodiments, any suitable computing component of the Puffin Service (e.g., Puffin Central 118 and/or Puffin Regional 120) may be configured to monitor the health and/or lifecycle of a skill according to a predefined skill lifecycle. Health monitoring may be performed using one or more alarms that are associated with a given skill. In some embodiments, a telemetry service (e.g., an example of alarm service(s) 122) may utilize an application programming interface provided by the Puffin Service (including Puffin Central 118 and/or Puffin Regional 120) when an alarm is triggered. As another example, the Puffin Service (e.g., Puffin Regional 120) may request alarm data from the alarm service(s) 122 and/or from storage locations at which the alarm service(s) 122 store the alarm data. The Puffin Service may present, via one or more user interfaces, information related to the health of a skill based on the alarms corresponding to the alarm data obtained and their corresponding association to a given skill.

In some embodiments, the Puffin Service (e.g., Puffin Central 118 and/or Puffin Regional 120) may expose one or more application programming interfaces (APIs) with which validation operations may be performed. By way of example, a SPAM describing the build process with respect to one or more services may be provided via a given API (e.g., by the Orchestrator 106). The Puffin Service (e.g., Puffin Central 118) may execute any suitable operations for validating that all services and skills identified in the SPAM have been previously registered with the Puffin Service and that the build process defined in the SPAM does not violate previously defined dependency relationships maintained by the Puffin Service.

Additionally, or alternatively, Orchestrator 106 may perform any suitable validation check such as determining whether each flock config and/or artifact identified in a given service's manifest is referenced within the service's corresponding service plan and/or that no flock config and/or artifact is referenced within the service plan that is not referenced within the manifest. Orchestrator 106 may perform validation operations (e.g., a static analysis including parsing the service plan) to determine that a service plan lacks circular dependencies. If a circular dependency is found within a service plan, Orchestrator 106 may provide a notification and/or restrict the service plan and corresponding manifest from being utilized. In some embodiments, such restrictions may include restricting the service plan and manifest from being added to a SPAM set (e.g., a set of SPAMs to be used to perform a region build). In some embodiments, the Orchestrator 106 may perform any suitable validation operations to ensure that SPAMs of a SPAM set and/or a SPAM that is being considered as an addition to a preexisting SPAM set are mutually compatible. This may include analyzing the SPAM set (alone or with a SPAM that is being considered for addition) to ensure that the SPAMs of the SPAM set do not include circular dependencies.

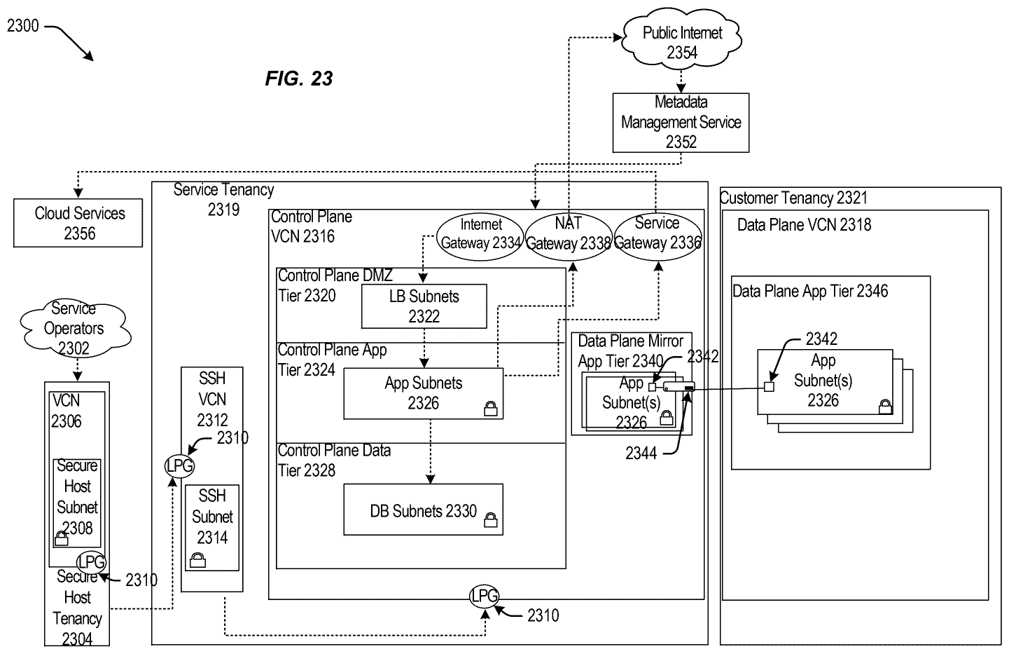

In some embodiments, a user can request that a new region (e.g., target region 114) be built. This can involve bootstrapping resources corresponding to a variety of services. In some embodiments, target region 114 may not be communicatively available (and/or secure) at a time at which the region build request is initiated. Rather than delay bootstrapping until such time as target region 114 is available and configured to perform bootstrapping operations, CIOS 102 may initiate the region build using a virtual bootstrap environment (e.g., Virtual Bootstrap Environment (ViBE) 116. ViBE 116 may be an overlay network that is hosted by host region 103 (a preexisting region that has previously been configured with a core set of services and which is communicatively available and secure). Orchestrator 106 can leverage resources of the host region 103 to bootstrap resources to the VIBE 116 (generally referred to as “building the ViBE”). By way of example, Orchestrator 106 can provide instructions through CIOS Central 108 that cause an instance of CIOS Regional 110 within a host region (e.g., host region 103) to bootstrap another instance of CIOS Regional within the VIBE 116. Once the CIOS Regional within the ViBE is available for processing, bootstrapping the services for the target region 114 can continue within the VIBE 116. When target region 114 is available to perform bootstrapping operations, the previously bootstrapped services within ViBE 116 may be migrated to target region 114. Utilizing these techniques, CIOS 102 can greatly improve the speed at which a region is built by drastically reducing the need for any manual input and/or configuration to be provided. In some embodiments, any suitable combination of the components depicted as part of CIOS 102 may individually be examples of the cloud services of FIGS. 23-26 (e.g., 2356 of FIG. 23) and may be configured to operate in any suitable infrastructure pattern such as the examples described below in connection with FIGS. 23-26.

FIG. 2 is a block diagram for illustrating an environment and method 200 for building a virtual bootstrap environment (ViBE) 202 (an example of ViBE 116 of FIG. 1), according to at least one embodiment. ViBE 202 represents a virtual cloud network that is provisioned in the overlay of an existing region (e.g., host region 204, an example of the host region 103 of FIG. 1 and in an embodiment is a Host Region Service Enclave). ViBE 202 represents an environment in which services can be staged for a target region (e.g., a region under build such as target region 114 of FIG. 1) before the target region becomes available.

In order to bootstrap a new region (e.g., target region 114 of FIG. 1), a core set of services may be bootstrapped. While those core set of services exist in the host region 204, they do not yet exist in the ViBE (nor the target region). These essential core services provide the functionality needed to provision devices, establish a chain of trust to the new region, and deploy remaining services into a region. The ViBE 202 may be a tenancy that is deployed in a host region 204 and used as a virtual region.

When the target region is available to provide bootstrapping operations, the VIBE 202 can be connected to the target region so that services in the ViBE can interact with the services and/or infrastructure components of the target region. This will enable deployment of production level services, instead of self-contained seed services as in previous systems, and may be connected over the internet to the target region. Conventionally, a seed service was deployed as part of a container collection and used to bootstrap dependencies necessary to build out the region. Using infrastructure/tooling of an existing region, resources may be bootstrapped (e.g., provisioned and deployed) into the VIBE 202 and connected to the service enclave of a region (e.g., host region 204) in order to provision (reserve and/or configure) hardware and deploy services until the target region is self-sufficient and can be communicated with directly. Utilizing the ViBE 202 allows for meeting the dependencies and providing the services needed to be able to provision/prepare infrastructure and deploy software while making use of the host region's resources in order to break circular dependencies of core services.

Orchestrator 206 (an example of Orchestrator 106 of FIG. 1) may be configured to perform operations to build (e.g., configure) ViBE 202. Orchestrator 206 can obtain applicable flock configs and/or SPAMs corresponding to various resources to be bootstrapped to the new region (in this case, a ViBE region, ViBE 202). By way of example, Orchestrator 206 may obtain a flock config (e.g., a “ViBE flock config”) that identifies aspects of bootstrapping Capabilities Service 208 (e.g., an example of Capabilities Service 112) and/or Worker 210. In some embodiments, Orchestrator 206 may additionally obtain a flock configuration identifying aspects of bootstrapping any suitable portion of a skills service (e.g., Puffin Regional 120 of FIG. 1). In some embodiments, one or more service plan and manifests (SPAMs) may be used to identify these aspects (e.g., specifying operations previously defined in one or more flock configuration files and/or the resources/artifacts that may be needed (or are needed) to bootstrap a service from start to finish) for bootstrapping any suitable combination of Capabilities Service 208, Worker 210, and/or Puffin Regional 209. As another example, Orchestrator 206 may obtain another flock config and/or SPAM corresponding to bootstrapping Domain Name Service (DNS) 212 to ViBE 202.

The method 200 may begin at step 1, where Orchestrator 206 may instruct CIOS Central 214 (e.g., an example of CIOS Central 108 and CIOS Central 214 of FIGS. 1 and 2, respectively). For example, Orchestrator 206 may transmit a request (e.g., including the ViBE flock config, which may be one flock config identified in a service plan) to request bootstrapping of the Capabilities Service 208 and Worker 210 (and in some embodiments, Puffin Regional 209) that, at this time do not yet exist in the ViBE 202. In some embodiments, a corresponding SPAM for the Capabilities Service 208, Worker 210, and/or Puffin Regional 209 may be utilized in lieu of or in addition to the ViBE flock config. In some embodiments, CIOS Central 214 may have access to all flock configs and/or SPAMs. Therefore, in some examples, Orchestrator 206 may transmit an identifier for the ViBE flock config and CIOS Central 214 may independently obtain the ViBE flock config from storage (e.g., from database (DB) 308 or DB 312 of FIG. 3).

At step 2, CIOS Central 214 may provide the ViBE flock config via a corresponding request to CIOS Regional 216. CIOS Regional 216 may parse the ViBE flock config to identify and execute specific infrastructure provisioning and deployment operations at step 3.

In some embodiments, the CIOS Regional 216 may utilize additional corresponding services for provisioning and deployment. For example, at step 4, CIOS Regional 216 CIOS Regional may instruct deployment orchestrator 218 (e.g., an example of a core service, or other write, build, and deploy applications software, of the host region 204) to execute instructions that in turn cause Capabilities Service 208, Worker 210, and in some embodiments Puffin Regional 209, to be bootstrapped within ViBE 202.

At step 5, capabilities data may be transmitted to the Capabilities Service 208 (from the CIOS Regional 216, Deployment Orchestrator 218 via the Worker 210 or otherwise) indicating that resources corresponding to the ViBE flock are available. Capabilities Service 208 may persist this data. In some embodiments, the Capabilities Service 208 adds this information to a list it maintains of available capabilities with the ViBE. By way of example, the capability provided to Capabilities Service 208 at step 5 may indicate the Capabilities Service 208 and Worker 210 (and in some embodiments, Puffin Regional 209) are available for processing. In some embodiments, skills metadata may be transmitted to Puffin Regional 209 indicating that any suitable combination of functionality corresponding to the Capabilities Service 208, Worker 210, and/or Puffin Regional 209 is available.

At step 6, Orchestrator 206 may identify that the Capabilities Service 208, Worker 210, and/or Puffin Regional 209 are available based on receiving or obtaining data (an identifier corresponding to a capability and/or skill) from the Capabilities Service 208 and/or Puffin Regional 209.

In some embodiments, published capabilities may be processed by Puffin Regional 209 (e.g., Puffin Regional 120 of FIG. 1) prior to processing by Orchestrator 206. In some embodiments, Puffin Regional 209 may be configured to provide forward and backward compatibility between skills and capabilities. By way of example, in some embodiments, if a capability is published to Puffin Regional 209, Puffin Regional 209 may query known skills (e.g., via a skills table or other suitable record of registered/previously generated skills) to check if any skill is associated with the capability. If no skill is associated with the capability, Puffin Regional 209 may be configured to create a skill (referred to as a “shadow skill) to represent the capability using the skill construct (e.g., including the data structures discussed below in connection with FIG. $4). When orchestrator 206 publishes skills (or updates skill state) during the process of performing a region build, Puffin Regional 209 may receive this data and identify one or more capabilities that are associated with the corresponding skill(s). Puffin Regional 209 may publish any or all capabilities associated with the skill that have not yet been published. In some embodiments, publishing such data may include storing an indication that these capabilities are available. In this manner, Puffin Regional 209 may support full compatibility between capabilities and skills such that any suitable combination of the two may be utilized to drive the operations performed during a region build.

Although some embodiments describe shadow skill generation being conducted at build time, it should be appreciated that the Puffin Service may generate shadow skills at any suitable time and according of a variety of methods. By way of example, historical capabilities data (e.g., capabilities data historically published during one or more previous region builds) may be obtained by the Puffin Service (e.g., Puffin Central 118 and/or Puffin Regional 120 of FIG. 1, and/or Puffin Regional 209 of FIG. 2, etc.) at any suitable time (e.g., prior to initiation of a region build, prior to deployment within the region, upon completion of region build, etc.). In some embodiments, the historical capabilities data may be stored (e.g., by an instance of Capabilities Service 112 of FIG. 1) in a data store that is accessible the Puffin Service. The Puffin Service may process the historical capabilities data (e.g., one or more files, records, tables, data structures, etc.) to identify one or more capabilities for which no corresponding skill currently exists. Identifying a corresponding skill may include matching any suitable portion of a tag or label of a capability with any suitable attribute and/or portion of an attribute (e.g., one or more tokens/words of a service name and/or identifier) associated with a service. A shadow skill may be generated by the Puffin Service for each historically published capability that fails to match any known skills. As described above, these shadow skills may be configured to represent a corresponding historically published capability and may be used to maintain compatibility between skills and capabilities, and between skill-based service build definitions (e.g., a SPAM) and capability-based service build definitions (e.g., a flock, a SPAM, etc.).

At step 7, as a result of receiving/obtaining the data at step 6, the Orchestrator 206 may instruct CIOS Central 214 to bootstrap a DNS service (e.g., DNS 212) to the VIBE 202. The instructions may identify or include a particular flock config and/or SPAM corresponding to the DNS service.

At step 8, the CIOS Central 214 may instruct the CIOS Regional 216 to deploy DNS 212 to the VIBE 202. In some embodiments, the DNS flock config and/or SPAM for the DNS 212 may be provided by the CIOS Central 214.

At step 9, Worker 210, now that it is deployed in the VIBE 202, may be assigned by CIOS Regional 216 to the task of deploying DNS 212. Worker may execute a declarative infrastructure provisioner in the manner described above in connection with FIG. 3 to identify a set of operations that are needed to deploy DNS 212. These operations may be identified based at least in part on from comparing the flock config (the desired state), or corresponding portion of a SPAM, to a current state of the (currently non-existing) resources associated with DNS 212.

At step 10, the Deployment Orchestrator 218 may instruct Worker 210 to deploy DNS 212 in accordance with the operations identified at step 9. As depicted, Worker 210 proceeds with executing operations to deploy DNS 212 to ViBE 202 at step 11. At step 12, Worker 210 may notify Capabilities Service 208 (via a capability) or Puffin Regional 209 (directly, or via Capabilities Service 208 and using a skill) that DNS 212 is available in ViBE 202. Orchestrator 206 may subsequently identify that the resources associated with the ViBE flock config and the DNS flock config are available any may proceed to bootstrap any suitable number of additional resources to the ViBE.

After steps 1-12 are concluded, the process for building the VIBE 202 may be considered complete and the VIBE 202 may be considered built and ready for additional bootstrapping (e.g., the bootstrapping of various cloud services such as cloud services 2356 of FIG. 23). At any suitable time during steps 1-12, Puffin Regional 209 may receive and/or obtain alarm data from one or more alarm services (e.g., the alarm service(s) 122 of FIG. 1). In some embodiments, the alarm data may be processed by Puffin Regional 209 (or Puffin Regional 209 may communicate the alarm data or data derived from the alarm data to Puffin Central 118 of FIG. 1). In some embodiments, Puffin Regional 209 (and/or Puffin Central 118) may communicate skill health information to Orchestrator 206 indicating corresponding health states associated with one or more skills. In some embodiments, Puffin Regional 209, Puffin Central 118, and/or Orchestrator 206 may be configured to execute operations that may pause (partially or fully) any suitable portion of the operations discussed above in connection with the method 200. In some embodiments, this may cause a regions state associated with the region within which method 200 is executed, to be updated to a state that indicates the build of the region is paused. In some embodiments, Puffin Regional 209, Puffin Central 118, and/or Orchestrator 206 may be configured to resume the operations of method 200 (and update the region state accordingly) based at least in part on user input, on subsequent alarm data indicating an update to a health state of one or more skills, on a skill health override value, or the like.

FIG. 3 is a block diagram for illustrating an environment and method 300 for bootstrapping services to a target region utilizing the ViBE, according to at least one embodiment.

The method 300 may begin at step 1, where user 302 (e.g., a service team member) may interact with any suitable number of user interfaces managed by Puffin Central 340 (e.g., Puffin Central 118 of FIG. 1). Puffin Central 340 may be configured to read service and/or skill metadata from predefined files or the user 302 may enter service metadata and/or skill metadata at one or more of the provided user interfaces. In some embodiments, Puffin Central 340 may store all service and skill metadata and serve as a centralized authority for the same. At any suitable time, any suitable user may view the service and/or skill metadata such as prior to and/or during performance of the region build.

At step 2, user 303 may utilize any suitable user interface provided by CIOS Central 304 (an example of CIOS Central 108 and CIOS Central 214 of FIGS. 1 and 2, respectively) to modify region data. By way of example, user 303 may create a new region to which a number of services are to be bootstrapped.

At step 3, CIOS Central 304 may execute operations to send the change to RRDD 306 (e.g., an example of RRDD 104 of FIG. 1). At step 4, RRDD 306 may store the received region data in database 308, a data store configured to store region data including any suitable identifier, attribute, state, etc. of a region, AD, realm, ET, or the like. In some embodiments, updater 307 may be utilized to store region data in database 308 or any suitable data store from which such updates may be accessible (e.g., to service teams). In some embodiments, updater 307 may be configured to notify (e.g., via any suitable electronic notification) of updates made to database 308.

At step 5, Orchestrator 310 (an example of the Orchestrator 106 and/or 206 of FIGS. 1 and 2, respectively) may detect the change in region data. In some embodiments, Orchestrator 310 may be configured to poll RRDD 306 for changes in region data. In some embodiments, RRDD 306 may be configured to publish or otherwise notify Orchestrator 310 of region data changes.

At step 6, detecting the change in region data may trigger Orchestrator 310 to obtain a version set (e.g., a version set associated with a particular identifier such as a “golden version set” identifier) identifying a particular version for each flock config and a particular version for each artifact to be used to build the region. The version set may be obtained from DB 312. As flock configs and/or artifacts evolve and change over time, multiple versions of each may be maintained, and certain versions of each may be used for a region build. The version set may be persisted in DB 312 such that Orchestrator 310 may identify which versions of flock configs and artifacts to use for building a region (e.g., a ViBE region, a Target Region/non-ViBE Region, etc. The flock configs (e.g., all versions of the flock configs) and/or artifacts (e.g., all versions of the artifacts) may be stored in DB 308, DB 312, or any suitable data store accessible to the CIOS Central 304 and/or Orchestrator 310.

In some embodiments, Orchestrator 310 may identify any suitable number of SPAMs (collectively referred to as a “SPAM set”) corresponding to the infrastructure to be provisioned and artifacts to be deployed as part of a region build. In some embodiments, each SPAM may identify versions corresponding to one or more flock configs and/or one or more artifacts that may be needed (or are needed) to build a single service. In embodiments in which one or more SPAMs are utilized, the SPAM(s) (or any suitable portion of the SPAM(s)) may be stored within DB 312 and utilized to identify the particular flock config and/or artifact versions to be utilized for building the region. In some embodiments, the flock configs and/or artifact versions of a SPAM set may be included in the version set and stored within DB 312. This enables some service teams to utilize a set of flock configs to define their service's build implementation while other service teams may choose to utilize a SPAM to define their service's build implementation.

In some embodiments, any suitable flock version sets and/or version set items may be derived from any suitable number of SPAMs and the Orchestrator 310 may be configured to verify compliance of a flock's behavior (e.g., the build/orchestration operations identified within a flock config) complies with the process defined by a corresponding SPAM. The Orchestrator 310 may be configured to ingest SPAMs which provide the information that may be required (or in some cases, that is required) to build an up-front plan of work and to introduce better guardrails than those available in previous implementations. Any suitable number of SPAMs may be aggregated into corresponding SPAM sets in a similar way that flocks may be aggregated into version sets. SPAM sets may enforce the invariant that all SPAMs within the set are mutually compatible and compose together to form a viable graph of releases required to build a region. In some embodiments, SPAM sets may be used within a given regional context to improve service build progress tracking. SPAM operations may be validated before they are applied and rejected if they are invalid, unlike version set item operations which were unconditionally applied. The utilization of SPAMs may enable the Orchestrator 310 to build a deterministic plan of work prior to building a region, to block updates that would jeopardize or break an ongoing or future build, to improve the tracking of process of a service build, to detect deviations of flock behavior from the SPAM's specification, and to alert operators of deviations and status.

At step 7, Orchestrator 310 may request CIOS Central 304 to recompile each of the flock configs associated with the version set (including any suitable number of flock configs identified by a SPAM of a SPAM set) with the current region data. In some embodiments, the request may indicate a version for each flock config and/or artifact.

At step 8, CIOS Central 304 may obtain current region data from the DB 308 (e.g., directly, or via Real-time Regional Data Distributor 306) and retrieve any suitable flock config and artifact in accordance with the versions requested by Orchestrator 310.

At step 9, CIOS Central 304 may recompile the obtained flock configs with the region data obtained at step 8 to inject those flock configs with current region data. CIOS Central 304 may return the compiled flock configs to Orchestrator 310. In some embodiments, CIOS Central 304 may simply indicate compilation is done, and Orchestrator 310 may access the recompiled flock configs via RRDD 306.

In some embodiments, at step 10, Orchestrator 310 may perform a static flock analysis of the recompiled flock configs (and/or SPAMs). As part of the static flock analysis, Orchestrator 310 may parse the flock configs (and/or SPAMs) (e.g., using a library associated with a declarative infrastructure provisioner (e.g., Terraform®, or the like)) to identify dependencies. Data generated by the static flock analysis (e.g., “SFA data,” including the identified dependencies) may be stored for subsequent use. From the analysis and the dependencies identified (e.g., the SFA data), Orchestrator 310 may generate any suitable number of data structures (e.g., directed acyclic graphs) that identify an order for releases identified in the flock configs (or from any suitable portion of one or more service plans, such as from a flock config entity of the service plan). A DAG that is generated based on a flock config and that specifies the releases and order of releases necessary to build a service may be referred to as a “service DAG.” In some embodiments, Orchestrator 310 may generate a directed acyclic graph (referred to as a “build diagram”) corresponding to each SPAM in which each node represents a build milestone with edges indicating execution units and capabilities (and/or skills) that transition the service between build milestones. Each execution unit may represent a number of releases that, when performed, transition the service between build milestones. Any suitable number of service DAGs can be composed together to form Build Dependency Graph 338. Build Dependency Graph 338 may be an acyclic directed graph that identifies an order by which releases are to be executed to bootstrap one or more services within the new region.

In some embodiments, Build Dependency Graph 338 may be a region-level dependency graph that includes every release that may be needed (or that is needed) for every service to be bootstrapped within the region/data center. Each node in the Build Dependency Graph 338 may correspond to bootstrapping any suitable portion of a service. By way of example, each node of the Build Dependency Graph 338 may correspond to a single release. The specific bootstrapping order (e.g., the order of release execution) may be identified based at least in part on the dependencies. In some embodiments, the dependencies may be expressed as an attribute of the node and/or indicated via edges of the graph that connect the nodes. Orchestrator 310 may traverse the Build Dependency Graph 338 (e.g., beginning at a starting node) to drive the operations of the region build. Any suitable portion of a service DAG and/or the Build Dependency Graph 338 may be presented via one or more user interfaces (e.g., one or more interfaces provided by any suitable component of CIOS 102 of FIG. 1, including orchestrator 310, CIOS Central 304, or the like).

In some embodiments, Orchestrator 310 may utilize a cycle detection algorithm to detect the presence of a cycle (e.g., service A depends on service B and vice versa). Orchestrator 310 can identify orphaned capabilities dependencies. For example, Orchestrator 310 can identify orphaned nodes of the Build Dependency Graph 338 that do not connect to any other nodes. Orchestrator 310 may identify falsely published capabilities (e.g., when a capability was prematurely published, and the corresponding functionality is not actually yet available). Orchestrator 310 can detect from the graph that one or more instances of publishing the same capability exist. In some embodiments, any suitable number of these errors may be detected and Orchestrator 310 (or another suitable component such as CIOS Central 304) may be configured to notify or otherwise present this information to users (e.g., via an electronic notification, a user interface, or the like). In some embodiments, Orchestrator 310 may be configured to force delete/recreate resources to break circular dependencies and may once again provide instructions to CIOS Central 304 to perform bootstrapping operations for those resources and/or corresponding flock configs.

A starting node of the Build Dependency Graph 338 may correspond to building the ViBE 316 (or individual services within the ViBE), a second node may correspond to bootstrapping DNS. The steps 11-16 may correspond to deploying (via deployment orchestrator 317, an example of the deployment orchestrator 218 of FIG. 2) the resources and/or artifacts identified in a corresponding VIBE flock config or SPAM to ViBE 316 (e.g., an example of ViBE 116 and 202 of FIGS. 1, and 2, respectively). That is, steps 11-16 of FIG. 3 generally correspond to steps 1-6 of FIG. 2. Once notified that capabilities (or skills) exist (e.g., indicating that Capabilities Service 318, Worker 320, and/or Puffin Regional 342, corresponding to Capabilities Service 208, Worker 210, and Puffin Regional 209 of FIG. 2, respectively, are deployed/available) the Orchestrator 310 may recommence traversal of the Build Dependency Graph 338 to identify which operations/releases to be executed next.

Orchestrator 310 may continue traversing the Build Dependency Graph 338 to identify that one or more releases corresponding to deploying DNS 322 are to be executed. Steps 17-22 may be executed to deploy DNS 322 (an example of the DNS 212 of FIG. 2). These operations may generally correspond to steps 7-12 of FIG. 2.

At step 22, a capability (or skill) may be published and/or stored indicating that DNS 322 is available. In some embodiments, CIOS Regional 314 and/or Deployment Orchestrator 317 may initially communicate the availability of the capability or skill (e.g., to Capabilities Service 318 or Puffin Regional 342, respectively). If a skill is published, Puffin Regional 342 may transmit data to Capabilities Service 318 to indicate one or more corresponding capabilities are published. Upon detecting the publishing of a capability (e.g., via data provided by Capabilities Service 318, perhaps triggered based on skill-related data provided by Puffin Regional 342), Orchestrator 310 may recommence traversal of the Build Dependency Graph 338. On this traversal, the Orchestrator 310 may identify that any suitable portion of an instance of CIOS Regional (e.g., an example of CIOS Regional 314) is to be deployed to the VIBE 316. In some embodiments, steps 17-22 may be substantially repeated with respect to deploying CIOS Regional (ViBE) 326 (an instance of CIOS Regional 314, CIOS Regional 110 of FIG. 1) and

Worker 328 to the VIBE 316. A capability may be transmitted to the Capabilities Service 318 that CIOS Regional (ViBE) 326 is available. If a skill is used to indicate that CIOS Regional (ViBE) 326 is available, Puffin Regional 342 may transmit data to Capabilities Service 318 indicating one or more corresponding capabilities are available. The interactions between Puffin Regional 342 and Capabilities Service 318 enable any suitable combination of capabilities and/or skills to be utilized to express progress through the region build. In some embodiments, when the Build Dependency Graph 338 identifies transitions through capability publishing and dependencies, progress evidenced with skill publishing may be used to trigger corresponding capabilities publishing to enable skills to trigger progress of the region build.

Upon detecting the CIOS Regional (ViBE) 326 is available, Orchestrator 310 may recommence traversal of the Build Dependency Graph 338. On this traversal, the Orchestrator 310 may identify that a deployment orchestrator (e.g., Deployment Orchestrator 330, an example of the Deployment Orchestrator 317) is to be deployed to the VIBE 316. In some embodiments, steps 16-21 may be substantially repeated with respect to deploying Deployment Orchestrator 330. Information that identifies a capability may be transmitted to the Capabilities Service 318 (e.g., by CIOS Regional 314, worker 320, and/or Puffin Regional 342), indicating that Deployment Orchestrator 330 is available.

After Deployment Orchestrator 330 is deployed, ViBE 316 may be considered available for processing subsequent requests. Upon detecting Deployment Orchestrator 330 is available, Orchestrator 310 may instruct subsequent bootstrapping requests to be routed to ViBE components rather than utilizing host region components (components of host region 332). Thus, Orchestrator 310 can continue traversing the Build Dependency Graph 338, at each node instructing release execution to the VIBE 316 via CIOS Central 304. CIOS Central 304 may transmit release requests CIOS Regional (ViBE) 326 to effectuate release execution as instructed by Orchestrator 310.

At any suitable point during this process, Target Region 334 may become available. Indication that the Target Region is available may be identifiable from region data for the Target Region 334 being provided by the user 303 (e.g., as an update to the region data). The availability of Target Region 334 may depend on establishing a network connection between the Target Region 334 and external networks (e.g., the Internet). The network connection may be supported over a public network (e.g., the Internet), but use software security tools (e.g., IPSec) to provide one or more encrypted tunnels (e.g., IPSec tunnels such as tunnel 336) from the ViBE 316 to Target Region 334. As used herein, “IPSec” refers to a protocol suite for authenticating and encrypting network traffic over a network that uses Internet Protocol (IP) and can include one or more available implementations of the protocol suite (e.g., Openswan, Libreswan, strongSwan, etc.). The network may connect the VIBE 316 to the service enclave of the Target Region 334.

Prior to establishing the IPSec tunnels, the initial network connection to the Target Region 334 may be on a connection (e.g., an out-of-band VPN tunnel) sufficient to allow bootstrapping of networking services until an IPSec gateway may be deployed on an asset (e.g., bare-metal asset) in the Target Region 334. To bootstrap the Target Region's network resources, Deployment Orchestrator 330 can deploy the IPSec gateway at the asset within Target Region 334. The Deployment Orchestrator 330 may then deploy VPN hosts at the Target Region 334 configured to terminate IPSec tunnels from the VIBE 316. Once services (e.g., Deployment Orchestrator 330, Service A, etc.) in the ViBE 316 can establish an IPSec connection with the VPN hosts in the Target Region 334, bootstrapping operations from the ViBE 316 to the Target Region 334 may begin.

In some embodiments, the bootstrapping operations may begin with services in the ViBE 316 provisioning resources in the Target Region 334 to support hosting instances of core services as they are deployed from the VIBE 316. For example, a host provisioning service may provision hypervisors on infrastructure (e.g., bare-metal hosts) in the Target Region 334 to allocate computing resources for VMs. When the host provisioning service completes allocation of physical resources in the Target Region 334, the host provisioning service may publish information indicating a capability that indicates that the physical resources in the Target Region 334 have been allocated. The capability may be published to Capabilities Service 318 via CIOS Regional (ViBE) 326 (e.g., by Worker 328).

With the hardware allocation of the Target Region 334 established and posted to Capabilities Service 318, CIOS Regional (ViBE) 326 can orchestrate the deployment of instances of core services from the VIBE 316 to the Target Region 334. This deployment may be similar to the processes described above for building the ViBE 316, but using components of the ViBE (e.g., CIOS Regional (ViBE) 326, Worker 328, Deployment Orchestrator 330) instead of components of the Host Region 332 service enclave (e.g., CIOS Regional 314 and Deployment Orchestrator 317). The deployment operations may generally correspond to steps 17-22 described above.

As a service is deployed from the ViBE 316 to the Target Region 334, the DNS record associated with that service may correspond to the instance of the service in the VIBE 316. The DNS record associated with the service may be updated at any suitable time to complete deployment of the service to the Target Region 334. Said another way, the instance of the service in the ViBE 316 may continue to receive traffic (e.g., requests) until the DNS record is updated.

A service may deploy partially into the Target Region 334 and publish information indicating a capability (e.g., to Capabilities Service 318) that the service is partially deployed. For example, a service running in the ViBE 316 may be deployed into the Target Region 334 with a corresponding compute instance, load balancer, and associated applications and other software, but may need to wait for database data to migrate to the Target Region 334 before being completely deployed. The DNS record (e.g., managed by DNS 322) may still be associated with the service in the VIBE 316. Once data migration for the service is complete, the DNS record may be updated to point to the operational service deployed in the Target Region 334. The deployed service in the Target Region 334 may then receive traffic (e.g., requests) for the service, while the instance of the service in the ViBE 316 may no longer receive traffic for the service.

At any suitable time during method 300, Puffin Regional 209 may receive and/or obtain alarm data from one or more alarm services (e.g., the alarm service(s) 344, an example of the alarm service(s) 122 of FIG. 1). In some embodiments, the alarm data may be processed by Puffin Regional 342 (or Puffin Regional 342 may communicate the alarm data or data derived from the alarm data to Puffin Central 340). In some embodiments, Puffin Regional 342 and/or Puffin Central 340 may communicate skill health information to Orchestrator 310 indicating corresponding health states associated with one or more skills. In some embodiments, Puffin Regional 342, Puffin Central 340, and/or Orchestrator 310 may be configured to execute operations that pause or otherwise halt any suitable portion of the operations discussed above in connection with the method 300. In some embodiments, Puffin Regional 342, Puffin Central 340, and/or Orchestrator 310 may be configured to resume and/or execute any suitable portion of the operations of method 300 (e.g., based at least in part on user input, subsequent alarm data indicating an update to a health state associated with one or more skills, based at least in part on a skill health override value, or the like).

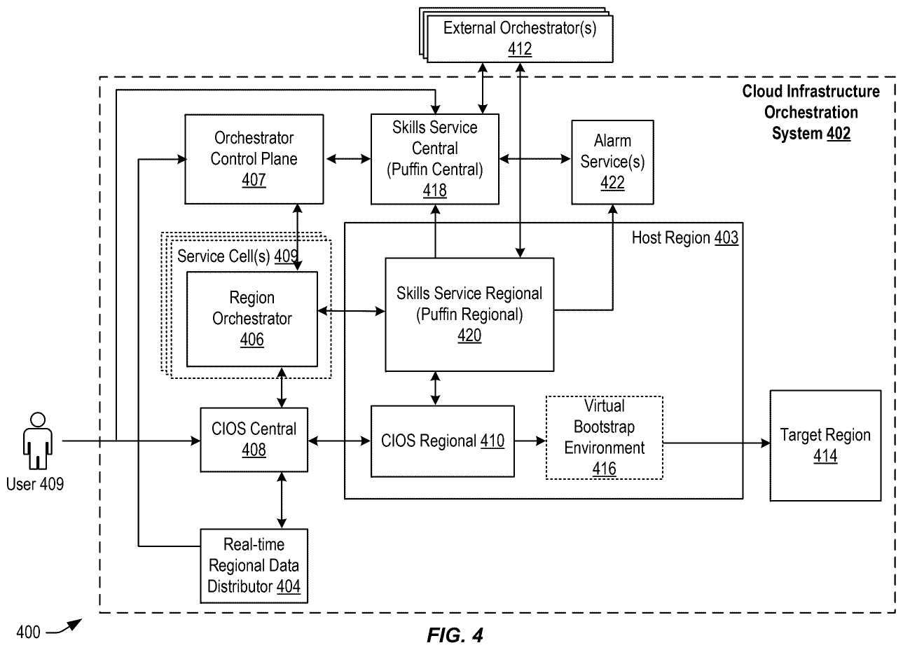

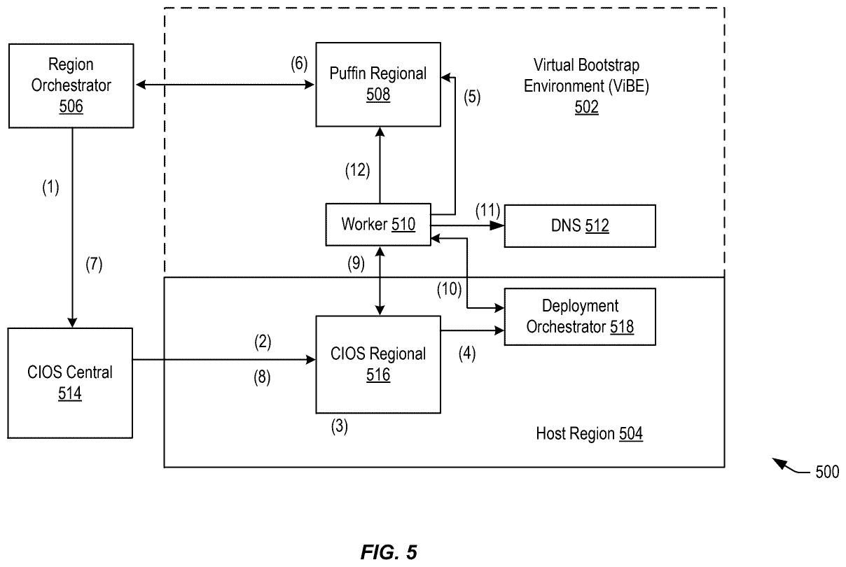

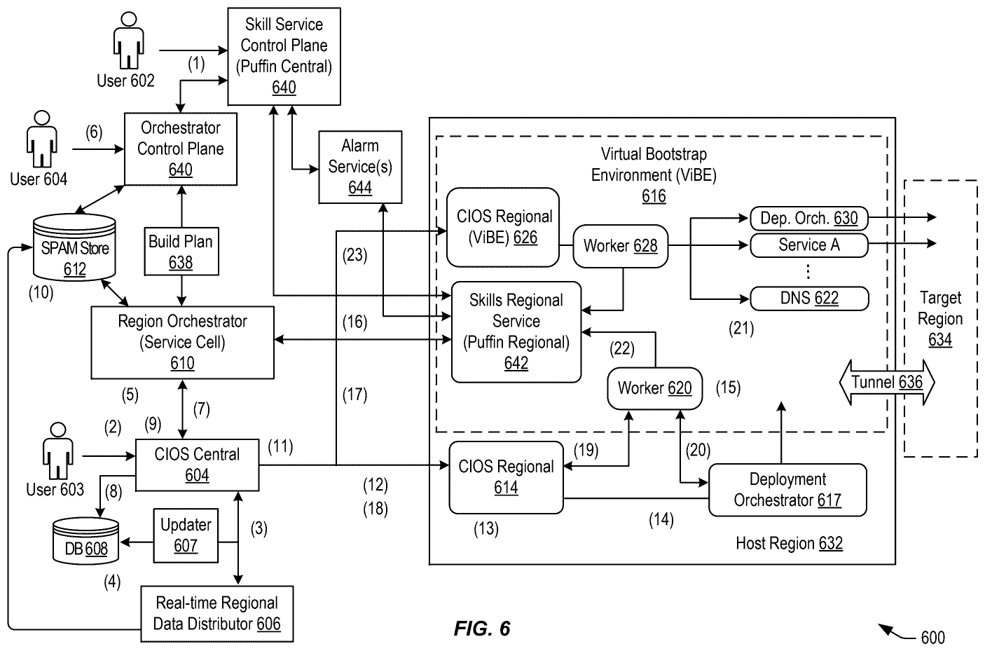

FIG. 4 is a block diagram of an environment 400 in which another example Cloud Infrastructure Orchestration System (CIOS) (e.g., CIOS 402) may operate to dynamically bootstrap services in a region/data center, according to at least one embodiment. CIOS 402 can include, but is not limited to, the following components: Real-time Regional Data Distributor (RRDD) 404, Region Orchestrator 406 (operating in a corresponding service cell of service cell(s) 409), Orchestrator Control Plane 407, CIOS Central 408, CIOS Regional 410, Virtual Bootstrap Environment 416, Puffin Central 418, Puffin Regional 420, and Alarm Service(s) 422. In some embodiments, any suitable combination of the components of CIOS 402 may be provided as a service. In some embodiments, some portion of CIOS 402 may be deployed to a region (e.g., a data center represented by host region 403). In some embodiments, CIOS 402 may include any suitable number of cloud services (not depicted in FIG. 4) discussed in further detail below with respect to FIGS. 5 and 6.

Real-time Regional Data Distributor (RRDD) 404 may be configured to maintain and provide region data that identifies realms (which may include one or more regions), regions (which may include one or more availability domains), execution targets, and availability domains. In some cases, the region data may be in any suitable form (e.g., JSON format, data objects/containers, XML, etc.). Region data maintained by RRDD 404 may include any suitable number of subsets of data which can individually be referenceable by a corresponding identifier. By way of example, an identifier “all_regions” can be associated with a data structure (e.g., a list, a structure, an object, etc.) that includes a metadata for all defined regions. As another example, an identifier such as “realms” can be associated with a data structure that identifies metadata for a number of realms and a set of regions corresponding to each realm. In general, the region data may maintain any suitable attribute of one or more realm(s), region(s), availability domains (ADs), execution target(s) (ETs), and the like, such as identifiers, DNS suffixes, states (e.g., a state of a region), and the like. The RRDD 404 may be configured to manage region state as part of the region data. A region state may include any suitable information indicating a state of bootstrapping within a region. By way of example, some example region states can include “initial,” “building,” “production,” “paused,” or “deprecated.” The “initial” state may indicate a region that has not yet been bootstrapped. A “building” state may indicate that bootstrapping of one or more flocks within the region has commenced. A “production” state may indicate that bootstrapping has been completed, and the region is ready for validation. A “paused” state may indicate that CIOS Central 408 or CIOS Regional 410 has paused internal interactions with the regional stack, likely due to an operational issue. A “deprecated” state may indicate the region has been deprecated and is likely unavailable and/or will not be contacted again.

CIOS Central 408 may be configured to provide any suitable number of user interfaces with which users (e.g., user 409) may interact with CIOS 402 or view data associated with one or more region builds. By way of example, users can make changes to region data via a user interface provided by CIOS Central 408. CIOS Central 408 may additionally provide a variety of interfaces that enable users to: view changes made to flock configs and/or artifacts, generate and view plans, approve/reject plans, view status on plan execution (e.g., corresponding to tasks involving infrastructure provisioning, deployment, region build, and/or desired state of any suitable number of resources managed by CIOS 402. CIOS Central 408 may implement a control plane configured to manage any suitable number of CIOS Regional 410 instances. CIOS Central 408 can provide one or more user interfaces for presenting region data, enabling the user 409 to view and/or change region data. CIOS Central 408 can be configured to invoke the functionality of RRDD 404 via any suitable number of interfaces. Generally, CIOS Central 408 (also referred to as a “provisioning and deployment manager”) may be configured to manage region data, either directly or indirectly (e.g., via RRDD 404). CIOS Central 408 may be configured to compile SPAMs to inject region data as variables within the SPAMs. CIOS Central 408 may be instructed (e.g., by region orchestrator 406) to perform one or more releases (e.g., infrastructure or application releases) according to a given SPAM.

Orchestrator Control Plane 407 may be configured to provide any suitable number of user interfaces with which users (e.g., user 409) may interact with CIOS 402 or view data associated with one or more region builds. Orchestrator Control Plane 407 may include a build planning module that may be configured to generate a region build plan. Additional details of region build plans, and their generation are provided in more detail with the following figures. In some embodiments, Orchestrator Control Plane 407 may be configured to provide and/or instruct any suitable number of region orchestrators (e.g., Region Orchestrator 408) operating in any suitable service cell (e.g., service cell(s) 409).

In some embodiments, an external orchestrator may be used in lieu of Region Orchestrator 408. In these instances, an external orchestrator (e.g., one of external orchestrator(s) 412) may communicate with the Region Orchestrator 406 via Puffin (e.g., Puffin Central 418 and/or Puffin Regional 420) by consuming the signals they wait for and signaling completion of their work via installation of Skills. When the region build plan reaches an external execution unit, the Region Orchestrator 406 may wait for an external orchestrator to signal completion via publishing the relevant skills.

Each instance of CIOS Regional 410 may correspond to a module configured to execute bootstrapping tasks that are associated with a service of a region (e.g., a data center such as host region 403). CIOS Regional 410 can receive desired state data from CIOS Central 408. In some embodiments, desired state data may correspond to an infrastructure or software release. In some embodiments, the desired state data may be expressed as part of a flock config that declares (e.g., via declarative statements) a desired state of resources associated with a service. CIOS Central 408 can maintain current state data indicating any suitable aspect of the current state of the resources associated with a service. In some embodiments, CIOS Regional 410 can identify, through a comparison of the desired state data and the current state data, that changes that may be (or are) needed to one or more resources. For example, CIOS Regional 410 can determine that one or more infrastructure components need to be provisioned, one or more artifacts deployed, or any suitable change that may be (or is) needed to the resources of the service to bring the state of those resources in line with the desired state. As CIOS Regional 410 performs bootstrapping operations, it may publish data indicating a transition of a skill from one state to another. A skill state may identify a unit of functionality associated with a service is, or is not, available. The unit could be a portion, or all of the functionality to be provided by the service. By way of example, data may be transmitted from CIOS Regional 410 to Puffin Regional 420 indicating that the state of a skill corresponding to a resource has transitioned to “installed,” indicating the resource is available for authorization/authentication processing (e.g., a subset of the functionality to be provided by the resource). Skills can be used to identify functionality on which a resource or service depends and/or functionality of a resource or service that is available for use. By way of example, in some embodiments, CIOS Regional 410 performs bootstrapping operations which result in publishing a skill (e.g., transmitting skill metadata including a skill state value). The skill metadata may be transmitted to Puffin (e.g., Puffin Regional 420) and used to update the skill state of the corresponding skill.

In some embodiments, Puffin Central 418 may provide a number of user interfaces with which one or more skills can be defined. A skill may be used in lieu of capabilities and enables improvements over previous capabilities-based implementations. Unlike capabilities, skills may be scoped (e.g., controllable through access and authorization policies), versioned, and attributed to a particular service and/or contact. Skills may be associated with a lifecycle and may be monitored for health and are designed to be more highly visible/accessible than capabilities. Puffin Central 418 may provide an authoritative registry for skills. Various user interfaces managed by Puffin Central 418 may be utilized to define, maintain, and manage skills that each service offers, as well as their dependency relationships with other services. Puffin Central 418 may be utilized to declare and persist strongly defined metadata of services in a versioned manner. This metadata may be used to generate a blueprint for build-time and run-time dependencies. These blueprints can be used to validate build plans, to drive orchestration decisions during region build, and to improve time-to-engage and time-to-diagnose measures during region build and/or Large-Scale Events (LSEs).

Puffin Central 418 may be configured to serve as a source of truth for services and may maintain metadata including each service's upstream and downstream dependencies and service team contact information and methods for each service across regions and realms (e.g., a set of regions). Each skill may represent a function unit that a service exposes and offers to consumers (e.g., other services). In some embodiments, skills may be scoped where access is controlled based on access and/or authorization policies and/or based on an association with a particular namespace. A skill may be associated with multiple versions in which one or more aspects of the skill differs from previous versions, where each skill version represents a specific implementation of the skill. Each skill version may be identifiable using a unique skill identifier.

In some embodiments, any suitable computing component of the Puffin Service (e.g., Puffin Central 418 and/or Puffin Regional 420) may be configured to monitor the health and/or lifecycle of a skill according to a predefined skill lifecycle. Health monitoring may be performed using one or more alarms that are associated with a given skill. In some embodiments, a telemetry service (e.g., an example of alarm service(s) 422) may utilize an application programming interface provided by the Puffin Service (including Puffin Central 418 and/or

Puffin Regional 420) when an alarm is triggered. As another example, the Puffin Service (e.g., Puffin Regional 420) may request alarm data from the alarm service(s) 422 and/or from storage locations at which the alarm service(s) 422 store the alarm data. The Puffin Service may present, via one or more user interfaces, information related to the health of a skill based on the alarms corresponding to the alarm data obtained and their corresponding association to a given skill.

In some embodiments, the Puffin Service (e.g., Puffin Central 418 and/or Puffin Regional 420) may expose one or more application programming interfaces (APIs) with which validation operations may be performed. By way of example, a SPAM describing the build process with respect to one or more services may be provided via a given API (e.g., by the Region Orchestrator 406). The Puffin Service (e.g., Puffin Central 418) may execute any suitable operations for validating that all services and skills identified in the SPAM have been previously registered with the Puffin Service and that the build process defined in the SPAM does not violate previously defined dependency relationships maintained by the Puffin Service. Additionally, or alternatively, Region Orchestrator 406 may perform any suitable validation check such as determining whether each flock config and/or artifact identified in a given service's manifest is referenced within the service's corresponding service plan and/or that no flock config and/or artifact is referenced within the service plan that is not referenced within the manifest. Region Orchestrator 406 may perform validation operations (e.g., a static analysis including parsing the service plan) to determine that a service plan lacks circular dependencies. If a circular dependency is found within a service plan, Region Orchestrator 406 may provide a notification and/or restrict the service plan and corresponding manifest from being utilized. In some embodiments, such restrictions may include restricting the service plan and manifest from being added to a SPAM set (e.g., a set of SPAMs to be used to perform a region build). In some embodiments, the Region Orchestrator 406 may perform any suitable validation operations to ensure that SPAMs of a SPAM set and/or a SPAM that is being considered as an addition to a preexisting SPAM set are mutually compatible. This may include analyzing the SPAM set (alone or with a SPAM that is being considered for addition) to ensure that the SPAMs of the SPAM set do not include circular dependencies.

In some embodiments, each regional component such as Region Orchestrator 406, CIOS Regional 410, Puffin Regional 420, and/or Virtual Bootstrap Environment 416 may be one of many regional components. Each regional component may be specific to a given region (e.g., as depicted in FIG. 4, Host Region 403). Therefore, another region may include similar, but separate, components that are specific to that region. In some embodiments, central components (e.g., Region Orchestrator 406, CIOS Central 408, RRDD 404, and Puffin Central 418) may include one or more components that are configured to manage build operations corresponding to one or more regions. By way of example only, a single orchestrator (Region Orchestrator 406) may be utilized to manage bootstrapping operations for building any suitable number of data centers, or multiple instances of Region Orchestrator 406 may be utilized, each driving the bootstrapping operations for a subset of those data centers or a single data center. In some embodiments, each Region Orchestrator 406 may operate within one of service cell(s) 409 and isolated from other instances of the Region Orchestrator 406.

In some embodiments, Region Orchestrator 406 (e.g., an orchestration service) may be configured to drive region build efforts. In some embodiments, Region Orchestrator 406 may manage information that describes which flock config versions and/or artifact versions are to be utilized to bootstrap a given service within a region (or to make a unit of change to a target region). In some embodiments, Region Orchestrator 406 may manage any suitable combination of flock configs and/or service plans. In some embodiments, Region Orchestrator 406 may be configured to monitor (or be otherwise notified of) changes to the region data managed by Real-time Regional Data Distributor 404. In some embodiments, receiving an indication that region data has been changed may cause a region build to be triggered by Region Orchestrator 406. In some embodiments, Region Orchestrator 406 may identify SPAMs to be used for a region build. Some, or all, of the SPAMs may be configured to be region agnostic. That is, the SPAMs may not explicitly identify what region(s) to which the flock is to be bootstrapped. In some embodiments, Region Orchestrator 406 may trigger a data injection process through which the collected flock configs and/or SPAMs are recompiled (e.g., by CIOS Central 408). During recompilation, operations may be executed (e.g., by CIOS Central 408) to cause the region data maintained by Real-time Regional Data Distributor 404 to be injected into the config files and/or SPAMs. SPAMs can reference region data through variables/parameters without requiring hard-coded identification of region data. Any suitable portion of the SPAMs can be dynamically modified at run time using this data injection rather than having the region data be hardcoded, and therefore, more difficult to change.

In some embodiments, Region Orchestrator 406 can perform a static analysis in which the identified service plans are parsed to identify execution targets, execution target checkpoints, phases, and flocks, and/or to identify circular dependencies between resources that need to be removed. In some embodiments static analysis data corresponding to this analysis may be stored (e.g., via SPAM store 612 of FIG. 6) for subsequent use. In some embodiments, Region Orchestrator 406 can generate any suitable number of data structures based on the dependencies identified. These data structures (e.g., directed acyclic graph(s), linked lists, etc.) may be utilized by CIOS 402 to drive operations for performing a region build. By way of example, these data structures may collectively define an order by which services are bootstrapped within a region.

An example of such a data structure is discussed further below with respect to Build Plan 638 of FIG. 6. If circular dependencies (e.g., a service A skill requires a service B skill and vice versa) exist and are identified through the static analysis and/or graph, Region Orchestrator 406 may be configured to notify any suitable service teams that changes are required to the corresponding SPAM to correct these circular dependencies. Region Orchestrator 406 can be configured to traverse one or more data structures to manage an order by which services are bootstrapped to a region. Region Orchestrator 406 can identify (e.g., using data obtained from Puffin Regional 420) the status of each skill within a given region at any suitable time. Region Orchestrator 406 may utilize this data to identify when it can bootstrap a service, when bootstrapping is blocked, and/or when bootstrapping operations associated with a previously blocked service can resume. Based on this traversal, Region Orchestrator 406 can perform a variety of releases in which instructions are transmitted by Orchestrator 406 to CIOS Central 408 to perform bootstrapping operations corresponding to any suitable number of flock configs.

In some embodiments, the service plans and manifests (SPAMs) utilized by Region Orchestrator 406 may provide a deterministic specification of a build description for a service than previously provided by one or more flock configs. While flock configs specify aspects of a single release associated with a single service, a service plan may provide a single specification of the order and conditional requirements for executing all of the releases that may be needed (or are needed) to build a given service. Previous implementations of flock configs included optional dependencies which allowed for a degree of indeterministic behavior with respect to the order of operations performed during a region build. The inclusion of optional dependencies required an orchestrator to perform multiple passes of the build dependency graph, resulting in wasteful processing. These types of dependencies make it difficult, if not impossible, for the system to track region build progress, identify remaining operations yet to be performed, and/or identify build completion. Service plans and manifests (SPAMs) may be utilized to eliminate at least some of the drawbacks to previous indeterministic approaches.

SPAMs (one SPAM corresponding to one service to be bootstrapped in the region) allow service teams to describe the corresponding operations that may be needed (or are needed) to build their service and may allow for separation between internal coordination (e.g., coordination of operations internal to the service) and external coordination (e.g., coordination of operations between components of different services). A number of visualizations may be provided (e.g., via Region Orchestrator 406 or any suitable component of CIOS 402) via one or more user interfaces. One visualization may depict a directed acyclic graph describing the build operations internal to a given service, and a separate visualization may depict a directed acyclic graph describing the order of build operations corresponding to multiple services (e.g., all services of the region/data center). As a specific example, one or more visualizations can present a region-level directed acyclic graph (DAG) including only external coordination (e.g., an order of operations corresponding to coordination between services) while omitting operations that are internal with respect to each service. This DAG, for example, may depict nodes corresponding to one service's skills on which other services depend, while excluding nodes corresponding to skill dependencies between service components/functional units of the same service.

A SPAM may include an external interaction interface that includes a service build definition that includes a number of build milestones. Each build milestone may be associated with a set of capabilities (and/or skills) that the service is expected to publish upon reaching a given milestone. To transition between build milestones, the SPAM may include execution units that encapsulate a directed acyclic graph (DAG) of one or more releases, each release being equivalent to operations previously defined with a single flock config. Each execution unit may define a set of build time dependencies that identify one or more capabilities (and/or skills) that are required by at least one of the releases of the execution unit.

A SPAM may include a service build implementation. An execution unit of the SPAM may describe one or more releases that may be needed (or are needed) to build a service, with potentially multiple execution units being defined. Each execution unit may be associated with one or more execution target checkpoint transitions, each of which may be used to specify the expected capabilities that should be available before the time of the release and the capabilities that should be published as the result of performing the release.

In some embodiments, the Region Orchestrator 406 may be configured to aggregate SPAMs corresponding to each service to be deployed in a region to generate a larger directed acyclic graph (e.g., the Build Plan 638 of FIG. 6) which may capture all of the operations necessary to build a region/data center. The collection of SPAMs identified from this aggregation may be referred to as a “SPAM set.” In some embodiments, the Region Orchestrator 406 may utilize the DAG generated from a SPAM set to validate a DAG and/or operations performed using flock configs, while the DAG generated from flock configs is used to drive build operations/release execution. Alternatively, the Region Orchestrator 406 may utilize the DAG generated from the SPAM set to drive build operations/release execution. The utilization of a SPAM/SPAM set may be utilized by the system to generate a deterministic execution plan with which the region build may be executed.

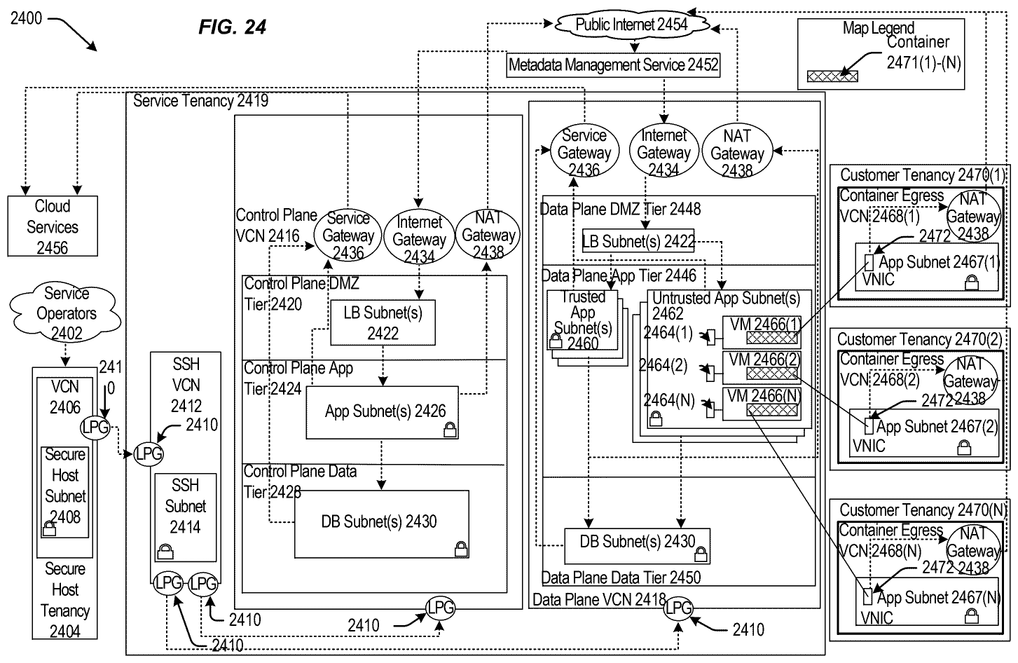

In some embodiments, a user can request that a new region (e.g., target region 414) be built. This can involve bootstrapping resources corresponding to a variety of services. In some embodiments, target region 414 may not be communicatively available (and/or secure) at a time at which the region build request is initiated. Rather than delay bootstrapping until such time as target region 414 is available and configured to perform bootstrapping operations, CIOS 402 may initiate the region build using a virtual bootstrap environment (e.g., Virtual Bootstrap Environment (ViBE) 416. ViBE 416 may be an overlay network that is hosted by host region 403 (a preexisting region that has previously been configured with a core set of services and which is communicatively available and secure). Region Orchestrator 406 may leverage resources of the host region 403 to bootstrap resources to the VIBE 416 (generally referred to as “building the ViBE”). By way of example, Region Orchestrator 406 may provide instructions through CIOS Central 408 that cause an instance of CIOS Regional 410 within a host region (e.g., host region 403) to bootstrap another instance of CIOS Regional within the VIBE 416. Once the CIOS Regional within the ViBE is available for processing, bootstrapping the services for the target region 414 can continue within the VIBE 416. When target region 414 is available to perform bootstrapping operations, the previously bootstrapped services within ViBE 416 may be migrated to target region 414. Utilizing these techniques, CIOS 402 can greatly improve the speed at which a region is built by drastically reducing the need for any manual input and/or configuration to be provided. In some embodiments, any suitable combination of the components depicted as part of CIOS 402 may individually be examples of the cloud services of FIGS. 23-26 (e.g., 2356 of FIG. 23, 2456 of FIG. 24, etc.) and may be configured to operate in any suitable infrastructure pattern such as the examples described below in connection with FIGS. 23-26.

FIG. 5 is a block diagram for illustrating an environment and method 500 for building a virtual bootstrap environment (ViBE) 502 (an example of ViBE 416 of FIG. 4), according to at least one embodiment. ViBE 502 represents a virtual cloud network that is provisioned in the overlay of an existing region (e.g., host region 504, an example of the host region 403 of FIG. 4 and in an embodiment is a Host Region Service Enclave). ViBE 502 represents an environment in which services can be staged for a target region (e.g., a region under build such as target region 414 of FIG. 4) before the target region becomes available.

In order to bootstrap a new region (e.g., target region 414 of FIG. 4), a core set of services may be bootstrapped. While those core set of services exist in the host region 504, they do not yet exist in the ViBE (nor the target region). These essential core services provide the functionality needed to provision devices, establish a chain of trust to the new region, and deploy remaining services into a region. The ViBE 502 may be a tenancy that is deployed in a host region 504 and used as a virtual region.

When the target region is available to provide bootstrapping operations, the VIBE 502 can be connected to the target region so that services in the ViBE can interact with the services and/or infrastructure components of the target region. This will enable deployment of production level services, instead of self-contained seed services as in previous systems, and may be connected over the internet to the target region. Conventionally, a seed service was deployed as part of a container collection and used to bootstrap dependencies necessary to build out the region. Using infrastructure/tooling of an existing region, resources may be bootstrapped (e.g., provisioned and deployed) into the VIBE 502 and connected to the service enclave of a region (e.g., host region 504) in order to provision (reserve and/or configure) hardware and deploy services until the target region is self-sufficient and can be communicated with directly. Utilizing the ViBE 502 allows for meeting the dependencies and providing the services needed to be able to provision/prepare infrastructure and deploy software while making use of the host region's resources in order to break circular dependencies of core services.

Region Orchestrator 506 (an example of Region Orchestrator 406 of FIG. 4) may be configured to perform operations to build (e.g., configure) ViBE 502. Region Orchestrator 506 can obtain applicable SPAMs corresponding to various resources to be bootstrapped to the new region (in this case, a ViBE region, ViBE 502). By way of example, Region Orchestrator 506 may obtain a SPAM for building any suitable portion of DNS 512, Worker 510, and/or Puffin Regional 508. In some embodiments, Region Orchestrator 506 may obtain a SPAM identifying aspects of bootstrapping any or all resources of the VIBE 502.

The method 500 may begin at step 1, where Region Orchestrator 506 may instruct CIOS Central 514 (e.g., an example of CIOS Central 408 and CIOS Central 514 of FIGS. 4 and 5, respectively) to build a service of the VIBE 502 or building the ViBE 502 in whole or in part. For example, Region Orchestrator 506 may transmit a request (e.g., including the flock config identified within a SPAM corresponding to building Puffin Regional 508 and a flock config corresponding to building worker 510 identified within the same or a different SPAM) to request bootstrapping of the Puffin Regional 508 and worker 510 that, at this time do not yet exist in the ViBE 502. In some embodiments, CIOS Central 514 may have access to all SPAMs. Therefore, in some examples, Region Orchestrator 506 may transmit one or more identifiers for one or more SPAMs and CIOS Central 514 may independently obtain the corresponding flock config(s) (e.g., flock configs identified by each manifest and/or service plan) from storage (e.g., from database (DB) 608 or SPAM store 612 of FIG. 6).

At step 2, CIOS Central 514 may provide the flock config(s) via a corresponding request to CIOS Regional 516. CIOS Regional 516 may parse the flock config(s) to identify and execute specific infrastructure provisioning and deployment operations at step 3.

In some embodiments, the CIOS Regional 516 may utilize additional corresponding services for provisioning and deployment. For example, at step 4, CIOS Regional 516 CIOS Regional may instruct deployment orchestrator 518 (e.g., an example of a core service, or other write, build, and deploy applications software, of the host region 504) to execute instructions that in turn cause Puffin Regional 508 and Worker 510, to be bootstrapped within ViBE 502.

At step 5, skills data may be transmitted to the Puffin Service 508 (from the CIOS Regional 516, Deployment Orchestrator 518 via the Worker 510 or otherwise) indicating that Puffin Regional and/or Worker 510 are available. Puffin Service 508 may persist this data. In some embodiments, the Puffin Regional 508 receives state transition data (e.g., from CIOS Regional 516) that indicates a particular skill has a particular status. By way of example, the skill provided to Puffin Regional 508 at step 5 may indicate the Puffin Regional 508 and Worker 510 are available for processing.

At step 6, Puffin Service 508 may identify that the Puffin Service 508 and/or Worker 510 are available based on receiving or obtaining data (an identifier corresponding to a skill) from Puffin Regional 508.

At step 7, as a result of receiving/obtaining the data at step 6 from Puffin Regional 508, Region Orchestrator 506 may instruct CIOS Central 514 to bootstrap a DNS service (e.g., DNS 512) to the ViBE 502.

At step 8, the CIOS Central 514 may instruct the CIOS Regional 516 to deploy DNS 512 to the ViBE 502. In some embodiments, the DNS SPAM for the DNS 512 may be provided by the CIOS Central 514 or one or more corresponding flock configs for bootstrapping the DNS 512 may be identified by CIOS Central 514.

At step 9, Worker 510, now that it is deployed in the VIBE 502, may be assigned by CIOS Regional 516 to the task of deploying DNS 512. Worker may execute a declarative infrastructure provisioner in the manner described above in connection with FIG. 6 to identify a set of operations that are needed to deploy DNS 512. These operations may be identified based at least in part on from comparing the flock config (the desired state), a corresponding portion of a SPAM, to a current state of the (currently non-existing) resources associated with DNS 512.

At step 10, the Deployment Orchestrator 518 may instruct Worker 510 to deploy DNS 512 in accordance with the operations identified at step 9. As depicted, Worker 510 proceeds with executing operations to deploy DNS 512 to ViBE 502 at step 11. At step 12, Worker 510 may notify Puffin Regional 508 (e.g., via a skills state transition) that DNS 512 is available in ViBE 502. Region Orchestrator 506 may subsequently identify that the resources associated with the flock configs corresponding to Puffin Regional 508, Worker 510, and DNS 512 are available any may proceed to bootstrapping any suitable number of additional resources to the VIBE 502.

After steps 1-12 are concluded, the process for building the VIBE 502 may be considered complete and the ViBE 502 may be considered built and ready for additional bootstrapping (e.g., the bootstrapping of various cloud services such as cloud services 2356 of FIG. 23). At any suitable time during steps 1-12, Puffin Regional 508 may receive and/or obtain alarm data from one or more alarm services (e.g., the alarm service(s) 422 of FIG. 4). In some embodiments, the alarm data may be processed by Puffin Regional 508. At any suitable time, Puffin Regional 508 may communicate the alarm data or data derived from the alarm data to Puffin Central 418 of FIG. 4. In some embodiments, Puffin Regional 508 (and/or Puffin Central 418) may communicate skill health information to Region Orchestrator 506 indicating corresponding health states associated with one or more skills. In some embodiments, Puffin Regional 508, Puffin Central 418, and/or Region Orchestrator 506 may be configured to execute operations that may pause (partially or fully) any suitable portion of the operations discussed above in connection with the method 500. In some embodiments, this may cause a regions state associated with the region within which method 500 is executed, to be updated to a state that indicates the build of the region is paused. In some embodiments, Puffin Regional 508, Puffin Central 418, and/or Region Orchestrator 506 may be configured to resume the operations of method 500 (and update the region state accordingly) based at least in part on user input, on subsequent alarm data indicating an update to a health state of one or more skills, on a skill health override value, or the like.

FIG. 6 is a block diagram for illustrating an environment and method 600 for bootstrapping services to a target region utilizing the ViBE, according to at least one embodiment.

The method 600 may begin at step 1, where user 602 (e.g., a service team member) may interact with any suitable number of user interfaces managed by Puffin Central 640 (e.g., Puffin Central 418 of FIG. 4). Puffin Central 640 may be configured to read service and/or skill metadata from predefined files or the user 602 may enter service metadata and/or skill metadata at one or more of the provided user interfaces. In some embodiments, Puffin Central 640 may store all service and skill metadata and serve as a centralized authority for the same. At any suitable time, any suitable user may view the service and/or skill metadata such as prior to and/or during performance of the region build.

At step 2, user 603 (the same or different user as user 602) may utilize any suitable user interface provided by CIOS Central 604 (an example of CIOS Central 408 and CIOS Central 514 of FIGS. 4 and 5, respectively) to modify region data. By way of example, user 603 may create a new region to which a number of services are to be bootstrapped.

At step 3, CIOS Central 604 may execute operations to send the change to RRDD 606 (e.g., an example of RRDD 404 of FIG. 4). At step 4, RRDD 606 may store the received region data in database 608, a data store configured to store region data including any suitable identifier, attribute, state, etc. of a region, AD, realm, ET, or the like. In some embodiments, updater 607 may be utilized to store region data in database 608 or any suitable data store from which such updates may be accessible (e.g., to service teams). In some embodiments, updater 607 may be configured to notify (e.g., via any suitable electronic notification) of updates made to database 608.

At step 5, Region Orchestrator 610 (an example of the Region Orchestrator 406 and/or 506 of FIGS. 4 and 5, respectively), operating in a given service cell (e.g., one of service cell(s) 409 of FIG. 4), may detect the change in region data. In some embodiments, Region Orchestrator 610 may be configured to poll RRDD 606 for changes in region data. In some embodiments, RRDD 606 may be configured to publish or otherwise notify Region Orchestrator 610 of region data changes.

At step 6, user 609 (the same or a different user as users 602 and/or 603) may utilize any suitable user interface to select a SPAM set (also referred to as a “template” herein) to identify a set of one or more SPAMs. The SPAMs corresponding to the selected SPAM set may be obtained from DB 612. In some embodiments, Orchestrator Control Plane 640 may identify any suitable number of SPAMs of the SPAM set corresponding to the infrastructure to be provisioned and artifacts to be deployed as part of a region build according to the SPAMs of the SPAM set. In some embodiments, each SPAM may identify versions corresponding to one or more flock configs and/or one or more artifacts that may be needed (or are needed) to build a single service. In embodiments in which one or more SPAMs are utilized, the SPAM(s) (or any suitable portion of the SPAM(s)) may be stored within SPAM store 612 and utilized to identify the particular flock config and/or artifact versions to be utilized for building the region. In some embodiments, the flock configs and/or artifact versions of a SPAM set may be included in the corresponding SPAM(s) and stored within SPAM store 612.

In some embodiments, any suitable manifest items may be derived from any suitable number of SPAMs and the Orchestrator Control Plane 640 may be configured to verify compliance of a flock's behavior (e.g., the build/orchestration operations identified within a flock config) complies with the process defined by a corresponding SPAM. The Orchestrator Control Plane 640 may be configured to ingest SPAMs which provide the information that may be required (or in some cases, which is required) to build an up-front plan of work and to introduce better guardrails than those available in previous implementations. By way of example, the Orchestrator Control Plane 640 generate build plan 638 based at least in part on the SPAM(s) of the SPAM set and may enforce the invariant that all SPAMs within the set are mutually compatible and composable together to form a viable build plan of releases required to build the service(s) of a region to be built. In some embodiments, a SPAM set may be used within a given regional context to improve service build progress tracking. operations composed from a SPAM set may be validated before they are applied and rejected if they are invalid. This provides an improvement over previous implementations which utilize version set item operations which were unconditionally applied. The utilization of SPAMs may enable the Orchestrator Control Plane 640 to build a deterministic plan of work prior to building a region, to block updates that would jeopardize or break an ongoing or future build, to improve the tracking of process of a service build, to detect deviations of flock behavior from the SPAM's specification, and to alert operators of deviations and status. Orchestrator Control Plane 640 may provide Build Plan 638 to Region Orchestrator 610 or Region Orchestrator 610 may otherwise obtain Build Plan 638 (e.g., from a storage location accessible to the Region Orchestrator 610).

At step 7, Region Orchestrator 610 may request CIOS Central 604 to recompile each of the flock configs associated with the SPAM set) with the current region data. In some embodiments, the request may indicate a version for each flock config and/or artifact.

At step 8, CIOS Central 604 may obtain current region data from the DB 608 (e.g., directly, or via Real-time Regional Data Distributor 606) and retrieve any suitable flock config and artifact in accordance with the versions requested by Region Orchestrator 610.

At step 9, CIOS Central 604 may recompile the obtained flock configs with the region data obtained at step 8 to inject those flock configs of the SPAM set with current region data. CIOS Central 604 may return the recompiled flock configs to Region Orchestrator 610 or the recompiled flock configs may be stored within SPAM store 612. In some embodiments, CIOS Central 604 may simply indicate compilation is done, and Region Orchestrator 610 may access the recompiled flock configs via RRDD 606.

In some embodiments, Build Plan 638 may be a region-level plan that includes every release that may be needed (or that is needed) for every service associated with a SPAM of the SPAM set to be bootstrapped within the region/data center. In some embodiments, the region build plan may be represented by a graph (e.g., a directed acyclic graph) that includes “tracks” and “steps.” A “track” refers to a single thread of execution of the Build Plan 638 that may include any suitable number of steps. In some embodiments, multiple tracks may execute concurrently. A “track step” or “step,” for brevity, refers to a node of the Build Plan 638 and may correspond to a single track. In some embodiments, a step may include an assertion about state (e.g., an installation of or health of a skill), an execution of an infrastructure or application release, a control flow operation for handling concurrency, or the like. In some embodiments, a track step is an atomic unit of execution of the Build Plan 638. Any suitable portion of Build Plan 638 may be presented via one or more user interfaces (e.g., one or more interfaces provided by any suitable component of CIOS 402 of FIG. 4, including Orchestrator Control Plane, CIOS Central 604, or the like).

One or more “steps” of the Build Plan 638 may correspond to building the VIBE 616 (or individual services within the ViBE such as Puffin Regional 642 and/or worker 620), another node may correspond to bootstrapping DNS 622. The steps 11-16 may correspond to deploying (via deployment orchestrator 617, an example of the deployment orchestrator 518 of FIG. 5) the resources and/or artifacts identified from a SPAM corresponding to building the VIBE 616 (e.g., an example of ViBE 416 and 502 of FIGS. 4, and 5, respectively). That is, steps 11-16 of FIG. 6 generally correspond to steps 1-6 of FIG. 5. Once notified a skill has been installed (e.g., indicating that Worker 620 and/or Puffin Regional 642, corresponding to Worker 510 and Puffin Regional 509 of FIG. 5, respectively, are deployed/available) the Region Orchestrator 610 may recommence traversal of the Build Plan 638 to identify which operations/releases to be executed next.

Region Orchestrator 610 may continue traversing the Build Plan 638 to identify that one or more releases corresponding to deploying DNS 622 are to be executed. Steps 17-22 may be executed to deploy DNS 622 (an example of the DNS 512 of FIG. 5). These operations may generally correspond to steps 7-12 of FIG. 5.

At step 22, a skill state may be updated to indicate that DNS 622 is available. In some embodiments, CIOS Regional 614 and/or Deployment Orchestrator 617 may initially communicate the installation of the skill (e.g., to Puffin Regional 642). Upon detecting the updated skill state (e.g., via data provided by Puffin Regional 642), Region Orchestrator 610 may recommence traversal of the Build Plan 638. The Region Orchestrator 610 may identify that any suitable portion of an instance of CIOS Regional (e.g., an example of CIOS Regional 614) is to be deployed to the VIBE 616. In some embodiments, steps 17-22 may be substantially repeated with respect to deploying CIOS Regional (ViBE) 626 (an instance of CIOS Regional 614, CIOS Regional 410 of FIG. 4) and Worker 628 to the ViBE 616. One or more skill states may be updated to indicate that that CIOS Regional (ViBE) 626 and worker 628 are available.

Upon detecting the CIOS Regional (ViBE) 626 is available, Region Orchestrator 610 may recommence traversal of the Build Plan 638. On this traversal, the Region Orchestrator 610 may identify that a deployment orchestrator (e.g., Deployment Orchestrator 630, an example of the Deployment Orchestrator 617) is to be deployed to the VIBE 616. In some embodiments, steps 17-22 may be substantially repeated with respect to deploying Deployment Orchestrator 630. A skill state indicating the deployment of the Deployment Orchestrator 630 is complete may be transmitted to the Puffin Regional 642, indicating that Deployment Orchestrator 630 is available.

After Deployment Orchestrator 630 is deployed, ViBE 616 may be considered available for processing subsequent requests. Upon detecting Deployment Orchestrator 630 is available, Region Orchestrator 610 may instruct subsequent bootstrapping requests to be routed to ViBE components rather than utilizing host region components (components of host region 632). Thus, Region Orchestrator 610 can continue traversing the Build Plan 638, at each node instructing release execution to the VIBE 616 via CIOS Central 604. CIOS Central 604 may transmit release requests CIOS Regional (ViBE) 626 to effectuate release execution as instructed by Region Orchestrator 610.

At any suitable point during this process, Target Region 634 may become available. Indication that the Target Region is available may be identifiable from region data for the Target Region 634 being provided by the user 603 (e.g., as an update to the region data). The availability of Target Region 634 may depend on establishing a network connection between the Target Region 634 and external networks (e.g., the Internet). The network connection may be supported over a public network (e.g., the Internet), but use software security tools (e.g., IPSec) to provide one or more encrypted tunnels (e.g., IPSec tunnels such as tunnel 636) from the ViBE 616 to Target Region 634. As used herein, “IPSec” refers to a protocol suite for authenticating and encrypting network traffic over a network that uses Internet Protocol (IP) and can include one or more available implementations of the protocol suite (e.g., Openswan, Libreswan, strongSwan, etc.). The network may connect the VIBE 616 to the service enclave of the Target Region 634.

Prior to establishing the IPSec tunnels, the initial network connection to the Target Region 634 may be on a connection (e.g., an out-of-band VPN tunnel) sufficient to allow bootstrapping of networking services until an IPSec gateway may be deployed on an asset (e.g., bare-metal asset) in the Target Region 634. To bootstrap the Target Region's network resources, Deployment Orchestrator 630 can deploy the IPSec gateway at the asset within Target Region 634. The Deployment Orchestrator 630 may then deploy VPN hosts at the Target Region 634 configured to terminate IPSec tunnels from the VIBE 616. Once services (e.g., Deployment Orchestrator 630, Service A, etc.) in the VIBE 616 can establish an IPSec connection with the VPN hosts in the Target Region 634, bootstrapping operations from the VIBE 616 to the Target Region 634 may begin.

In some embodiments, the bootstrapping operations may begin with services in the ViBE 616 provisioning resources in the Target Region 634 to support hosting instances of core services as they are deployed from the VIBE 616. For example, a host provisioning service may provision hypervisors on infrastructure (e.g., bare-metal hosts) in the Target Region 634 to allocate computing resources for VMs. When the host provisioning service completes allocation of physical resources in the Target Region 634, the host provisioning service may transit data (e.g., a skills update) that indicates that the physical resources in the Target Region 634 have been allocated. The data may be transmitted to Puffin Regional 642 via CIOS Regional (ViBE) 626 (e.g., by Worker 628).

With the hardware allocation of the Target Region 634 established and corresponding skills are updated with Puffin Regional 642, CIOS Regional (ViBE) 626 can orchestrate the deployment of instances of core services from the VIBE 616 to the Target Region 634. This deployment may be similar to the processes described above for building the ViBE 616, but using components of the ViBE (e.g., CIOS Regional (ViBE) 626, Worker 628, Deployment Orchestrator 630) instead of components of the Host Region 632 service enclave (e.g., CIOS Regional 614 and Deployment Orchestrator 617). The deployment operations may generally correspond to steps 17-22 described above.

As a service is deployed from the VIBE 616 to the Target Region 634, the DNS record associated with that service may correspond to the instance of the service in the VIBE 616. The DNS record associated with the service may be updated at any suitable time to complete deployment of the service to the Target Region 634. Said another way, the instance of the service in the ViBE 616 may continue to receive traffic (e.g., requests) until the DNS record is updated. A service may deploy partially into the Target Region 634 and publish information indicating the availability of a skill (e.g., to Puffin Regional 642) indicating that the service is at least partially deployed. For example, a service running in the ViBE 616 may be deployed into the Target Region 634 with a corresponding compute instance, load balancer, and associated applications and other software, but may wait for database data to migrate to the Target Region 634 before being completely deployed. The DNS record (e.g., managed by DNS 622) may still be associated with the service in the VIBE 616. Once data migration for the service is complete, the DNS record may be updated to point to the operational service deployed in the Target Region 634. The deployed service in the Target Region 634 may then receive traffic (e.g., requests) for the service, while the instance of the service in the VIBE 616 may no longer receive traffic for the service.

At any suitable time during method 600, Puffin Regional 642 may receive and/or obtain alarm data from one or more alarm services (e.g., the alarm service(s) 644, an example of the alarm service(s) 422 of FIG. 4). In some embodiments, the alarm data may be processed by Puffin Regional 642 (or Puffin Regional 642 may communicate the alarm data or data derived from the alarm data to Puffin Central 640). In some embodiments, Puffin Regional 642 and/or Puffin Central 640 may communicate skill health information to Region Orchestrator 610 indicating corresponding health states associated with one or more skills. In some embodiments, Puffin Regional 642, Puffin Central 640, and/or Region Orchestrator 610 may be configured to execute operations that pause or otherwise halt any suitable portion of the operations discussed above in connection with the method 600. In some embodiments, Puffin Regional 642, Puffin Central 640, and/or Region Orchestrator 610 may be configured to resume and/or execute any suitable portion of the operations of method 600 (e.g., based at least in part on user input, subsequent alarm data indicating an update to a health state associated with one or more skills, based at least in part on a skill health override value, or the like).

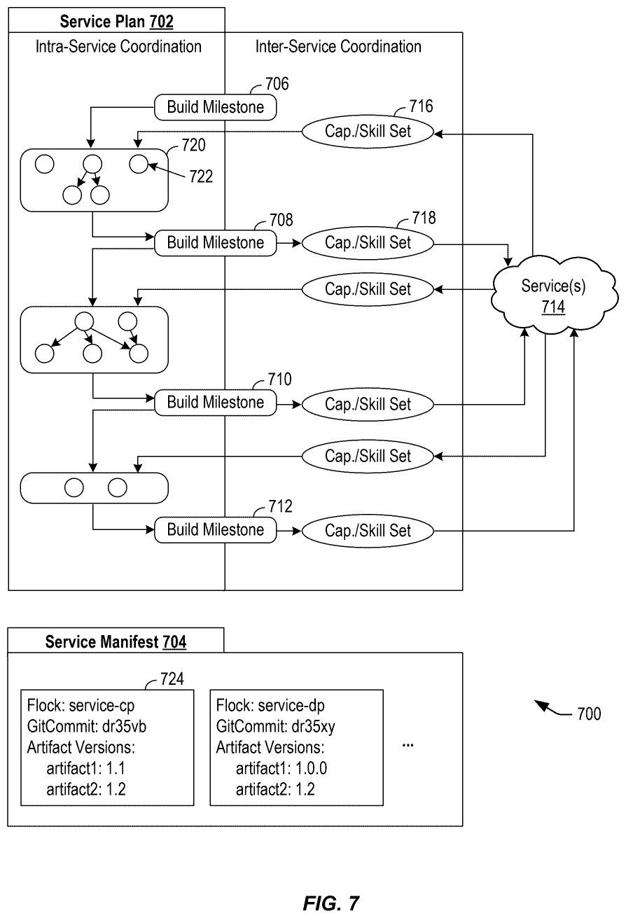

FIG. 7 is a block diagram 700 depicting relationships between portions of a service plan (e.g., service plan 702, an example service plan corresponding to service plan data structure) and manifest (e.g., manifest 704, an example of a service manifest), in accordance with at least one embodiment. The service plan 702 may include any suitable combination of build milestones, execution units, and/or the flock configuration files. In some embodiments, the service plan 702 indicates a service build implementation at different levels of granularity. The highest level of granularity indicates the build milestones (e.g., build milestones 706-712, defined with a corresponding build milestone entity of the service plan 702). The service plan 702 may be used specify a service build to a sequence of build milestones that the service progresses through during its build. Each milestone may represent an interaction that occurs between a given service and other services (e.g., publishing a skill and/or a capability that unblocks other services from building, and/or consuming a new skill and/or capability published by another service). These build milestones may be used to understand a high-level picture of how that service builds and the inter-service coordination required for that service without having to understand all the services' flocks and their service-internal coordination.

Build milestones 706-712 may individually be associated with a set of external skills and/or capabilities on which transitioning to the build milestone depends. These skills and/or capabilities may include the expected published skills/capabilities that are relevant for external services (e.g., service(s) 714, including the other services of a region build). As a non-limiting example, build milestone 1706 may depend on capabilities/skill set 1716 (including one or more capabilities and/or skills) as defined in a corresponding execution unit transition specifying a transition to build milestone 706. Build milestones 706-712 may be associated with the publication of capabilities and/or skills that are required to start/continue the installation of another service. By way of example build milestone 708 may be associated with capabilities/skills set 718, including one or more capabilities and/or skills that are expected to be published prior to transitioning to build milestone 708. In some embodiments, capabilities/skills set 718 may be published upon transitioning to build milestone 708. In some embodiments, build milestones may be used to generate a high-level sequencing diagram that may be used to identify progress in a region build.

Each build milestone may be associated with a corresponding execution unit. By way of example, build milestone 706 may be associated with execution unit 720. Each execution unit, including execution unit 720, may include any suitable number of releases such as release 722, and an order by which these releases are to be executed. In some embodiments, release 722 may correspond to an ET checkpoint associated with executing the release 722 at a single execution target. In some embodiments, each release may be expressed within the execution unit as an execution target checkpoint transition. The corresponding execution target checkpoint transition may indicate external and/or internal capabilities dependencies for the transition/release and may provide a mapping to a corresponding flock config identified in the service manifest 704. By way of example, release 722 may be ultimately mapped to a particular flock config using the service manifest item 724. The service manifest item 724 may be identified by an identifier provided in the execution target checkpoint referenced by the execution unit 720 and corresponding to the release 722.

Using the entities of the service plan, one or more acyclic graphs may be generated. As a non-limited example, a directed acyclic graph defining the service build may be generated. This DAG may be referred to as a “service DAG” and may include any suitable number of nodes representing a corresponding release and an order by which those releases are to be executed to build that service. The nodes themselves, or edges between nodes, may be associated with external and/or internal capability dependencies. In some embodiments, a graph, list, sequence diagram, or any suitable data structure may be generated for a service and/or for any suitable number of services of the region build using the build milestones corresponding to the service(s). This data structure may be referred to as a “milestone plan.” As yet another example, the Build Dependency Graph 338 and 638 of FIGS. 3 and 6 may be generated using the service plan (e.g., as part of a SPAM set including service plans and manifests corresponding to one or more services). As described above in FIGS. 3 and 6, the Build Dependency Graph 338 and 638 may be used (e.g., by the Orchestrator 310 of FIG. 3, by Region Orchestrator 610 of FIG. 6) to drive region build operations (e.g., to execute a deterministic order of infrastructure and application releases for the region/data center).

In some embodiments, the service manifest 704 may be utilized to specify the flock versions and artifact versions that will be used to create releases for the execution targets specified in the service plan 702. The service manifest 704 may be used to validate the service plan 702 based at least in part on identifying that each release identified in the service plan 702 is included within the service manifest 704. In some embodiments, each service manifest item (e.g., service manifest item 724) may be mapped to a version set item such that service manifests may be used to validate a version set used by CIOS 102 and/or CIOS 402 to perform a region build. As a non-limiting example, a SPAM set may be constructed all SPAMs corresponding to services that are to be bootstrapped within a region/data center. The manifests of the SPAM set may be used to validate a version set, should one be used, to ensure that all flock config files and artifacts referenced in the SPAM set are included in the version set to be used to build the region.

Orchestration tasks related to performing a data center (region) build, utilizing the service plans and/or data structures/models discussed herein, tracking capabilities and/or skills during a build, maintaining compatibility between capabilities and skills, and the like, are discussed in more detail U.S. Non-provisional application Ser. No. 18/661,401, filed May 10, 2024, entitled “Managing Data Center Orchestration using Service Plans and Manifests,” and U.S. Non-provisional application Ser. No. 18/667,875, filed May 17, 2024, entitled “Techniques for Region Build Orchestration,” the disclosures of which are incorporated by reference in their entirety for all purposes.

### Cross-Realm Identity Management

The present disclosure relates to techniques that enable cross-realm interactions between entities of different realms of a cloud computing system. In a computing platform operating under an IaaS cloud service model, an entity of one realm may request access to protected resources. Within an identity and access management (IAM) service provided as part of a cloud platform, such entities are sometimes referred to as “principals.” A principal is an entity that can be permitted, based on the identity of the principal, to interact with (e.g., access) resources in a cloud computing environment (e.g., to perform a read, a write, or a service-related operation). A “realm” refers to an identity boundary in which principals may be authenticated and authorized, but beyond which principals are unknown and cannot be authenticated or authorized. A realm may be associated with a set of resources for which authentication and authorization is managed by a single identity management system. Certain use cases may require support for cross-realm communication.

For example, a singleton instance of CIOS Central (e.g., CIOS Central 108 and/or CIOS Central 408) may be hosted in one realm (e.g., “OC1,” referred to as a “management realm”) within a corporate governance enclave that includes all connected realms (e.g., a set of all realms to which service resources are to be provisioned and deployed). A “governance enclave” is intended to refer to a collection of realms (e.g., one or more target realms) where certain management operations for the group are performed centrally through a single realm (e.g., a host realm). As another example, CIOS Central 408, Orchestrator Control Pane 407, and Region Orchestrator 406 (or multiple region orchestrators executing within service cell(s) 409) may operate from a governance enclave of one realm (e.g., “OC1,” a management realm), but control various resources in one or more additional realms (e.g., target realms), and therefore may need to perform operations in those additional realms. By way of example, CIOS Central may be configured to handle provisioning, deployment, and management of flocks (e.g., service resources) for the target realms of the governance enclave. During a region build (e.g., a building of a data center with a set of core services provided by the cloud service provider), an Orchestrator (e.g., Orchestrator 106, Region Orchestrator 406) may make an Application Programming Interface (API) call to CIOS Central 108 in the context of a resource (e.g., a “flock”) to initiate a release by the CIOS Regional in the target realm. A “flock” is intended to refer to a resource representing a flock configuration file and/or a resource representing a set of resources to be provisioned and/or deployed as part of performing a release according to the desired state specified in a flock configuration file.

Conventionally, a cross-realm mutual Transport Layer Security (mTLS) connection would be established between CIOS and the resources in different realms. By way of example, an mTLS connection may be established between CIOS Central 108 and CIOS Regional 110 of FIG. 1 which would require CIOS Central 108 and CIOS Regional 110 to authenticate one another using the TLS protocol. This enabled cross-realm identity management, but these implementations lacked support for policy-based authorization management. These mTLS connections form information and control bridges between realms, linking participating services. While architectural and design restrictions may be used to restrict these connections, the safety framework that may be provided by policy statements was missing. Each service team (implementing the cross-realm mTLS use case) was required to implement separate cross-realm operation checks within code to individually determine what operations to allow or restrict. This approach is time consuming and wasteful.

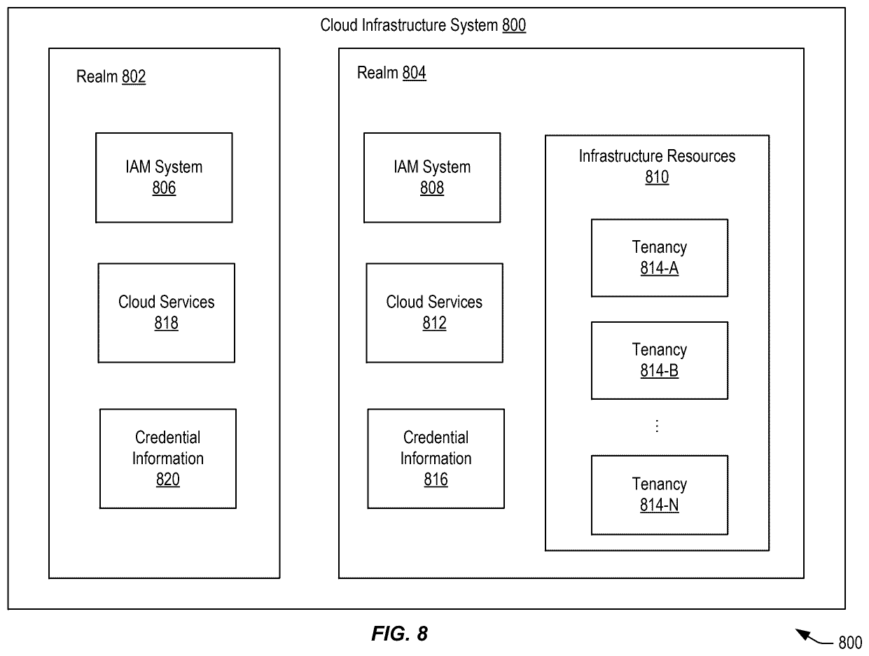

FIG. 8 is a simplified block diagram of an example cloud computing environment (e.g., cloud infrastructure system 800), in accordance with at least one embodiment. The cloud infrastructure system 800 may include any suitable number of realms. As depicted in FIG. 8, cloud infrastructure system 800 includes realm 802 and realm 804, both operated by a cloud service provider. Identity and access control within realm 802 may be managed by Identity Access Management (IAM) System 806 and identity and access control within realm 804 may be managed by IAM System 808. Realm 804 may include infrastructure resources 810 (e.g., hardware and/or software components configurable to provide cloud services 812 to clients of the cloud infrastructure system 800). As illustrated, the infrastructure resources 810 can be partitioned into different tenancies 814A-814-N (collectively referred to as “tenancies 814”). Each of the tenancies 814 may be a logical container that can contain resources for which access is protected by IAM System 808. For example, a resource could be a database, a load balancer, or a testing platform for testing software code, etc.

The resources within a tenancy can include or be built from infrastructure resources managed by the cloud services 812. For example, each of the cloud services 812 may utilize a respective tenancy within which they may provision resources from infrastructure resources 810 and deploy artifacts (e.g., software, scripts, libraries, etc.) to those provisioned resources to provide the functionality of cloud services 812.

As illustrated in FIG. 8, the cloud infrastructure system 800 may include an Identity Access Management (IAM) system 808. The IAM system 808 may be configured to manage access to the infrastructure resources 810 by user principals and/or resource principals. For example, the functionality provided by the IAM system 808 may include a cloud-based identity and access management service (an example of one of cloud services 812). IAM system 808 may be configured to maintain information about users associated with the tenancies 814, such as usernames, passwords or other credential information, user information, and the like (collectively, credential information 816). IAM system 808 can be implemented in hardware and/or software and may include, for example, one or more access management servers configured to process resource access requests for access to resources within the tenancies 814.

As indicated above, principals can include user principals and resource principals. Thus, the IAM system 808 may be configured to store, as part of the credential information 816, credentials for both user principals and resource principals. Such credentials can be used to determine whether to grant or deny a request from a principal. In particular, IAM system 808 may provide authentication and/or authorization services, whereby the identity of a principal is verified (authenticated) based upon the principal being able to present a valid credential, and whereby an authenticated principal is granted permission (authorized) to access a resource based upon an applicable access policy that is associated with the principal. For example, a resource principal requesting access to another resource may submit an access request that is signed using a digital certificate or private key associated with the resource principal. In some embodiments, a Resource Principal Token (RPT) may include a number of identity claims signed by the entity that generated it. An RPT may be provided to an IAM system which may authenticate the resource and, if authenticated, provide a corresponding Resource Principal Session Token (RPST). An RPST may be a temporary session token and a secure credential that enables the resource to authenticate itself (assert its resource principal identity) to other cloud resources. In a certain implementation, the RPST may be formatted as a JSON Web Token (JWT) token that includes claims that identify the resource's host tenancy and compartment information.

In certain embodiments, the IAM system 808 may operate as a central access manager that manages credentials for infrastructure resources 810 and resources built using infrastructure resources 810. In other embodiments, access management responsibilities may be distributed between the IAM system 808 and one or more additional components. By way of example, one or more services of cloud services 812 may be configured to manage authentication and/or authorization for a subset of access requests. For example, CIOS Regional 110, an example of cloud services 812 may be configured to manage authentication and authorization in a target realm (e.g., region 804) for calls received from CIOS Central 108 of a management realm (e.g., realm 802), an example of cloud services 818.

Authentication and authorization management within realm 802 may be similarly managed by IAM System 806 using credential information 820. Conventionally, cross-realm requests (e.g., requests between components of realms 802 and 804) were not possible as the identity of the component in one realm could not be authenticated in the other.

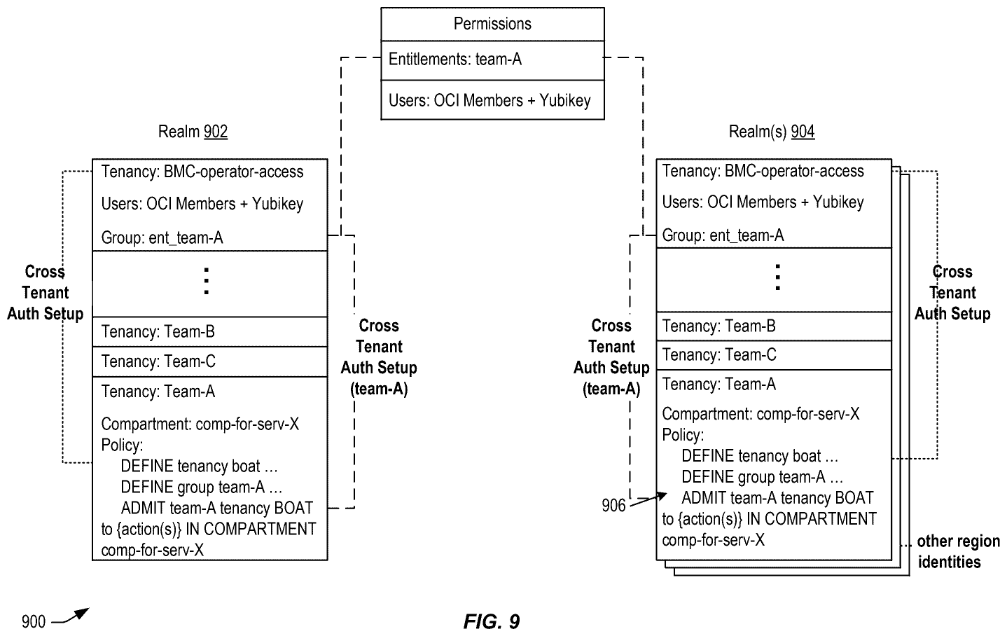

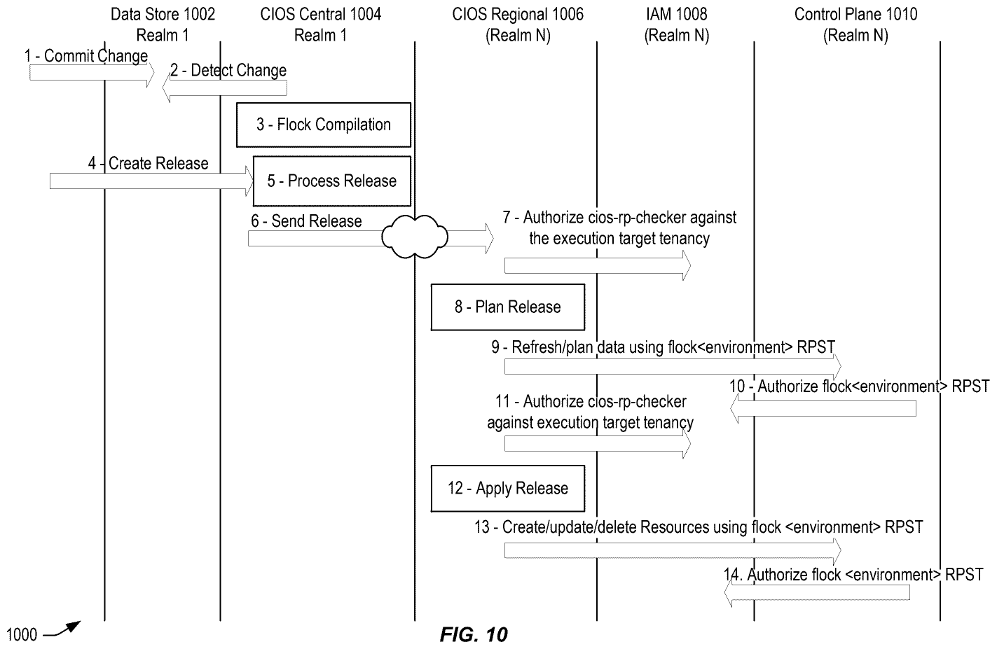

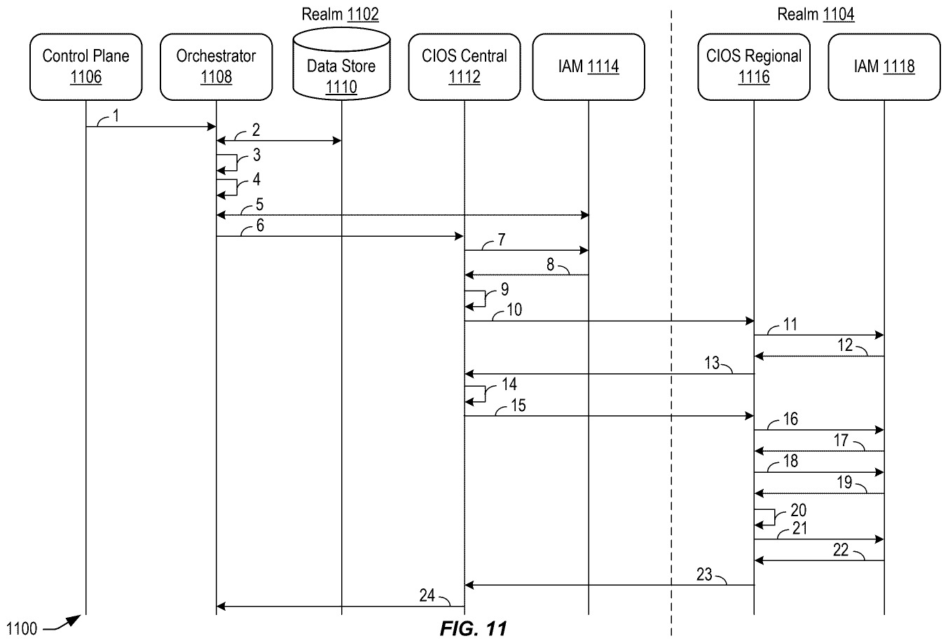

FIG. 9 is a block diagram illustrating an example environment 900 in which a user's identity is provided in two realms, in accordance with at least one embodiment. To enable service team users (e.g., Oracle Cloud Infrastructure operators associated with service) to be subject to policy-based authorization with each realm, each service team members identity may be projected from a governance enclave (e.g., realm 802 of FIG. 2) into each realm that the service is expected to execute. By way of example, the identity of service team members known in realm 902 may be projected or otherwise duplicated within any suitable number of additional realms (e.g., realm(s) 904). In some embodiments, any suitable realm-specific access policy may be written to enable service team members (members of “Team A”) to access resources within a corresponding tenancy (e.g., Team-A tenancy) according to the policy depicted at 906. This may enable service team users to generate policies related to their flock and/or resource checker as described in FIGS. 10 and 11.

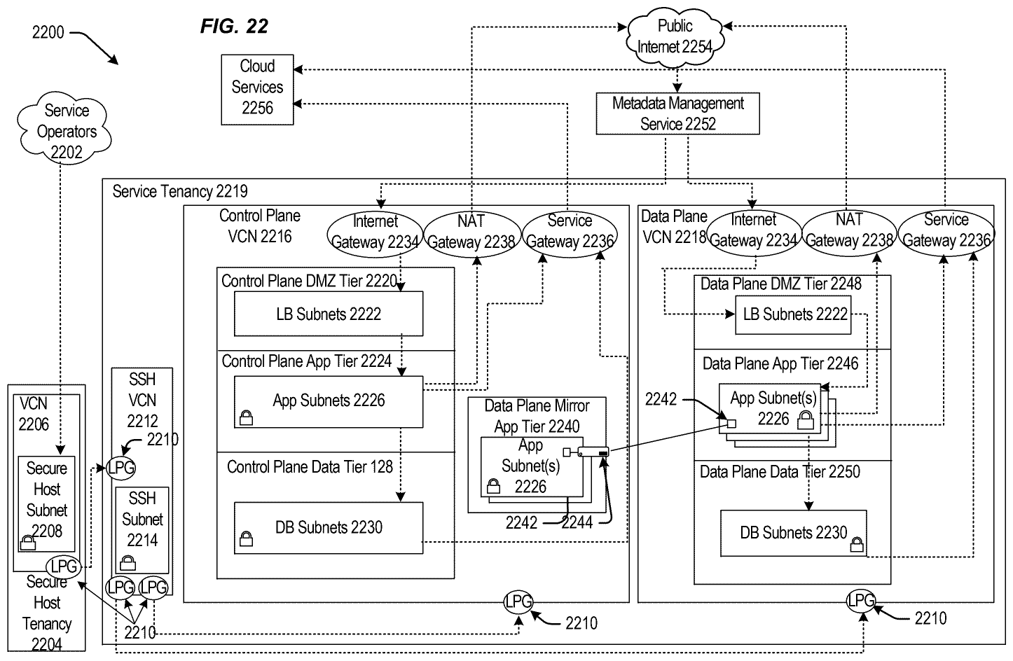

Early implementations of CIOS 102 of FIG. 1 faced a resource principal related problem with respect to flocks. As part of a region build, a flock could modify resources of a service tenancy (e.g., a tenancy associated with a cloud service such as one of cloud services 2256 of FIG. 22). In legacy implementations, flocks were made resource principals that existed in the governance enclave (e.g., realm 802 of FIG. 8, realm 902 of FIG. 9, etc.), but not within other realms (e.g., target realms such as realm(s) 804 of FIG. 8, realm 904 of FIG. 9, etc.). This meant that access policies could not be written against the flocks within target realms. To enable policy-based authorization for flocks in each realm, CIOS Regional 110 was modified to generate new resource principals (e.g., resource principal tokens) that represent the identity of a flock within a corresponding realm. Policies could then be written to restrict a flock's permissions to modify resources within the service tenancy. An example of one such policy includes:

allow any-user to manage all-resources in tenancy where all {
request.principal.type = ‘flock’, request.principal.id = ‘ocid1.flock...’ }

These previous implementations included a risk, mainly through human error, that the allow permissions on a tenancy could be more broadly scoped than the service team intended. For example, if the “where” clause of the policy above were omitted, all resources of the tenancy may be vulnerable to any authenticated user of the tenancy, even when the user should not have, or does not need, such broadly scoped permissions (e.g., when the user needs only to write policies for a subset of all resources). In addition, CIOS flocks may contain execution targets for non-production environments as well as production environments, and in early implementations a test resource (e.g., a resource of a test tenancy) could modify/impact a production tenancy resource (e.g., a resource of a production tenancy), and vice versa. It may be undesirable to allow a flock to be able to affect resources that it was not explicitly authorized to modify or affect production resources by accident with changes intended for non-production environments, and that an unstable environment should not be able to accidentally modify a production environment. To address these issues, an authorization check against the execution target's tenancy was added. FIGS. 10 and 11 provide examples that include the added authorization check.

FIG. 10 is a flow diagram illustrating an example method 1000 for authorizing modifications by an entity within a given execution tenancy, in accordance with at least one embodiment. The method 1000 may be performed using data store 1002 (e.g., DB 312 of FIG. 3), CIOS Central 1004 (e.g., CIOS Central 108 of FIG. 1), CIOS Regional 1006 (e.g., CIOS Regional 110 of FIG. 1), IAM 1008 (e.g., IAM 808 of FIG. 8), and Control Plane 1010. The method 1000 may include more or fewer steps than those depicted in FIG. 10. The operation discussed below may be performed in any suitable order.

Prior to the execution of method 1000, service teams may add new policies to tenancies in each realm (e.g., Realm N) for their flock(s). In some embodiments, one or more flock configuration file(s) associated with the service team may be modified to configure an environment on each execution target and to create a resource principal onboarding release for every execution target. The resource principal onboarding release, when executed, may create a resource principal for the flock and an rp-checker resource principal. An “rp-checker” resource principal refers to a resource principal that may be used to identify whether the resource corresponding to the rp-checker (e.g., CIOS Regional 1006) is authorized to generate resource principals of another resource type (e.g., a resource type indicated by a resource name such as ‘<projectName>/<flockName>’).

To enable this change, a resource classification may be added to IAM 1008 to allow policies to be written against specific resource types which may be referenced by name. In some embodiments, CIOS Regional 1006 in the target realm (e.g., Realm N) may be configured to manage resources of a particular resource type (e.g., “flock”) and may be used to inject appropriate variables within access policies in the format of:

allow resource flock<environment> ‘<projectName>/<flockName>’ to

| | |
|---|---|
| manage all-resources in tenancy | (1) |

admit resource cios-rp-checker checker of any-tenancy to
{CIOS_FLOCK_APPLY_CREATE} in tenancy where all {
target.resource.name

| | |
|---|---|
| = ‘<projectName>/<flockName>’ } | (2) |

The first policy above may be used to ensure that a flock is authorized to modify resources within the execution target tenancy (e.g., an execution target tenancy in Realm N). Environments may be added to CIOS with the intention of distinguishing between different stages in a service team's build lifecycle. Every execution target resource (e.g., an execution target resource of a flock, an execution target resource of a service plan, etc.) may be associated with one of a predefined list of stages (e.g., “alpha” corresponding to an unstable testing environment, “beta” corresponding to a stable testing environment, “gamma” corresponding to a pre-production environment, “delta” corresponding to a non-production environment used for load testing or feature testing, etc.). Each of these environments may be associated with a resource type and then used for authentication/authorization purposes when interacting with downstream control planes (e.g., control plane 1010). An example execution target within an unstable testing environment may be defined in the following format, where environment=“alpha” indicates an unstable testing environment:

```
resource “cios_execution_target” unstable {
  name = “unstable_region-X”
  tenancy_name = “cios-tenancy”
  region = “region-X”
  phase = “unstable”
  environment = “alpha”
}
```

In some embodiments, execution targets in the same phase may be in the same environments. An environment's execution targets/phases may be sequential such as Phase 1 (alpha), Phase 2 (Beta), Phase 3 (alpha). Utilizing environments may allow comparisons to be made (e.g., to compare what has been deployed in alpha vs. beta vs. production, etc.), enables different approval requirements based on environment, and enables environment specific automatic create release settings.

The second policy above (also referred to as “a resource checker policy”) may be used to ensure that CIOS Regional 1006 is authorized to perform create and apply operations for a given flock within an execution target tenancy. The second policy may authorize CIOS Regional 1006 to instantiate/generate a resource principal for a particular flock in the execution target tenancy (e.g., the execution target tenancy in Realm N) as part of a flock create operation. This may be used as an additional layer of protection then provided in previous implementations as CIOS Regional 1006, in some cases, cannot check flock permissions on a tenancy until plan/apply time. For example, in a region build, tenancy OCIDs/identity may not be accessible until plan/apply time. The first and second policies above may be added to the root compartment in the tenancy of each execution target to which one or more releases (e.g., specified by one or more flock configuration files) is to be applied for a service.

Method 1000 may begin at step 1, where a change to a flock (e.g., a flock configuration file specifying resources of the flock) may be committed (e.g., via a version control software and a user device, not depicted) and stored in data store 1002. In the example depicted, data store 1002 may exist in realm 1 (e.g., a management realm, “OC1,” realm 802 of FIG. 8, etc.). In some embodiments, the change may be added to a version set of flock configuration files to be used for a region build. CIOS Central 1004, in Realm 1, may be configured to detect changes to various flock configuration files.

At step 2, CIOS Central 1004 may detect the change to the flock configuration file. In some embodiments, detecting the change to a flock configuration file may include detecting a new version of a flock configuration file or a new flock configuration file.

At step 3, CIOS Central 1004 may perform a process during which it compiles all of the flock configuration files to be used for a region build (e.g., all of the flock configuration files of a golden version set). During flock compilation, CIOS Central 1004 may resolve which execution targets and environments each flock (e.g., the resources provisioned or deployed by the flock configuration file) may affect.

At step 4, a request to create a release may be transmitted to CIOS Central 1004. In some embodiments, a user (e.g., an OCI operator) may transmit the request via a user device (not depicted) using an interface managed by CIOS Central 1004. In some embodiments, a release request may be transmitted by an orchestrator (e.g., orchestrator 106 of FIG. 1). For example, orchestrator 106 may transmit various release requests as part of its traversal of Build Dependency Graph 338 of FIG. 3.

At step 5, CIOS Central 1004 may perform any suitable operations for processing the release request.

At step 6, CIOS Central 1004 may send a release request to CIOS Regional 1006 of Realm N (e.g., an example of Realm 804 of FIG. 8, a target realm, etc.). In some embodiments, the release may be transmitted via an mTLS connection previously established between CIOS

Central 1004 and CIOS Regional 1006. The release request may include the flock configuration file or an identifier for the flock configuration file that specifies the resource(s) to be provisioned and/or deployed, the environments (e.g., realm, region, execution target) to which the resource(s) are to be provisioned/deployed, and/or a phase during which the release is to be applied.

At step 7, CIOS Regional 1006 of Realm N may perform operations to determine whether CIOS Regional 1006 of Realm N is authorized to perform create operations corresponding to a given flock (e.g., whether CIOS Regional 1006 is authorized to create resource principal tokens for a given flock). CIOS Regional 1006 may generate a resource principal token (RPT) indicating a target resource name/type (e.g., “cios-rp-checker”) and the identifier for a flock. IAM 1008 may trust CIOS Regional 1006 to mint/generate resource principal tokens including a particular resource name/type (e.g., RPTs with a resource name/type of “cios-rp-checker”) such that IAM 1008 may forgo authenticating identity claims of the RPT. IAM 1008 may generate a corresponding resource principal session token (RPST) that may be digitally signed by IAM 1008 using a credential associated with IAM 1008. CIOS Regional 1006 may transmit the RPST to IAM 1008 to perform an authorization check with IAM data plane 1008 of Realm N. IAM 1008 may check that current policies allow for CIOS Regional 1006 to perform create operations corresponding to a particular flock. Create operations may include instantiating/generating a resource principal checker for the identified flock within the execution target tenancy. By way of example, the authorization check may be checking that the second policy provided above exists, allowing CIOS Regional 1006 to instantiate/generate a resource principal token for a particular flock in the execution target tenancy. If the policy exists, IAM 1008 may indicate that operation is authorized, and the method 1000 may proceed to step 8. Using the resource principal checker (e.g. an RPT of type “cios-rp-checker”) enables the service team associated with the flock has explicitly authorized CIOS Regional 1006 to generate, within the execution target tenancy, a resource principal for the flock.

At step 8, CIOS Regional 1006 may perform any suitable operations for planning the release against an execution target. In some embodiments, CIOS Regional 1006 may be configured to plan against each execution target as both the CIOS resource principal as well as the flock resource principal. In some embodiments, CIOS Regional 1006 may generate a RPT corresponding to the flock identified at step 6 and may exchange the RPT for a corresponding RPST from IAM 1008 (e.g., flock <environment> RPST). In some embodiments, IAM 1008 may whitelist or otherwise trust resource principal tokens of type “flock” that have been generated by CIOS Regional 1006.

At step 9, CIOS Regional 1006 may transmit the RPST obtained at step 8 (e.g., the RPST corresponding to the flock) with plan data to control plane 1010 to refresh/create a plan for performing a release (e.g., making the changes identified in the flock and according to the plan).

At step 10, Control Plane 1010 may transmit the RPST received at step 9 to IAM 1008 to authorize the operation. For example, IAM 1008 may verify that the first policy above exists. If the first policy exists and the operation is authorized by the policy, IAM 1008 may return an indication that the operation is authorized (e.g., that the flock corresponding to the RPST provided is authorized to manage resources in the execution target tenancy), Control Plane 1010 may update the plan.

At step 11, CIOS Regional 1006 may attempt to authorize operations for applying the release. CIOS Regional 1006 may generate a resource principal token (RPT) (e.g., named “cios-rp-checker”) indicating a target resource name indicating the identifier for the flock. CIOS Regional 1006 may transmit the RPT to IAM 1008 to exchange the RPT for a RPST.

Alternatively, the RPST obtained at step 7 may be used. The RPST may be provided to IAM 1008 which in turn may perform an authorization check. IAM 1008 may perform any suitable operation using the RPST for determining whether current policies allow for CIOS Regional 1006 to apply a particular flock (e.g., to create/update/delete resources of a particular flock) within the execution target tenancy. By way of example, the authorization check may be checking that the second policy provided above exists, allowing CIOS Regional 1006 apply a particular flock (e.g., create/update/delete resources of a particular flock) in the execution target tenancy. If the policy exists and the operation is allowed, the method 1000 may proceed to step 12.

At step 12, CIOS Regional 1006 may perform any suitable operations for applying the release. By way of example, applying the release may include iteratively performing steps 13 and 14 any suitable number of times corresponding to each resource of the flock (e.g., each resource specified in the flock configuration file).

At step 13, as part of applying a release, CIOS Regional 1006 may transmit a request to Control Plane 1010 (e.g., a downstream control plane, a resource manager, etc.), to create, update, or delete one or more resources in accordance with the resources specified in the flock configuration file received at step 6. The request may include the flock's resource principal (e.g., flock <environment> RPST)

At step 14, Control Plane 1010 (e.g., a resource manager for the resource to which the requests at step 13 relates) may transmit the flock resource principal (e.g., flock <environment> RPST) to IAM 1008 to authorize the operation at step 13. IAM 1008 may perform any suitable operation to authorize the operation based on checking the policies associated with the flock in the tenancy. For example, IAM 1008 may verify that the first policy above exists. If authorized, Control Plane 1010 may perform the requested operation (e.g., to create, update, or delete the requested resource).

FIG. 11 is a flow diagram illustrating another example method 1100 for authorizing modifications by an entity within a given execution tenancy, in accordance with at least one embodiment. The method 1100 may be performed using components of different realms (e.g., realm 1102 an example of a management realm such as realm 802 of FIG. 8, realm 1104 an example of a target realm such as realm 804 of FIG. 8). The method 1100 may be performed using control plane 1106 (e.g., control plane 407 of FIG. 4, control plane 640 of FIG. 6, etc.), orchestrator 1108 (e.g., region orchestrator 406 of FIG. 4, region orchestrator 610 of FIG. 6, etc.), data store 1110 (e.g., SPAM store 612 of FIG. 6), CIOS Central 1112 (e.g., CIOS Central 408 of FIG. 4, CIOS Central 604 of FIG. 6), CIOS Regional 1114 (e.g., CIOS Regional 410 of FIG. 4, CIOS Regional 614 of FIG. 6, etc.), and IAM 1116 (e.g., IAM 808 of FIG. 8). The method 1100 may include more or fewer steps than those depicted in FIG. 11. The operation discussed below may be performed in any suitable order.

Prior to the execution of method 1100, service teams may add new policies to tenancies in each realm (e.g., Realm 1104) for their SPAM. By way of example, the following policy may be added to the root compartment in the tenancy for each execution target to which the SPAM is to be applied:

Admit any-user of any-tenancy to {FLOCK_CREATE | FLOCK_READ
| FLOCK_UPDATE} in tenancy where all
{request.principal.type=‘spam’,
request.resource.id=‘id1.spam.r3..foo’} (1)

The following policies may be added to the root compartment of the SPAM specific tenancy within realm 1104.

Admit any-user of any-tenancy to { CIOS_SPAM_APPLY_CREATE }
in tenancy where all {request.principal.type=‘cios-rp-checker’,

| | |
|---|---|
| target.resource.id=‘id1.spam.r3..foo’} | (2) |

Endorse any-user to {FLOCK_CREATE | FLOCK_READ |
FLOCK_UPDATE} in any-tenancy where all
{request.principal.id=‘id1.spam.r3..foo’,

| | |
|---|---|
| request.principal.type=‘spam’} | (3) |

The first policy above may be used to ensure that a SPAM's flocks are authorized to manage all resources within an execution target tenancy (e.g., the execution target tenancy in Realm N). The second policy above (also referred to as “a resource checker policy”) may be used to ensure that CIOS Regional 1116 is allowed to perform operations related to creating or applying a SPAM. Create operations may include instantiating/generating a resource principal for a particular SPAM in a SPAM-specific tenancy of the target realm. Apply operations May include applying resource changes corresponding to one or more infrastructure or application releases of a SPAM, where each release may correspond to a respective flock. The third policy above may be used to ensure that a SPAM resource principal is authorized to perform flock create, read, and update operations (e.g., to manage flock resources) in the SPAM-specific tenancy of the target realm.

Prior to performing method 1100, control plane 1106 may perform operations to generate a build plan that includes executing one or more SPAMs (e.g., a SPAM set including one or more SPAMs to be utilized to build a set of services in the target realm). The build plan may indicate an order for performing a set of releases (e.g., each corresponding to a flock/flock configuration file of a SPAM) for building a set of services at one or more execution targets.

Method 1100 may begin at step 1, where a region build is initiated by control plane 1106 based at least in part on transmitting a request to orchestrator 1108. In some embodiments, the request may include a build plan generated by control plane 1106 (e.g., build plan 638 of FIG. 6).

At step 2, orchestrator 1104 may identify one or more individual SPAMs (e.g., from a SPAM set identified for the region build or from the build plan transmitted at step 1, if one was provided). By way of example, orchestrator 1108 may identify SPAM X:1.0.1 from the SPAM set or from the build plan and may execute operations for retrieving SPAM X:1.0.1 from data store 1110 (e.g., SPAM store 612 of FIG. 6).

At step 3, orchestrator 1104 may extract a flock (e.g., flock Y:1.0.1) that is associated with the SPAM X:1.0.1. The flock may correspond to an infrastructure or application release to be performed at an execution target of realm 1104.

At step 4, orchestrator 1104 may execute instructions to create a Resource Principal Token (RPT) for SPAM X:1.0.1. The RPT may include a set of claims that identify (e.g., by name) an issuer of the RPT (e.g., orchestrator 1108), a resource type (e.g., “SPAM”), a credential (e.g., a public key of a key pair assigned to the resource), a resource identifier (e.g., a unique identifier assigned to SPAM X:1.0.1), a token type indicating that the RPT is signed by a particular entity (e.g., the resource, orchestrator 1104), or the like. The RPT may be digitally signed using a credential associated with the signing entity (e.g., orchestrator 1108).

At step 5, orchestrator 1108 may execute instructions to obtain a SPAM Resource Principal Session Token (RPST) X:1.0.1 (RPST ocid=resource ocid) from IAM 1114 for the resource SPAM X:1.0.1 by passing IAM 1114 the RPT that was generated at step 4. IAM 1114 may perform authenticate the identity asserted by the RPT. This may include utilizing the signer's credential (e.g., a public key previously obtained and associated with orchestrator 1104) to verify that the RPT was signed by a particular entity (e.g., orchestrator 1108). If the RPT was signed by the particular entity (e.g., the resource manager of a resource such as orchestrator 1108 in the ongoing example), IAM 1114 may generate and sign a Resource Principal Session Token (RPST). The RPST may be used to perform AuthN and AuthZ checks. The identity of the resource principal may be verified by a receiver of the RPST by verifying that IAM 1114 signed the RPST. One or more access policies that are associated with the resource may be used to determine whether the operations requested are to be allowed or rejected.

At step 6, orchestrator 1108 may execute instructions to call (e.g., via an API call ApproveReleaseInPhase) to CIOS Central 1112 with the RPST X:1.0.1 (e.g., the RPST for SPAM X:1.0.1) for Flock Y:1.0.12. In some embodiments, orchestrator 1108 may add an additional header in the header of the message with which the RPST is transmitted. The additional header may include a realm identifiers map. In some embodiments, the realm identifiers map may indicate associations between realm identifiers and their corresponding SPAM-specific tenancy name. As a non-limiting example, orchestrator 1108 may transmit a mapping that includes a unique identifier of the SPAM in each realm. Any suitable data transmitted between orchestrator 1108 and CIOS Central 1112 may be transmitted via a secure connection (e.g., an mTLS connection requiring mutual authentication between orchestrator 108 and CIOS 1112). In some embodiments, the request may be signed by the calling entity (e.g., orchestrator 1108).

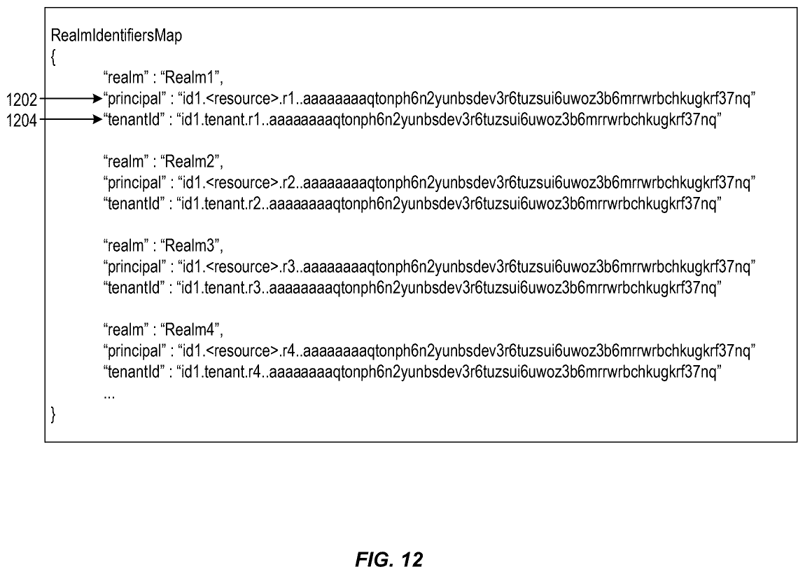

FIG. 12 is a block diagram illustrating an example realm identifiers map (e.g., map 1200), in accordance with at least one embodiment. Map 1200 may be an example of a mapping between identifiers corresponding to each realm in a governance enclave and any suitable combination of the resource principal identifier for the resource in the corresponding realm and/or a tenant identifier identifying the tenancy in which the resource is to be provisioned/deployed within the corresponding target realm. As depicted, realm identifier “Realm1” may be mapped to principal 1202 and tenantId 1204. Any suitable number of identifiers (e.g., resource identifiers, tenantIds, etc.) may be mapped to any suitable number of realms within realm identifiers map. In some embodiments, the resource identifier in one realm may be used (e.g., by the resource manager, orchestrator 1108 in the example of FIG. 11), to generate each of the remaining resource identifiers for each of the other realms based at least in part on a predefined naming convention, scheme, or protocol. For example, principal identifier “id1.<resource>.r1 . . . ” in Realm 1 may be used to generate the principal identifiers for each of the other realms based on a predefined protocol that replaces a portion of the principal identifier in Realm 1 (e.g., “r1”) with a corresponding portion for Realm N (e.g., “rN”). By way of example, the mapping of “id1.<resource>.r1 . . . ” to Realm 1 may be used to generate the mapping of “id1.<resource>.r2 . . . ” to Realm 2, based on a protocol that replaces “r1” in the first identifier with “r2” corresponding to Realm 2. Other naming conventions, schemes, or protocols are contemplated. In some embodiments, any suitable resource manager may maintain and/or generate a similar mapping for any suitable resources that it is responsible for managing. For example, because orchestrator 1108 manages SPAMs, it may maintain and/or generate a mapping between SPAM resource principal identifiers for any suitable number of SPAMs and the identifier for each corresponding realm. In some embodiments, CIOS Central 1112 is configured as the resource manager for flocks/flock configuration files. In these embodiments, CIOS Central 1112 may maintain and/or generate a similar mapping as depicted in FIG. 12 where resource identifiers and/or resource principal identifiers corresponding to one or more flocks are mapped to a respective realm identifier.

Returning to FIG. 11, at step 7, CIOS Central 1112 may authenticate that the RPST was signed by IAM 1114. If so, the SPAM's identity may be verified and CIOS Central 1112 may perform AuthZ operations for the incoming request to validate if the SPAM X:1.0.1 is authorized to create a release for the specified flock Y:1.0.12 in Realm 1102. For example, CIOS Central 1112 may pass the RPST X:1.0.1 with an indication that the resource is requesting creation of a resource for a specific flock (e.g., flock Y:1.0.1) in a flock-specific compartment of Realm 1102.

At step 8, IAM 1114 may respond to the AuthZ request indicating that the SPAM X:1.0.1 is authorized to create a release for the specified flock (e.g., flock Y:1.0.1) in the flock-specific compartment of Realm 1102.

At step 9, CIOS 1112 may extract the SPAM tenant name for the target realm from the realm identifiers map (e.g., map 1200 of FIG. 12) provided in the header of the API call at step 6. The SPAM tenant name may identify a name of the SPAM-specific tenancy in the target realm (e.g., Realm 1104).

At step 10, CIOS 1112 may call CIOS Regional 1116 (e.g., via an mTLS connection requiring mutual authentication between the two) via an API to request the tenant identifier corresponding to the tenant name obtained at step 9. The SPAM tenant identifier (ID) may be a unique resource identifier for the SPAM-specific tenancy within the target realm (e.g., Realm 1104).

At step 11, CIOS Regional 1116 may call an API of IAM 1118 to request the tenant ID for the tenant name provided in the call.

At step 12, IAM 1118 may respond with the tenant ID for the SPAM-specific tenancy in Realm 1104 that corresponds to the tenant name provided at step 11. CIOS Regional 1116 may forward the tenant ID to CIOS Central 1112 at step 13.

At step 14, CIOS Central 1112 may convert the resource identifier of the SPAM X:1.0.1 in the host realm (e.g., Realm 1102) to the corresponding resource principal identifier of the SPAM within the target realm (e.g., Realm 1104). For example, the resource principal identifier for the SPAM in Realm 1102 (e.g., SPAM X:1.0.1) may be converted to the resource principal identifier for the same SPAM in the target realm (e.g., SPAM X.N.0.1 corresponding to Realm 1104) based at least in part on the map provided by orchestrator 1108 at step 6. In some embodiments, CIOS Central 1112 may utilize a map that it generates and/or maintains (e.g., map 1200 of FIG. 12 that includes identifiers corresponding to one or more flocks and/or services) that includes associations between a resource principal identifier for any suitable number of flocks to a corresponding realm identifier. By finding the resource principal identifier of the flock in a management realm (e.g., flock Y.1.0.1 in Realm 1102), the corresponding resource principal identifier of the flock in any target realm (e.g., Y.N.0.1 in Realm 1104) may be identified.

At step 15, CIOS Central 1112 may instruct CIOS Regional 1116 via a call made through mTLS to execute the flock (e.g., flock Y:N.0.1) in the context of SPAM (X.N.0.1) (e.g., where the SPAM is treated as the calling entity). In some embodiments, the SPAM ID (e.g., X.N.0.1), the SPAM tenant ID provided at step 13, the flock ID (flock Y.N.0.1), and a flock execution target tenant ID may be passed in the request. In some embodiments, the flock ID and an identifier for the execution target tenancy in which the flock is to be released may be obtained from the map 1200 maintained by CIOS Central 1112 that maps flock target tenancy IDs of a flock to corresponding realm identifiers. The SPAM ID may be obtained from the map provided by orchestrator 1108 at step 6. The SPAM tenant ID may be obtained from the data provided at step 13, utilizing the SPAM tenant name provided in the map provided by the orchestrator 1108 at step 6. In some embodiments, the SPAM ID and SPAM tenant ID may be provided in a header added to the request.

At step 16, CIOS Regional 1116 may generate an RP-checker Resource Principal (e.g., an RPT) and provide the RPT to IAM 1118. An RP-checker Resource Principal may be one minted/generated in a tenancy corresponding to CIOS Regional 1116. An RP-checker resource principal may be used to validate whether a service team associated with a SPAM (e.g., a service team of SPAM X.N.0.1) has provided explicit permissions/policies to allow CIOS Regional 1116 to generate a resource principal in the service team's tenancy. In the ongoing example, this check may enable CIOS Regional 1116 to determine (e.g., according to the second policy provided above) whether CIOS Regional 1116 is authorized to create resource principals in SPAM X.N.0.1's tenancy (e.g., a tenancy corresponding to the service team that authored SPAM X.N.0.1). The tenancy to which resources for SPAM X.N.0.1 are to be provisioned and/or deployed may be referred to as “a SPAM-specific” tenancy or “service-specific” tenancy. In sone embodiments, CIOS Regional 1116 may be trusted by IAM 1118 to mint/generate any resource principal of type “cios-rp-checker.” The RPT may include indicate a principal type (e.g., ‘cios-rp-checker’) and a target resource ID (e.g., the identifier corresponding to SPAM X.N.0.1 in real 1104, for example ‘id1.spam.r3 . . . foo’}

At step 17, IAM 1118 may return a RPST for the RP-checker resource provided at step 16.

At step 18, CIOS Regional 1116 may transmit the RPST for the RP-checker to IAM 1118 with an AuthZ request to validate whether a service team associated with a SPAM (e.g., a service team of SPAM X.N.0.1) has provided explicit permissions/policies to allow CIOS Regional 1116 to generate a resource principal in the service team's tenancy. In the ongoing example, this check may enable CIOS Regional 1116 to determine (e.g., according to the second policy provided above) whether CIOS Regional 1116 is authorized to create resource principals within the tenancy corresponding to SPAM X.N.0.1. This check may attempt to authorize the operation CIOS_SPAM_CREATE in the root compartment of SPAM X.N.0.1's tenancy within realm 1104.

At step 19, IAM 1118 may return an indication that CIOS Regional 1116 is authorized to perform the operation.

At step 20, CIOS Regional 1116 may generate a resource principal token for SPAM X.N.0.1 with the resource identifier and tenant Id provided at step 15. The RP-checker related operations discussed at steps 16-20 may ensure that CIOS Regional 1116 has permissions to manage the SPAMs resources within the tenancy before a resource principal for the SPAM is created.

At step 21, the resource principal token (RPT) created for the SPAM may be transmitted to IAM 1118. The RPT may indicate a resource principal identifier for the SPAM (e.g., SPAM X.N.0.1, ‘id1.spam.r3 . . . foo’) and a principal type (e.g., “SPAM”). This may cause IAM 1118 to check for the first policy provided above indicating that the SPAM resource principal is allowed to perform flock create, read, and update operations (e.g., to manage flock resources) in the tenancy corresponding to the execution target.

At step 22, IAM 1118 may return an RPST or other suitable indication that indicates that the resource principal for the SPAM is allowed to perform flock create, read, and update operations (e.g., to manage flock resources) in the tenancy corresponding to the execution target. This indication may be forwarded at step 23 to CIOS Central 1112, and to orchestrator 1108 at step 24. If any of the authorization checks fail, the indication provided at steps 23-25 may indicate that the corresponding authorization(s) failed. In some embodiments, orchestrator 1108 may not initiate a release corresponding to flock Y:N.0.1 of SPAM X.N.0.1 unless an indication that both authorization checks discussed at steps 18 and 21 are successful.

### Projecting Resource Principals Across Identity Boundaries

As discussed above, cross-realm calls may be enabled through projecting a resource's identity (e.g., a resource principal identity) from a management realm (e.g., a host realm or any suitable realm that is used to manage orchestration in a governance enclave) to each of the other realms in a governance enclave. Identity projection can be implemented using Resource Principals by participating services. Resource Principals can also be viewed as identities provisioned by a service, and implementations may allow custom claims to be added to the principal object. In legacy systems, Identity (e.g., an Identity Access Management IAM service, IAM system 806 of FIG. 8, IAM system 808 of FIG. 8) was the only service that could assign principals (e.g., resource principals, user principals, service principals, etc.) to entities in a cloud environment. However, in some embodiments, Identity may delegate to another service (e.g., a resource manager service) the task of creating resource principals for a set of resources (e.g., resource of a type managed by that service), maintaining policies, and performing AuthN/AuthZ checks against that principal. This may greatly increase the scope of intercommunication of objects of different services with each other. Now, these resources can have their own identities, and have permissions scoped to them, instead of always going through their parent service (and using the service's identity to make requests to other entities). This approach allows fine grained policy management in terms of resources, rather than just stopping at the parent service boundary.

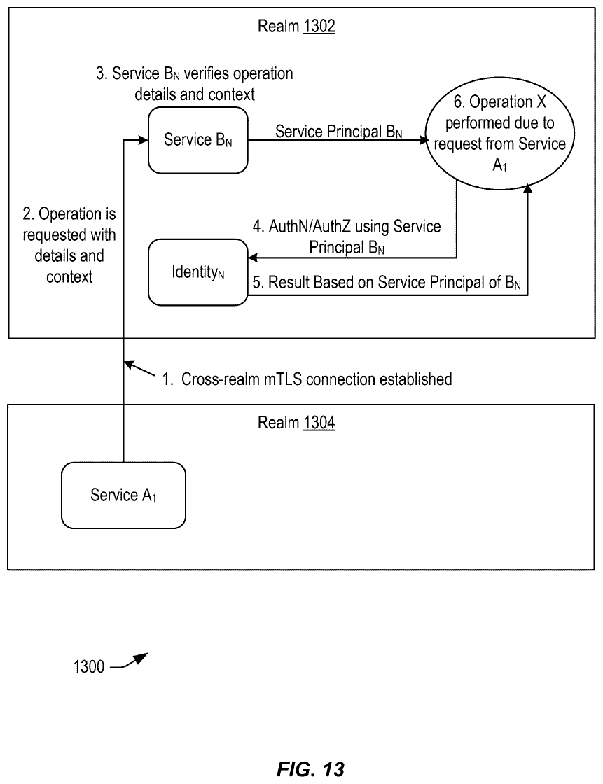

FIG. 13 is a block diagram 1300 depicting a conventional approach to cross-realm communication. As mentioned above, previous implementations for cross-realm communications required a cross-realm mutual Transport Layer Security (mTLS) connection between resources of different realms as depicted in FIG. 13. As a part of any such communication, a service in the target realm (e.g., Realm 1302, an example of Realm 802 of FIG. 8) may perform an operation based on the information/message/request from service A₁ in the host realm (e.g., Realm 1304, an example of Realm 804 of FIG. 8). In previous implementations, custom logic was added to Service BN to verify the intent of the operation. All of the operations performed by Service BN in the target region 1302, were performed using the service principal of service BN. In the diagram 1300, the Service Principal of service BN is used to authorize the operation. Service Principal BN is inherently a very powerful principal has a wide scope of permissions granted to it. Therefore, all operations that service BN performs on behalf of service A₁, need to be carefully reviewed, and possible tightened in scope and permissions.

As a non-limiting example, at step 1, a mTLS connection may be established between Service A₁ of Realm 1304 and Service B_{N} of Realm 1302. Service B_{N} may be configured to perform a mutual authentication process with Service A₁ as part of establishing the mTLS connection.

At step 2, Service A₁ may transmit a requested operation to Service B_{N} along with details and contextual information.

At step 3, Service B_{N} may be configured to verify the operation, details, and contextual information provided based at least in part on a predefined rule set. If authorized, the operation may be performed by Service B_{N} on behalf of Service A₁ using Service B_{N}'s service principal.

At step 4, AuthN and AuthZ checks for the operation may be performed with the identity management service of Realm 1302 (e.g., Identity N) using Service B_{N}'s service principal.

At step 5, the result(s) of the of the AuthN/AuthZ checks may be returned. These results may be determined based on the policies associated with Service B_{N}'s service principal.

If authorized, the operation may be performed at step 6. This approach enables Service A₁ to be authenticated, but lacks support for policy-based authorization of Service A₁ via Identity N.

There are a number of issues with this approach. For example, custom verification logic had to be added to Service B_{N}. This logic was often hard coded. Custom logic had to be added to downstream services as well which may want to support any such cross-realm action (e.g., Service B_{N}→Service C_{N}, and Service B_{N}→Service D_{N}, and Service B_{N}→Service E_{N}). Then all of these services (Service C_{N}, Service D_{N}, and Service E_{N}) had to have either custom verification logic added to allow the operation, or they would need to be configured to implicitly trust service B_{N}'s decisions as to whether to allow/reject the operation. Service B_{N} proceeded to perform the operation with its own service principal which is very powerful. However, this approach had little flexibility and a lower granularity of AuthZ. Additionally, this approach allowed Service B_{N} to manage resources in tenancy, which is not ideal.

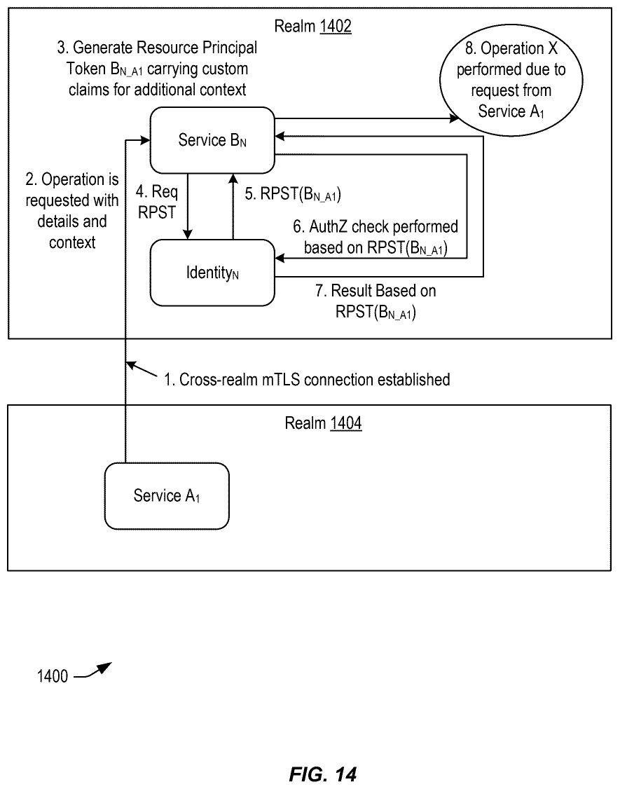

FIG. 14 is a block diagram depicting a process 1400 for projecting an identity of an entity across identity boundaries (e.g., between two identity realms such as Realm 1402 and Realm 1404), in accordance with at least one embodiment. Instead of the process depicted in FIG. 13 in which a service principal of Service B_{N} is used, operations may be performed in the target realm (e.g., Realm 1402, an example of Realm 1302 of FIG. 13) using a resource principal (e.g., Resource Principal Session Token (RPST) B_{N_A1}) generated for the caller (e.g., Service A₁ of Realm 1404). The RPST B_{N_A1} may be a resource principal of Service B_{N} with one or more custom claims for additional context (e.g., to indicate the original calling entity). This may limit permission of the operation and add more guardrails than the earlier model of manually reviewing code. Policies written for the resource principal of B_{N_A1} (e.g., RPST (B_{N_A1})), can decouple the operations performed independently by Service B_{N}, and those performed in response to an event/request from a service in a different realm (e.g., Service A₁). This may limit the blast radius/attack surface for inter realm communications/operations that are compulsory.

Advantageously, Service A₁ may have a projected identity in Realm 1402, that is referred to as Resource Principal B_{N_A1}. All AuthZ complexity which had to be implemented in custom logic by Service B_{N} in the earlier model depicted in FIG. 13, may be abstracted away and performed by Identity (e.g., Identity_{N}, an example of IAM 808 of FIG. 8), and granular policy statements can be written in any tenancy in Realm 1402 that refer to Service A₁ as Resource Principal B_{N_A1}. In this manner, the policies written for Resource Principal B_{N_A1} may be used to perform AuthZ checks against operations to be performed in Realm 1402 per a request initiated by Service A₁ in Realm 1404.

At step 1, a mTLS connection may be established between Service A₁ of Realm 1404 and Service B_{N} of Realm 1402. Service B_{N} may be configured to perform a mutual authentication process with Service A₁ as part of establishing the mTLS connection.

At step 2, Service A₁ may transmit a requested operation to Service B_{N} along with details and contextual information. Service A₁ may project its identity by including the identifier for its identity in Realm 1402 in the data transmitted via the cross-realm mTLS connection. In some embodiments, Service A₁ may project its identity by including a map (e.g., map 1200 of FIG. 12) that indicates an identifier for Service A₁ in each realm of a governance enclave in the request. In some embodiments the identifier (or map) may be provided in one or more custom claims of the request (e.g., in an auth header of the request) or the identifier (or map) may be provided in a header that is separate from an auth header of the request.

At step 3, Service B_{N} may generate Resource Principal Token B_{N_A1}. Resource Principal Token B_{N_A1} may be a Resource Principal Token (RPT) that includes one or more custom claims that indicate the operations are being performed due to a request from Service A₁. In some embodiments, the custom claim(s) may include the identifier for Service A₁ in realm 1402 as provided in the request received at step 2.

At step 4, Service B_{N} may request a Resource Principal Session Token (RPST) from Identity using the RPT generated at step 3.

At step 5, Identity_{N} may return the requested Resource Principal Session Token (RPST (B_{N_A1})). The RPST may include the custom claim(s) provided at step 3. In some embodiments, Identity may perform an AuthN check using the custom claims provided at step 3. It may be the case that Identity_{N} is configured to trust RPTs generated by Service B_{N} (e.g., for RPTs of a particular resource type such as “flock,” “SPAM,” etc.).

At step 6, Service B_{N} may perform an AuthZ check based on RPST (B_{N_A1}). For example, the receiver may transmit data indicating the requested operation and RPST (B_{N_A1})) to Identity_{N}. Identity may perform an authorization check to determine whether RPST (B_{N_A1}) (e.g., Service A₁ in Realm 1402) is authorized to perform the requested operation. AuthZ checks may be performed using the RPST (B_{N_A1}) and the result may therefore be based on the policies associated with RPST (B_{N_A1}).

At step 7, the result of the AuthZ check(s) may be provided to Service B_{N}. If RPST (B_{N_A1}) is authorized to perform the operation, the method 1400 may proceed to step 8.

Else, the operation may be rejected and a status indicating the same may be transmitted back to Service A₁.

At step 8, the requested operation may be performed by Service B_{N} on behalf of Service A₁.

In some embodiments, Service A₁ may be an example of a proxy service of a first identity realm (e.g., realm 1404) and Service B_{N} may be an example of a proxy service of a second identity realm (e.g., realm 1402) that is configured to mint (e.g., generate) resource principals. In these embodiments, Service B_{N} may perform the operations discussed above in connection with steps 3-5. Service B_{N} may then provide the resource principal (represented by RPST (B_{N_A1})) to another service (Service SN not depicted) via a function call. The Service SN may perform the operations of steps 6-8 (instead of Service B_{N} as described above).

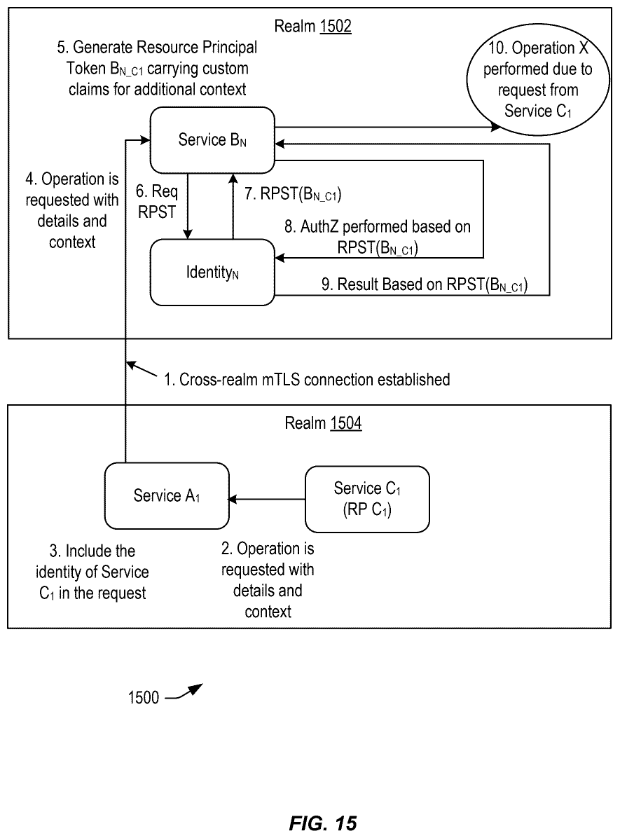

FIG. 15 is a block diagram depicting a process 1500 for projecting an identity of a machine caller across identity boundaries (e.g., between two identity realms), in accordance with at least one embodiment. Realm 1502 may be an example of a target realm (e.g., Realm 804 of FIG. 8). Realm 1504 may be an example of a host realm (e.g., Realm 802 of FIG. 8). FIG. 15 depicts a use case in which Service C₁ of realm may initiate a call to Service A₁ using the identity corresponding to resource principal (RP) C₁. In some embodiments, such as the example provided in FIG. 11, Service C₁ may initiate a call with a resource principal (RP) corresponding to another entity (e.g., SPAM X:1.0.1, as described in connection with FIG. 11).

At step 1, a mTLS connection may be established between Service A₁ of Realm 1504 and Service B_{N} of Realm 1502. Service B_{N} may be configured to perform a mutual authentication process with Service A₁ as part of establishing the mTLS connection.

At step 2, Service C₁ may transmit a requested operation to Service A₁ along with details and contextual information. The call may correspond to an operation that may need to be conducted in Realm 1502 (e.g., by an entity of Realm 1504 such as Service C₁, SPAM:X.1.0.1, or the like). The identity of the caller (e.g., the machine caller corresponding to RP C₁, RP SPAM:X.1.0.1, etc.) in each of one or more realms (e.g., realms separate from realm 1504, from an identity boundary perspective) may be included in message between Service C₁ and Service A₁. By way of example, a mapping or list of the identifiers of the resource principal of the caller in each of a number of realms (e.g., map 1200 of FIG. 12) may be included in a newly added portion of the message (e.g., an additional header specific to this information, that is separate from an auth header that includes the identity claims of RP C₁ in realm 1504). As a non-limiting example, RP C₁ may have an identity of RP C₁ in Realm 1504, RP C₁.N in Realm 1502, and RP C₁.M in Realm M (not depicted). A map or list including RP C₁, C₁.N, and C₁.M may be included in data transmitted between Service C₁ and Service A₁ via a header that is separate from the auth header that comprises the identity claims of RP C₁ in realm 1504. As another non-limiting example, RP SPAM:X.1.0.1 may have an identity of RP SPAM:X.1.0.1 in Realm 1504, RP SPAM:X.N.0.1 in Realm 1502, and RP SPAM:X.M.0.1 in Realm M (not depicted). A map or list of RP SPAM:X.1.0.1, RP SPAM:X.N.0.1, and RP SPAM:X.M.0.1 may be included in data transmitted between Service C₁ and Service A₁ via a header that is separate from the auth header that comprises the identity claims of RP C₁ in realm 1504.

At step 3, Service A₁ may be configured to include the identity in realm 1504 for the caller in realm 1502 (e.g., RP C₁, RP SPAM:X.1.0.1) in the message to be transmitted via the cross-realm mTLS connection between Service A₁ and Service B_{N} to realm 1504 at step 4. In some embodiments, Service A₁ may be configured to filter the information received from Service C₁ at step 2 and include a claim (e.g., within an authorization header of the message transmitted between Service A₁ and Service B_{N} at step 4) that indicates that the identity of the caller in Realm 1502 (e.g., RP C₁.N corresponding to the identifier for Service C₁ in realm 1502, SPAM:N.1.0.1 corresponding to the SPAM ID in realm 1502). This may include overwriting an authorization header (e.g., an auth header) that included claims of for the resource principal in realm 1502 (e.g., RP C₁, SPAM:X.1.0.1) with a claim that identifies the caller using the corresponding resource principal identifier in realm 1504 (e.g., RP C₁.N, SPAM:X.N.0.1). In this manner, the claims of the entity RP C₁ in Realm 1504 may be “replayed” to the projected identity RP C₁.N in realm 1502. In some embodiments, the Service A₁ may transmit the map or list that indicates the identity of the call in each realm to Service B_{N} (e.g., by adding the map/list to an additional header separate from the auth header). In these embodiments, Service B_{N} may identify the identifier for the caller that corresponds to realm 1502.

At step 5, Service B_{N} may generate Resource Principal Token B_{N_C1}. Resource Principal Token B_{N_C1} (or Resource Principal Token B_{N}_SPAM) may be a Resource Principal Token (RPT) generated by Service B_{N} that includes one or more custom claims that indicate the operations are being performed due to a request from the caller. The identifier of the caller (e.g., RP C₁.N, SPAM:X.N.0.1) may correspond to the caller's identity in realm 1502 and may be obtained from a map provided in a header of the request or from a claim provided in the auth header of the request.

At step 6, Service B_{N} may request a Resource Principal Session Token (RPST) from Identity_{N} using the RPT generated at step 5.

At step 7, Identity_{N} may return the requested Resource Principal Session Token (RPST (B_{N_C1})). The RPST may include the custom claims provided at step 5. In some embodiments, Identity_{N} may perform AuthN processing. It may be the case that Identity_{N} is configured to trust RPTs generated by Service B_{N} (e.g., for RPTs of a particular resource type such as “flock,” “SPAM,” etc.).

At step 8, Service B_{N} may perform an AuthZ check based on RPST (B_{N_C1}). For example, Service B_{N} may transmit data indicating the requested operation and RPST (B_{N_C1})) to Identity_{N}. Identity_{N} may perform authorization checks to determine whether RPST (B_{N_C1}) (e.g., the identity of Service C₁ in Realm 1502) is authorized to perform the requested operation. AuthZ checks may be performed using the RPST (B_{N_C1}) and the result may therefore be based on the policies associated with RPST (B_{N_C1}).

At step 9, the result of the AuthZ check(s) may be provided to Service B_{N}. If RPST (B_{N_C1}) is authorized to perform the operation, the method 1500 may proceed to step 10. Else, the operation may be rejected and a status indicating the same may be transmitted back to Service C₁ (e.g., via Service B_{N} and Service A₁).

At step 10, the requested operation may be performed in Realm 1502 due to the request initiated from Service C₁ in Realm 1504.

In some embodiments, Service A₁ may be an example of a proxy service of a first identity realm (e.g., realm 1504) and Service B_{N} may be an example of a proxy service of a second identity realm (e.g., realm 1502) that is configured to mint (e.g., generate) resource principals. In these embodiments, Service B_{N} may perform the operations discussed above in connection with steps 5-7. Service B_{N} may provide the resource principal (e.g., represented by RPST (B_{N_C1})) to another service (Service S_{N} not depicted) via a function call. The Service S_{N} may perform the operations of steps 8-10 (instead of Service B_{N} as described above).

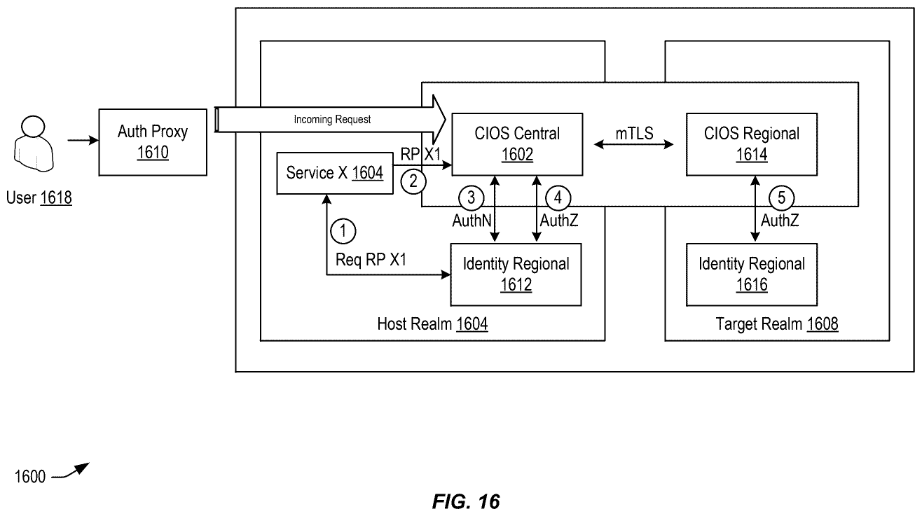

FIG. 16 is a block diagram depicting an example of the process of FIG. 15 for projecting an identity of a machine caller across identity boundaries (e.g., between two identity realms), in accordance with at least one embodiment. CIOS Central 1602 (e.g., CIOS Central 108 of FIG. 1, CIOS Central 408 of FIG. 4, etc.) may be hosted in a host realm 1604 (e.g., an identity realm associated with a corporate scope, referred to as a “corporate realm,” a “host realm,” a “management realm,” herein) may be configured to handle deployment and management of flocks for a governance enclave consisting of all connected realms (each connected realm being referred to as a “target realm”). Projects attempting to automate various aspects of deployments may call CIOS Central 1602 in host realm 1604 in the context of a resource (e.g., a flock, a SPAM, etc.) to perform operations in different realms (e.g., one or more target realms corresponding to execution targets of a target region) within the same governance enclave. For example, Service X 1606 (e.g., orchestrator 106 of FIG. 1, region orchestrator 406 of FIG. 4, etc.) may call CIOS Central 1602 in the context of a resource (e.g., a flock, a SPAM, respectively) to perform one or more releases in target realm 1608 (e.g., an example of realm 804 of FIG. 8). This entails performing AuthN/AuthZ checks at the Governance Enclave level.

IAM authentication and authorization envelopes the context of the request, requester and the target, and allows fine-grained policies around authorizing the operation to be written and enforced. However, these policies are scoped to a given realm, and identity policy statements can only reference entities local to the realm. As a result, legacy implementations had no standard mechanism to identify/reference entities and perform fine grained AuthN/AuthZ at the Governance Enclave level.

AuthN data provides the identity of the caller and AuthZ data provides the permissions granted to the caller. As depicted in FIG. 16, Auth Proxy 1610 may be a service that performs AuthN checks at a governance enclave level and forwards the information to CIOS Central 1602 (e.g., CIOS Central 108 of FIG. 1, CIOS Central 408 of FIG. 4, etc.). CIOS Central 1602 may be configured to trust AuthN information provided by Auth Proxy 1610 and use it for AuthZ checks with identity regional 1612 in the host realm 1604. CIOS Central 1602 may relay this information to CIOS Regional 1614 (e.g., CIOS Regional 110 of FIG. 1, CIOS Regional 410 of FIG. 4) in the target realm 1608, where the latter may perform another AuthZ operation (e.g., with identity regional 1616, the identity access management system of the target realm 1608).

It may be noted that authZ checks are depicted as being performed in both the host realm and target realm. Permissions and AuthZ may be defined by policy statements in host realm 1604. Policy statements may refer to realm local entities. Therefore, a policy statement in one realm may not have the entire context to approve or deny a request unilaterally. CIOS (e.g., CIOS 102 of FIG. 1 CIOS 402 of FIG. 4, etc.) may be configured to handle this by breaking the AuthZ check into two checks, one in the host realm and another in the target realm. CIOS Central 1602 may perform an AuthZ check with identity regional 1612 in the host realm 1604, while CIOS Regional 1614 may perform another check with identity regional 1616 in the target realm 1608. With this approach, the target realm 1604 (and its operators) may also maintain independence where the realm can have a separate set of policies with which it is governed.

In the example provided in FIG. 16, AuthN (e.g., an identity check of the user, in this example, an OCI operator) may be performed by Auth Proxy 1610. In some embodiments, Auth Proxy 1610 may provide CIOS Central 1602 with a Realm Identifiers Map (e.g., map 1200 of FIG. 12). This map may indicate the identity of the user 1618 in every realm). CIOS Central 1602 may perform any suitable AuthZ check of user 1618 within the host realm 1604 (e.g., using identity regional 1612, the identity access management service of the host realm 1604).

Service X 1604 may be an example of Orchestrator 106 of FIG. 1 and/or Region Orchestrator 406 of FIG. 4. Service X 1604 may execute calls to perform operations (e.g., infrastructure and/or application releases) in the context of a resource (e.g., a SPAM). By way of example, Service X 1604 may request an infrastructure release in the context of a SPAM in the host realm 1604 to be performed within a tenancy of a target realm 1608.

At step 1, Service X 1604 may generate a resource principal token (RPT) for the resource and communicate the RPT to identity regional 1612. Alternatively, Service X 1604 may request a resource principal session token (RPST) for a SPAM from identity Regional 1612. The resource principal session token for the SPAM may be referred to as “RP X1” (e.g., a resource principal with a type corresponding to the name of the SPAM). RP X1 may be received from identity regional 1612 of the host realm 1604.

At step 2, Service X 1604 may provide a map (e.g., map 1200 of FIG. 12) that lists the identity of the SPAM with every realm, including the host realm 1604 and the target realm 1608. In some embodiments, Service X 1604 may generate the map based at least in part on a predefined scheme or the map may be predefined and accessible to Service X 1604. In some embodiments, the map may indicate RP X1 is the identity of the SPAM in host realm 1604.

At step 3, CIOS Central 1602 may extract the identity for the SPAM in the host realm 1604 and the target realm 1608 from the map received at step 2. The host realm identity (RP X1) may be used to perform an AuthN check to authenticate the identity of the SPAM. In some embodiments, the map may be presented at any suitable user interface managed by CIOS Central 1602.

At step 4, CIOS Central 1602 in the host realm 1604 may perform an AuthZ check in which CIOS Central 1602 uses the host realm identity from the map (RP X1) and authorizes the host realm identity to perform the scope of the operation. By way of example, CIOS Central 1602 may perform an AuthZ check to see if the RP X1 (corresponding to the SPAM) is authorized to request a flock to perform an operation within a given tenancy (e.g., a tenancy associated with service team A) of the host realm 1604. CIOS Central 1602 may pass the identity (e.g., RP X2) of the entity (e.g., the SPAM) within the target realm 1608 to CIOS Regional 1614. The communication between CIOS Central 1602 and CIOS Regional 1614 may be performed over an mTLS connection where both endpoints mutually authenticate one another and, therefore, trust each other. In some embodiments, the data sent over this connection may be unsigned due to the trust between endpoints. In other embodiments, the data sent over the connection may be digitally signed using a credential (e.g., a private key of a key pair) associated with the sender and verified by the recipient (e.g., using a public key of the key pair associated with the sender).

At step 5, CIOS Regional 1614 may be configured to perform a second AuthZ check using the identity of the entity (e.g., RP X2) within the target realm. The AuthZ check may include checking whether the identity of the SPAM within target realm 1608 (e.g., RP X2) is authorized to request a flock to perform an operation within a given tenancy (e.g., an execution target's tenancy associated with service team A) of the target realm 1608. In some embodiments, CIOS Regional 1614 may create an RP-Checker resource which performs an AuthZ check to see whether CIOS Regional 1614 is authorized to create a resource principal (of resource type “SPAM) in the SPAM's tenancy in target realm 1608. If the AuthZ check passes, CIOS Regional 1614 may generate a resource principal object (e.g., a Resource Principal Token (RPT)) for the SPAM with the identity of the SPAM (e.g., RP X2). CIOS Regional 1614 may check with identity regional 1616 to determine whether the SPAM is authorized to create a release (e.g., for Flock Y). If this AuthZ check passes, CIOS Regional 1614 may obtain a Resource Principal Session Token (RPST) for the Flock to perform the relevant operations.

FIG. 11 provides a specific example of the method 1600, where orchestrator 1108 is an example of service X 1604, CIOS Central 1112 is an example of CIOS Central 1602, IAM 1114 is an example of Identity Regional 1612, CIOS Regional 1116 is an example of CIOS Regional 1614, and IAM 1118 is an example of Identity Regional 1616.

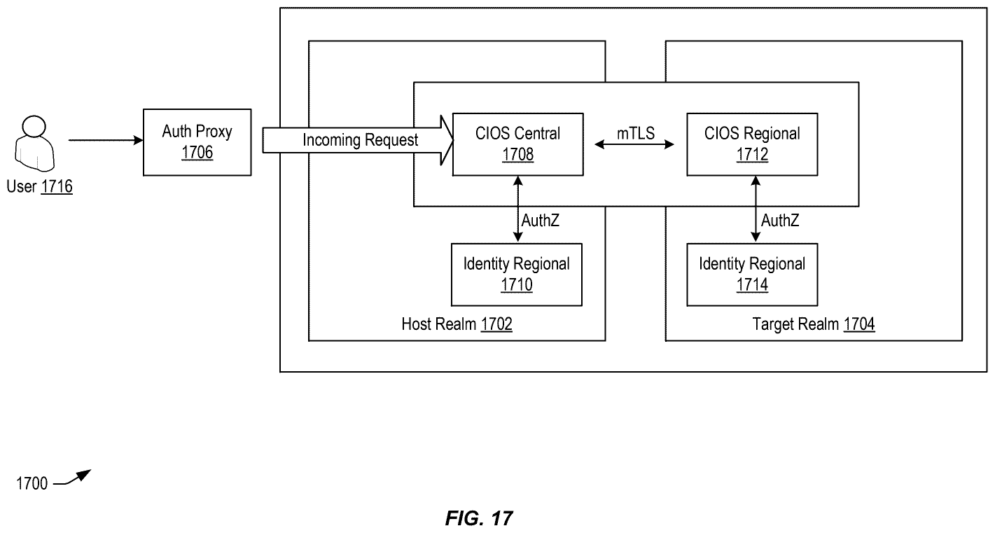

FIG. 17 is a block diagram depicting an example of the process 1700 for projecting an identity of a user across identity boundaries (e.g., between two identity realms such as host realm 1702 and target realm 1704), in accordance with at least one embodiment. Host realm 1702 may be an example of realm 802 of FIG. 8. Target realm 1704 may be an example of realm 804 of FIG. 8.

As discussed above, AuthN data provides the identity of the caller and AuthZ data provides the permissions granted to the caller. As depicted in FIG. 17, Auth Proxy 1706 may be a service that performs AuthN identity checks at a governance enclave level and forwards AuthN data to CIOS Central 1708 (e.g., CIOS Central 108 of FIG. 1, CIOS Central 408 of FIG. 4, etc.).

CIOS Central 1708 may be configured to trust AuthN data provided by Auth Proxy 1706 and use it for AuthZ checks with Identity Regional 1710 in the host realm 1702. CIOS Central 1708 may this information with identity data of the user 1716 in target realm 1704 to CIOS Regional 1712 (e.g., CIOS Regional 110 of FIG. 1, CIOS Regional 410 of FIG. 4) in the target realm 1704, where CIOS Regional 1712 performs another AuthZ check with the provided identity data (e.g., with Identity Regional 1714, the identity access management system of the target realm).

It may be noted that AuthZ checks are depicted as being performed in both the host realm 1702 and target realm 1704. Permissions and AuthZ are defined by Policy Statements in host realm 1702. Policy statements may refer to realm local entities. Therefore, a policy statement in one realm may not have the entire context to approve or deny a request unilaterally.

CIOS (e.g., CIOS 102 of FIG. 1 CIOS 402 of FIG. 4, etc.) may be configured to handle this by breaking the AuthZ check into two checks, one in the host realm 1702 and one in the target realm 1704. CIOS Central 1708 may perform an AuthZ check in the host realm 1702, while CIOS Regional 1712 may perform another check in the target realm 1704. With this approach, the target realm 1704 (and its operators) may also maintain independence where the realms can have a separate set of policies with which they are governed.

In the example provided in FIG. 17, an AuthN check (e.g., an identity check) is performed by Auth Proxy 1706. In some embodiments, Auth Proxy 1706 may provide CIOS Central 1708 with a Realm to Principal map (e.g., map 1200 of FIG. 12 that maps realm identifiers to principal identifiers for user 1716. This map may indicate the identity of the caller (e.g., user 1716) in every realm, including host realm 1702 and target realm 1704). CIOS Central 1708 may extract the identity for the user 1716 in host realm 1702 and in the target realm 1704 from this map.

CIOS Central 1708 in the host realm may perform an AuthZ check in which CIOS Central 1708 extracts the host realm identity (a user principal for user 1716 in host realm 1702) from the realm to identity map and determines whether the host realm identity is authorized to perform the operation. By way of example, CIOS Central 1708 may perform an AuthZ check to see if the user 1602 (e.g., an operator) is authorized to request a flock release within a given tenancy (e.g., a tenancy associated with service team A) of the host realm 1702.

CIOS Central 1708 may pass the identity of the entity (e.g., user 1716) within the target realm 1704 to CIOS Regional 1712. CIOS Regional 1712 may be configured to perform a second AuthZ check using the identity of the entity within the target realm 1704. In the ongoing example, the AuthZ check may include checking whether the identity of the user 1602 within target realm is authorized to request a flock release within a given tenancy (e.g., an execution target's tenancy associated with service team A) of the target realm 1704.

As a non-limiting example, a user may provide user input that initiates a request (e.g., an approveReleaseInPhase request). Auth Proxy 1706 may provide a map (e.g., map 1200) that identifies the Auth Proxy User Principal for user 1716 in each realm (e.g., host realm 1702, target realm 1704, etc.) and tenancy/compartment identifiers corresponding to each flock in each realm. CIOS Central 1708 may convert the Auth Proxy User Principal in host realm 1702 provided by Auth Proxy 1706 in the map to an IAM User Principal Object for the host realm 1702 (without signature verification claims by the IAM of the host realm). CIOS Central 1708 may request an AuthZ check using the IAM User Principal Object for the resource type “Flock” with the compartmentID that is associated in the map with the Flock and host realm 1702. CIOS

Central 1708 may extract the User Principal for user 1716 and compartmentID corresponding to target realm 1704. CIOS Central 1708 may request that CIOS Regional 1712 perform a cross-realm Auth for the User Principal, to FLOCK_UPDATE and FLOCK_READ in the root compartment associated with the first execution target of a phase. CIOS Regional 1712 in the target realm 1704, may create a User Principal object with the user principal identifier and tenant identifier in the target realm 1704 (without signature verification claims by IAM in the target realm 1704). CIOS Regional 1712 may request from Identity Regional 1714 an AuthZ check in the target realm 1704 for the resource type “Flock” with the tenant ID associated with the first execution target of the phase. If Identity Regional 1714 determines that the requested release is authorized, the release may be executed by CIOS Regional 1712 in target realm 1704.

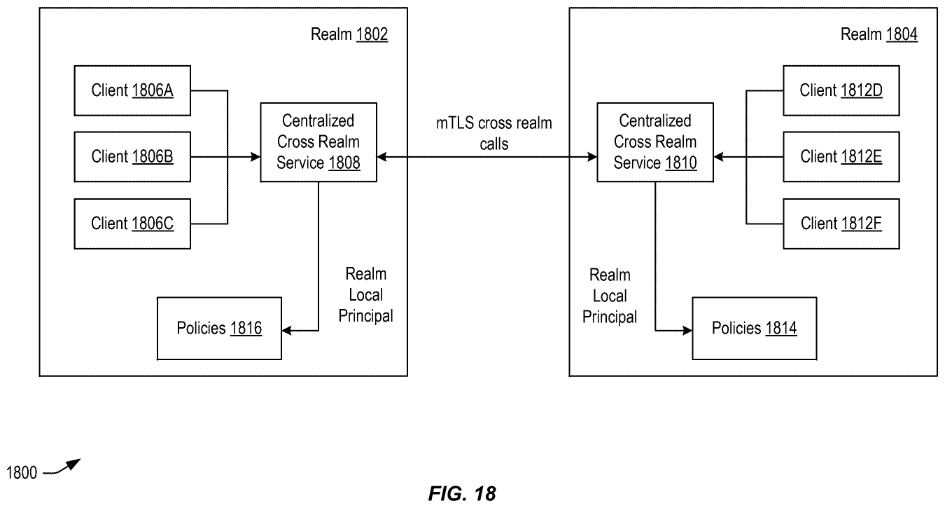

FIG. 18 is a block diagram depicting an example method 1800 for using a Centralized Cross-Realm Service to project identity of entities across identity boundaries (e.g., between two identity realms such as host realm 1802 and target realm 1804), in accordance with at least one embodiment. Host realm 1802 may be an example of realm 802 of FIG. 8. Target realm 1804 may be an example of realm 804 of FIG. 8.

In legacy systems, some service teams used anti-patterns such as moving Identity based principals such as API keys, Service Principals, etc. across realm boundaries and used them to communicate back to their destination realms. Some service teams use mTLS connections to carry out this communication. However, with the growing number of services that need to perform cross-realm communication either to decrease their footprint in destination realms or to remove their dependency on global shared secrets, utilizing a centralized service to perform these types of communications may be beneficial. One advantage of utilizing a centralized cross-realm service may include alleviating service teams from having to copy a global credential that is common across all realms to each connected realm. Having each service team separately set up and maintain a corresponding cross-realm connection (e.g., a corresponding mTLS connection) may duplicate the required development work but may also leave it up to each service team to correctly and securely implement this pattern, as opposed to having a centralized option that could be thoroughly reviewed and vetted. Having service teams maintain such connections increases the risk of user error. A centralized service may: 1) reduce the burden on service teams attempting to perform cross-realm communications, 2) reduce the footprint for service teams that previously maintained their own cross-realm connection but want to communicate with endpoints in the target realm without creating a presence in the target realm, 3) increase security by implementing cross-realm trust centrally rather than having each service team build their own pipeline, and 4) alleviate service teams from having to move a global credential across realms.

To onboard the Centralized Cross-Realm Service (CCRS) solution, client 1806A (associated with a service/service team) may provide an identifier for the endpoint with which communication is requested (e.g., Client 1812D) and a dynamic group and/or resource principal of the calling entity. In some embodiments, identifiers for the dynamic group and/or the resource principal in one or more realms (e.g., realm 1804) may be provided. The service team may write policies 1814 for realm 1804 allowing a CCRS resource principal (e.g., a CCRS resource principal in realm 1804) to perform the tasks required (e.g., to generate resource principals for the calling entity in realm 1804). Clients 1806A, 1806B, and 1806C may represent different services in realm 1802 and clients 1812D, 1812E, and 1812F may represent the respective corresponding service in realm 1804.

CCRS 1808 may create a dedicated compartment for client 1806A. The service team may write one or more policies to AuthZ the dynamic group and/or resource principal against this compartment. CCRS 1808 may be configured to check that the dynamic group and/or resource principal is authorized to contact the remote endpoint (e.g., client 1812D) using policies 1816.

In operation, client 1806A may transmit a request to their local CCRS endpoint (e.g., CCRS 1808) to initiate a cross-realm call. The request may include a realm local principal (e.g., a resource principal), a dynamic group identifier, and an identifier for the endpoint with which communication is requested (e.g., client 1812D). The policies corresponding to client 1806A (e.g., a subset of policies 1816) may be checked against the dedicated compartment for the calling entity's realm local principal, the dynamic group identifier, as well as the endpoint with which communication is requested. In some embodiments, the requestor may include an identifier (e.g., an identifier in a custom claim) and/or map (e.g., map 1200 of FIG. 12) that indicates the identity of the requestor in realm 1804.

If the resource principal/dynamic group is authorized to communicate with the endpoint, the CCRS 1808 may establish trust to its corresponding remote endpoint in the target realm (e.g., CCRS 1810). In some embodiments, trust may be established by establishing an mTLS connection (e.g., a trusted connection that is established based at least in part on mutual authentication during which the endpoints exchange credentials).

There are multiple ways in which CCRS can establish trust between its local (CCRS 1808) and remote endpoints (e.g., CCRS 1810). In some embodiments, service teams may onboard their own certificates for mTLS. This approach may allow service teams to onboard specific certificates that will be used to establish cross-realm trust for their own pipelines. In some embodiments, CCRS 1808 may use the calling dynamic group to obtain this certificate from a vault associated with the service team (not depicted). This approach may include significantly smaller chances of confused deputy as the certificate will be stored in a vault only accessible via an intermediary service with which CCRS 1808 may communicate to obtain the certificate. In this approach, compromise of the central service does not immediately mean a compromise of all the partners onboarded. Additionally, this approach may allow for a more granular level of access control as calling certificates access to downstream endpoints may be restricted.

In some embodiments, trust between endpoints of the mTLS communication established across realms relies on a single certificate. This certificate may belong to the Centralized Cross Realm Service (CCRS). In this trust approach, service teams may provide the endpoint with which they are trying to communicate, without providing a certificate. In some embodiments, both trust approaches may be combined in any suitable manner, potentially involving a central service credential but also unique secrets only known to the service team.

Once the mTLS connection is established, the CCRS 1808 may forward the request provided by the calling entity (e.g., client 1806A) to the remote CCRS endpoint (e.g., CCRS 1810). The remote CCRS endpoint may validate the request for correctness. This can be done by ensuring that the data is only relevant to the calling source realm.

In some embodiments, the remote CCRS (e.g., CCRS 1810) may generate a realm local principal which may be used to communicate with the endpoint (e.g., client 1812D) to cause the endpoint to perform the requested action. In some embodiments, CCRS 1810 generates a Realm Local Principal of a particular resource type and that is specific to the calling entity. By way of example, CCRS 1810 may generate a Resource Principal Token (RPT) within realm 1804 for the calling entity. Although not depicted, CCRS 1810 may exchange the RPT for a Resource Principal Session Token (RPST) issued by an Identity and Access Management (IAM) system of realm 1804 (e.g., an example of IAM system 808 of FIG. 8). In some embodiments, the IAM system in realm 1804 may be configured to trust CCRS 1810 to mint/generate resource principal tokens including a particular resource name/type such that IAM 1008 may forgo authenticating identity claims of the RPT. CCRS 1810 may use the Realm Local Principal to Authorize the operation against a particular endpoint using policies 1814 of realm 1804. All Realm Local Principals may be registered to a Central CCRS tenancy to ensure that CCRS 1810 controls the policies responsible for what the Realm Local Principals can do (e.g., policies 1814). In some embodiments, policies 1814 may be managed by an identity and access management system of realm 1804 (e.g., an example of IAM system 808 of FIG. 8).

Using a Centralized Cross-Realm Service may reduce the risk of a confused deputy. The confused deputy problem occurs when one caller can trick a service to perform actions on a resource that the service has access to, but the original caller may not. This may be addressed by performing authorization calls both at the host realm (e.g., realm 1802) and the target realm (e.g., realm 1804) of the call. When a calling entity tries to make a cross-realm communication call to a particular endpoint, the CCRS may perform an authorization check to see if the calling entity is authorized to access the endpoint (e.g., client 1816D). This may be performed via IAM policies and virtual resources representing these endpoints. In the target realm (e.g., realm 1804), the CCRS 1810 may expect that the calls being received are only from either the certificates of the onboarded service team or a certificate of the corresponding CCRS (e.g., CCRS 1808 of realm 1802). In either scenario, the remote CCRS endpoint (e.g., CCRS 1810) may be configured to know who the original calling entity is and may be able to validate via policies 1814 that the calling entity is authorized to access to a particular endpoint.

In some embodiments, the Realm Local Principal (e.g., the RPST) generated by CCRS 1810 may be returned and forwarded to client 1806A. Client 1806A may utilize the Realm Local Principal to make subsequent calls to CCRS endpoint 1808 or client 1806A may utilize the Realm Local Principal to make public calls to client 1812D. Client 1812D may authorize the requested operations with CCRS 1810 using the Realm Local Principal against policies 1814 (e.g., policies that are managed by CCRS 1810, policies that are managed by the IAM system in Realm 1804 (not depicted)).

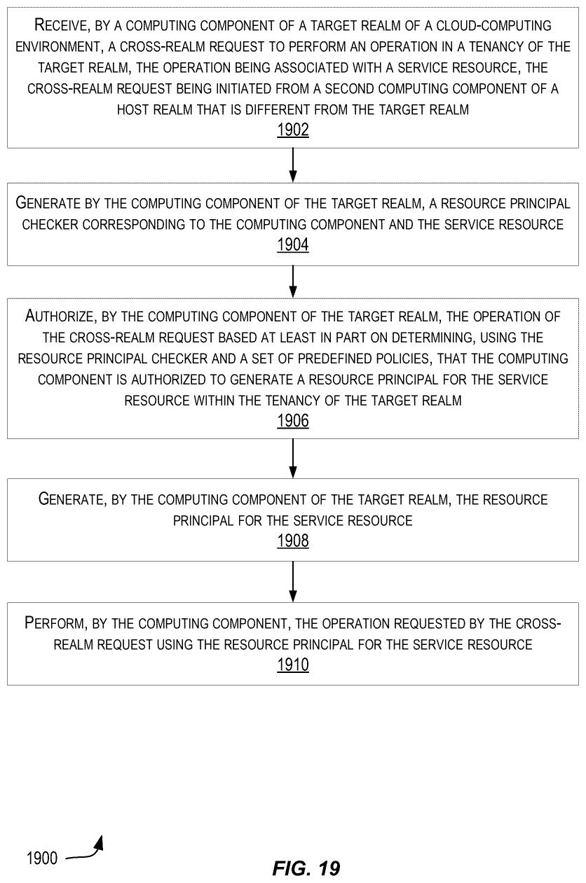

FIG. 19 is a block diagram illustrating an example method 1900 for authorizing a cross-realm call using a resource principal checker, in accordance with at least one embodiment. Method 1900 may be performed using one or more computing components. By way of example, the method 1900 may be performed, at least in part, using any suitable combination of the control plane 1106, orchestrator 1108, data store 1110, CIOS Central 1112, IAM 1114, CIOS Regional 1116, and IAM 1118 of FIG. 11. The operations of method 1900 may be performed in any suitable order. More or few operations than those depicted in FIG. 19 may be included in method 1900.

The method 1900 may begin at 1902, where a cross-realm request to perform an operation in a tenancy of a target realm of a cloud-computing environment may be received by a computing component of the target realm (e.g., CIOS Regional 1116). In some embodiments, the operation may be associated with a service resource. The cross-realm request may be initiated from a second computing component (e.g., CIOS Central 1112) of a host realm (e.g., realm 1102 of FIG. 11) that is different from the target realm (e.g., realm 1104 of FIG. 11). In some embodiments, the computing component is a regional component of an infrastructure and application release service (e.g., a service corresponding to CIOS Central 1112 and CIOS Regional 1116). In some embodiments, the operation of the cross-realm request is associated with performing an infrastructure release or an application release within the tenancy of the target realm. In some embodiments, the tenancy and the service resource are associated with a service. In some embodiments, the cross-realm request may be received (e.g., from a control plane component of the host realm such as control plane 1106) during a data center build that is associated with building a plurality of services in the target realm.

At 1904, a resource principal checker corresponding to the computing component and the service resource may be generated by the computing component of the target realm. In some embodiments, the service resource is 1) a flock configuration file specifying a desired state corresponding to an infrastructure release or application release that is associated with a service, or 2) a Service Plan and Manifest that specifies infrastructure releases and application releases to be performed when building the service.

At 1906, the operation of the cross-realm request may be authorized by the computing component of the target realm (e.g., CIOS Regional 1116) based at least in part on determining, using the resource principal checker and a set of predefined policies, that the computing component is authorized to generate a resource principal for the service resource within the tenancy of the target realm. In some embodiments, authorizing the operation may comprise 1) generating a resource principal token (RPT) corresponding to the service resource, 2) exchanging the RPT for a corresponding resource principal session token (RPST), and 3) determining, using the RPT and the one or more access policies, that the service resource is authorized to manage resources within the tenancy of the target realm.

At 1908, the resource principal for the service resource may be generated by the computing component of the target realm. In some embodiments, generating the resource principal checker may comprise 1) generating a resource principal token (RPT) corresponding to the computing component and the service resource, and 2) exchanging the RPT for a corresponding resource principal session token (RPST) based at least in part on authenticating an identity of the computing component using the RPT. In some embodiments, the resource principal checker comprises the RPST.

At 1910, the operation requested by the cross-realm request may be performed by the computing component using the resource principal for the service resource.

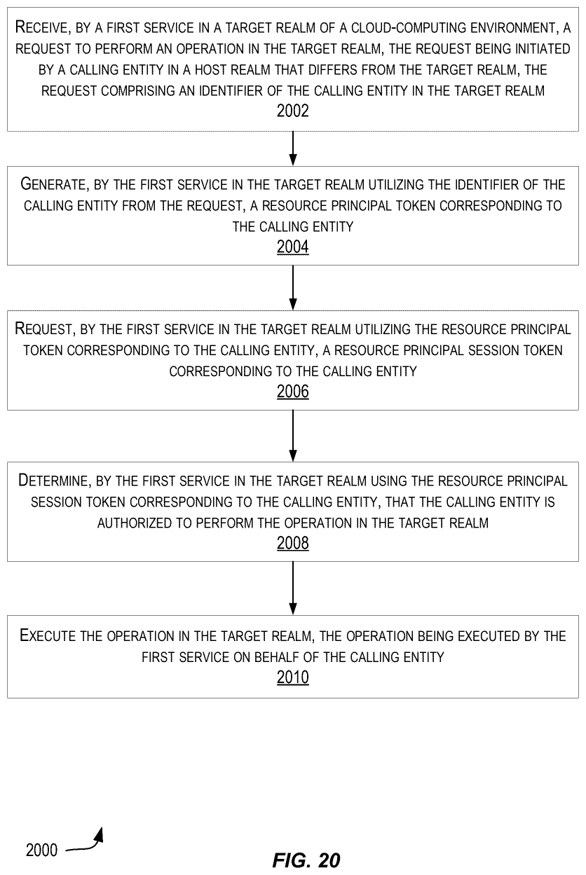

FIG. 20 is a block diagram illustrating an example method 2000 for authorizing a cross-realm call, in accordance with at least one embodiment. Method 2000 may be performed using one or more computing components. By way of example, the method 2000 may be performed, at least in part, using any suitable combination of Service A₁, Service B_{N}, Identity_{N}, and/or Service C₁ of FIG. 14 or 15. The operations of method 2000 may be performed in any suitable order. More or few operations than those depicted in FIG. 20 may be included in method 2000.

The method 2000 may begin at 2002, where a request to perform an operation in a target realm of a cloud-computing environment may be received by a first service (e.g., service B_{N} of FIGS. 14 and 15) in the target realm. In some embodiments, the request may be initiated by a calling entity (e.g., Service A₁ of FIG. 14, Service C₁ of FIG. 15, SPAM X:1.0.1, an example of SPAM 700 of FIG. 7) in a host realm (e.g., realm 1404 of FIG. 14, realm 1504 of FIG. 15, etc.) that differs from the target realm (e.g., realm 1402 of FIG. 14, realm 1502 of FIG. 15, etc.). In some embodiments, the request comprises an identifier for the calling entity within the target realm. In some embodiments, the identifier is provided in a map (an example of map 1200 of FIG. 12) or a header of the request. In some embodiments, the request is transmitted to the first service by a second service of the host realm (e.g., Service A₁ of FIG. 15, where the second service is different from the calling entity that initiated the request. In some embodiments, the second service overwrites a field of an authentication header of the request with the identifier for the calling entity in the target realm. In some embodiments, the second service selects the identifier for the calling entity from a plurality of identifiers associated with the calling entity and corresponding to a plurality of corresponding realms that comprises the target realm. The plurality of identifiers associated with the calling entity may be provided to the second service in the host realm (e.g., by Service C₁ of FIG. 15).

At 2004, a resource principal token corresponding to the calling entity may be generated by the first service (e.g., Service B_{N}) in the target realm utilizing the identifier of the calling entity from the request. In some embodiments, the resource principal token generated by the first service and corresponding to the calling entity (e.g., Service A₁ of FIG. 14) comprises a custom claim that includes the identifier for the calling entity in the target realm (e.g., the identifier for the calling entity obtained from a map included in the request).

At 2006, a resource principal session token corresponding to the calling entity may be requested by the first service in the target realm utilizing the resource principal token corresponding to the calling entity.

At 2008, the first service in the target realm may determine, using the resource principal session token corresponding to the calling entity, that the calling entity is authorized to perform the operation in the target realm. In some embodiments, determining that the calling entity is authorized to perform the operation comprises 1) transmitting the resource principal token corresponding to the calling entity to an identity access management service of the target realm, and 2) receiving the resource principal session token from the identity access management service of the target realm.

At 2010, the operation may be executed by the first service on behalf of the calling entity.

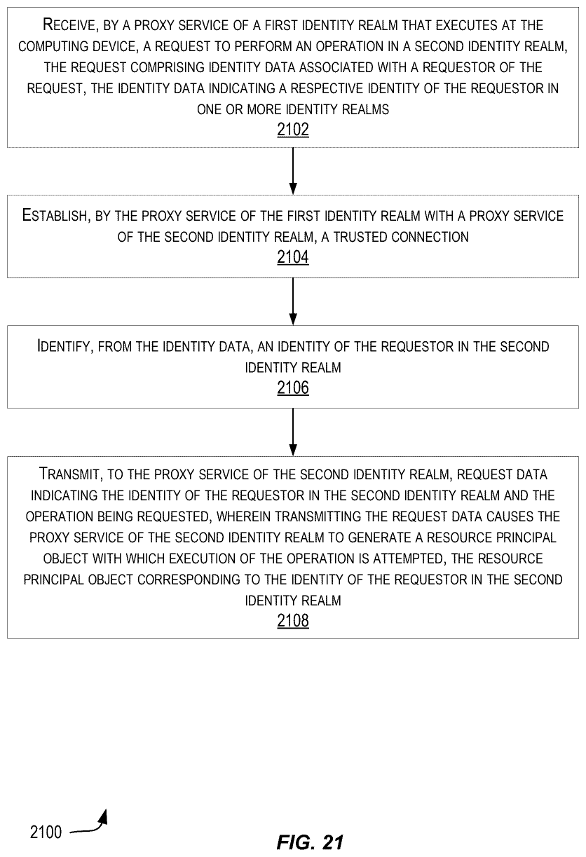

FIG. 21 is a block diagram illustrating an example method 2100 for utilizing a proxy service for cross-realm communications, in accordance with at least one embodiment. Method 2100 may be performed using one or more computing components. By way of example, the method 2100 may be performed, at least in part, using any suitable combination of Service A₁ of FIGS. 14 and 15, Service B_{N} of FIGS. 14 and 15, the Centralized Cross-Realm Service (CCRS) 1808 of FIG. 18, and/or the Centralized Cross-Realm Service (CCRS) 1810 of FIG. 18. The operations of method 2100 may be performed in any suitable order. More or few operations than those depicted in FIG. 21 may be included in method 2100.

Method 2100 may begin at 2102, where a request to perform an operation in a second identity realm may be received by a proxy service of a first identity realm (e.g., CCRS 1808). In some embodiments, the request comprises identity data associated with a requestor of the request. The identity data may indicate a respective identity of the requestor in one or more identity realms. By way of example, the identity data may be provided in the request as a map or a custom claim (e.g., a map or claim provided in a header of the request, the header being an auth header or an additional header that differs from the auth header of the request).

At 2104, a trusted connection may be established by the proxy service of the first identity realm (e.g., CCRS 1808) with a proxy service of the second identity realm (e.g., CCRS 1810). In some embodiments, the proxy service of the first identity realm and the proxy service of the second identity realm are associated with a centralized cross-realm service. The trusted connection may be established based at least in part on mutual authentication of the proxy service of the first identity realm and the proxy service of the second identity realm. In some embodiments, the mutual authentication may be performed based at least in part on a first credential that is associated with the centralized cross-realm service or a second credential that is provided by the requestor.

At 2106, an identity of the requestor in the second identity realm may be identified from the identity data by the proxy service of the first identity realm. By way of example, the identity of the requestor in the second identity realm may be identified from a map or custom claim provided in the request.

At 2106, request data indicating the identity of the requestor in the second identity realm and the operation being requested may be transmitting by the proxy service of the first identity realm to the proxy service of the second identity realm. In some embodiments, transmitting the request data causes the proxy service of the second identity realm (e.g., CCRS 1810) to generate a resource principal object with which execution of the operation is attempted. The resource principal object may be a resource principal token (RPT) or a resource principal session token (RPST) signed by a credential/private key associated with the CCRS 1810 and validated using the credential/public key corresponding to the private key). In some embodiments, the resource principal object corresponds to the identity of the requestor in the second identity realm. In some embodiments, the proxy service of the second identity realm provides the resource principal object to a second service of the second identity realm and the second service of the second identity realm authorizes the execution of the operation using the resource principal object generated by the proxy service in the second identity realm.

Although not depicted in FIG. 21, the method 2100 may further comprise receiving, by the proxy service of the first identity realm, the resource principal object generated by the proxy service of the second identity realm, and providing, by the proxy service of the first identity realm to the requestor, the resource principal object generated by the proxy service of the second identity realm. In some embodiments, providing the requestor with the resource principal object configures the requestor to perform subsequent operations with the second service of the second identity realm via an additional trusted connection between the requestor and the second service of the second identity realm.

### Example Cloud Service Infrastructure Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 22 is a block diagram 2200 illustrating an example pattern of an IaaS architecture, according to at least one embodiment. Service operators 2202 can be communicatively coupled to a secure host tenancy 2204 that can include a virtual cloud network (VCN) 2206 and a secure host subnet 2208. In some examples, the service operators 2202 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 2206 and/or the Internet.

The VCN 2206 can include a local peering gateway (LPG) 2210 that can be communicatively coupled to a secure shell (SSH) VCN 2212 via an LPG 2210 contained in the SSH VCN 2212. The SSH VCN 2212 can include an SSH subnet 2214, and the SSH VCN 2212 can be communicatively coupled to a control plane VCN 2216 via the LPG 2210 contained in the control plane VCN 2216. Also, the SSH VCN 2212 can be communicatively coupled to a data plane VCN 2218 via an LPG 2210. The control plane VCN 2216 and the data plane VCN 2218 can be contained in a service tenancy 2219 that can be owned and/or operated by the IaaS provider.

The control plane VCN 2216 can include a control plane demilitarized zone (DMZ) tier 2220 that acts as a perimeter network (e.g., portions of a corporate network between the corporate intranet and external networks). The DMZ-based servers may have restricted responsibilities and help keep breaches contained. Additionally, the DMZ tier 2220 can include one or more load balancer (LB) subnet(s) 2222, a control plane app tier 2224 that can include app subnet(s) 2226, a control plane data tier 2228 that can include database (DB) subnet(s) 2230 (e.g., frontend DB subnet(s) and/or backend DB subnet(s)). The LB subnet(s) 2222 contained in the control plane DMZ tier 2220 can be communicatively coupled to the app subnet(s) 2226 contained in the control plane app tier 2224 and an Internet gateway 2234 that can be contained in the control plane VCN 2216, and the app subnet(s) 2226 can be communicatively coupled to the DB subnet(s) 2230 contained in the control plane data tier 2228 and a service gateway 2236 and a network address translation (NAT) gateway 2238. The control plane VCN 2216 can include the service gateway 2236 and the NAT gateway 2238.

The control plane VCN 2216 can include a data plane mirror app tier 2240 that can include app subnet(s) 2226. The app subnet(s) 2226 contained in the data plane mirror app tier 2240 can include a virtual network interface controller (VNIC) 2242 that can execute a compute instance 2244. The compute instance 2244 can communicatively couple the app subnet(s) 2226 of the data plane mirror app tier 2240 to app subnet(s) 2226 that can be contained in a data plane app tier 2246.

The data plane VCN 2218 can include the data plane app tier 2246, a data plane DMZ tier 2248, and a data plane data tier 2250. The data plane DMZ tier 2248 can include LB subnet(s) 2222 that can be communicatively coupled to the app subnet(s) 2226 of the data plane app tier 2246 and the Internet gateway 2234 of the data plane VCN 2218. The app subnet(s) 2226 can be communicatively coupled to the service gateway 2236 of the data plane VCN 2218 and the NAT gateway 2238 of the data plane VCN 2218. The data plane data tier 2250 can also include the DB subnet(s) 2230 that can be communicatively coupled to the app subnet(s) 2226 of the data plane app tier 2246.

The Internet gateway 2234 of the control plane VCN 2216 and of the data plane VCN 2218 can be communicatively coupled to a metadata management service 2252 that can be communicatively coupled to public Internet 2254. Public Internet 2254 can be communicatively coupled to the NAT gateway 2238 of the control plane VCN 2216 and of the data plane VCN 2218. The service gateway 2236 of the control plane VCN 2216 and of the data plane VCN 2218 can be communicatively coupled to cloud services 2256.

In some examples, the service gateway 2236 of the control plane VCN 2216 or of the data plane VCN 2218 can make application programming interface (API) calls to cloud services 2256 without going through public Internet 2254. The API calls to cloud services 2256 from the service gateway 2236 can be one-way: the service gateway 2236 can make API calls to cloud services 2256, and cloud services 2256 can send requested data to the service gateway 2236. But, cloud services 2256 may not initiate API calls to the service gateway 2236.

In some examples, the secure host tenancy 2204 can be directly connected to the service tenancy 2219, which may be otherwise isolated. The secure host subnet 2208 can communicate with the SSH subnet 2214 through an LPG 2210 that may enable two-way communication over an otherwise isolated system. Connecting the secure host subnet 2208 to the SSH subnet 2214 may give the secure host subnet 2208 access to other entities within the service tenancy 2219.

The control plane VCN 2216 may allow users of the service tenancy 2219 to set up or otherwise provision desired resources. Desired resources provisioned in the control plane VCN 2216 may be deployed or otherwise used in the data plane VCN 2218. In some examples, the control plane VCN 2216 can be isolated from the data plane VCN 2218, and the data plane mirror app tier 2240 of the control plane VCN 2216 can communicate with the data plane app tier 2246 of the data plane VCN 2218 via VNICs 2242 that can be contained in the data plane mirror app tier 2240 and the data plane app tier 2246.

In some examples, users of the system, or customers, can make requests, for example create, read, update, or delete (CRUD) operations, through public Internet 2254 that can communicate the requests to the metadata management service 2252. The metadata management service 2252 can communicate the request to the control plane VCN 2216 through the Internet gateway 2234. The request can be received by the LB subnet(s) 2222 contained in the control plane DMZ tier 2220. The LB subnet(s) 2222 may determine that the request is valid, and in response to this determination, the LB subnet(s) 2222 can transmit the request to app subnet(s) 2226 contained in the control plane app tier 2224. If the request is validated and requires a call to public Internet 2254, the call to public Internet 2254 may be transmitted to the NAT gateway 2238 that can make the call to public Internet 2254. Metadata that may be desired to be stored by the request can be stored in the DB subnet(s) 2230.

In some examples, the data plane mirror app tier 2240 can facilitate direct communication between the control plane VCN 2216 and the data plane VCN 2218. For example, changes, updates, or other suitable modifications to configuration may be desired to be applied to the resources contained in the data plane VCN 2218. Via a VNIC 2242, the control plane VCN 2216 can directly communicate with, and can thereby execute the changes, updates, or other suitable modifications to configuration to, resources contained in the data plane VCN 2218.

In some embodiments, the control plane VCN 2216 and the data plane VCN 2218 can be contained in the service tenancy 2219. In this case, the user, or the customer, of the system may not own or operate either the control plane VCN 2216 or the data plane VCN 2218. Instead, the IaaS provider may own or operate the control plane VCN 2216 and the data plane VCN 2218, both of which may be contained in the service tenancy 2219. This embodiment can enable isolation of networks that may prevent users or customers from interacting with other users', or other customers', resources. Also, this embodiment may allow users or customers of the system to store databases privately without needing to rely on public Internet 2254, which may not have a desired level of threat prevention, for storage.

In other embodiments, the LB subnet(s) 2222 contained in the control plane VCN 2216 can be configured to receive a signal from the service gateway 2236. In this embodiment, the control plane VCN 2216 and the data plane VCN 2218 may be configured to be called by a customer of the IaaS provider without calling public Internet 2254. Customers of the IaaS provider may desire this embodiment since database(s) that the customers use may be controlled by the IaaS provider and may be stored on the service tenancy 2219, which may be isolated from public Internet 2254.

FIG. 23 is a block diagram 2300 illustrating another example pattern of an IaaS architecture, according to at least one embodiment. Service operators 2302 (e.g., service operators 2202 of FIG. 22) can be communicatively coupled to a secure host tenancy 2304 (e.g., the secure host tenancy 2204 of FIG. 22) that can include a virtual cloud network (VCN) 2306 (e.g., the VCN 2206 of FIG. 22) and a secure host subnet 2308 (e.g., the secure host subnet 2208 of FIG. 22). The VCN 2306 can include a local peering gateway (LPG) 2310 (e.g., the LPG 2210 of FIG. 22) that can be communicatively coupled to a secure shell (SSH) VCN 2312 (e.g., the SSH VCN 2212 of FIG. 22) via an LPG 2210 contained in the SSH VCN 2312. The SSH VCN 2312 can include an SSH subnet 2314 (e.g., the SSH subnet 2214 of FIG. 22), and the SSH VCN 2312 can be communicatively coupled to a control plane VCN 2316 (e.g., the control plane VCN 2216 of FIG. 22) via an LPG 2310 contained in the control plane VCN 2316. The control plane VCN 2316 can be contained in a service tenancy 2319 (e.g., the service tenancy 2219 of FIG. 22), and the data plane VCN 2318 (e.g., the data plane VCN 2218 of FIG. 22) can be contained in a customer tenancy 2321 that may be owned or operated by users, or customers, of the system.

The control plane VCN 2316 can include a control plane DMZ tier 2320 (e.g., the control plane DMZ tier 2220 of FIG. 22) that can include LB subnet(s) 2322 (e.g., LB subnet(s) 2222 of FIG. 22), a control plane app tier 2324 (e.g., the control plane app tier 2224 of FIG. 22) that can include app subnet(s) 2326 (e.g., app subnet(s) 2226 of FIG. 22), a control plane data tier 2328 (e.g., the control plane data tier 2228 of FIG. 22) that can include database (DB) subnet(s) 2330 (e.g., similar to DB subnet(s) 2230 of FIG. 22). The LB subnet(s) 2322 contained in the control plane DMZ tier 2320 can be communicatively coupled to the app subnet(s) 2326 contained in the control plane app tier 2324 and an Internet gateway 2334 (e.g., the Internet gateway 2234 of FIG. 22) that can be contained in the control plane VCN 2316, and the app subnet(s) 2326 can be communicatively coupled to the DB subnet(s) 2330 contained in the control plane data tier 2328 and a service gateway 2336 (e.g., the service gateway 2236 of FIG. 22) and a network address translation (NAT) gateway 2338 (e.g., the NAT gateway 2238 of FIG. 22). The control plane VCN 2316 can include the service gateway 2336 and the NAT gateway 2338.

The control plane VCN 2316 can include a data plane mirror app tier 2340 (e.g., the data plane mirror app tier 2240 of FIG. 22) that can include app subnet(s) 2326. The app subnet(s) 2326 contained in the data plane mirror app tier 2340 can include a virtual network interface controller (VNIC) 2342 (e.g., the VNIC of 2242) that can execute a compute instance 2344 (e.g., similar to the compute instance 2244 of FIG. 22). The compute instance 2344 can facilitate communication between the app subnet(s) 2326 of the data plane mirror app tier 2340 and the app subnet(s) 2326 that can be contained in a data plane app tier 2346 (e.g., the data plane app tier 2246 of FIG. 22) via the VNIC 2342 contained in the data plane mirror app tier 2340 and the VNIC 2342 contained in the data plane app tier 2346.

The Internet gateway 2334 contained in the control plane VCN 2316 can be communicatively coupled to a metadata management service 2352 (e.g., the metadata management service 2252 of FIG. 22) that can be communicatively coupled to public Internet 2354 (e.g., public Internet 2254 of FIG. 22). Public Internet 2354 can be communicatively coupled to the NAT gateway 2338 contained in the control plane VCN 2316. The service gateway 2336 contained in the control plane VCN 2316 can be communicatively coupled to cloud services 2356 (e.g., cloud services 2256 of FIG. 22).

In some examples, the data plane VCN 2318 can be contained in the customer tenancy 2321. In this case, the IaaS provider may provide the control plane VCN 2316 for each customer, and the IaaS provider may, for each customer, set up a unique compute instance 2344 that is contained in the service tenancy 2319. Each compute instance 2344 may allow communication between the control plane VCN 2316, contained in the service tenancy 2319, and the data plane VCN 2318 that is contained in the customer tenancy 2321. The compute instance 2344 may allow resources, that are provisioned in the control plane VCN 2316 that is contained in the service tenancy 2319, to be deployed or otherwise used in the data plane VCN 2318 that is contained in the customer tenancy 2321.

In other examples, the customer of the IaaS provider may have databases that live in the customer tenancy 2321. In this example, the control plane VCN 2316 can include the data plane mirror app tier 2340 that can include app subnet(s) 2326. The data plane mirror app tier 2340 can reside in the data plane VCN 2318, but the data plane mirror app tier 2340 may not live in the data plane VCN 2318. That is, the data plane mirror app tier 2340 may have access to the customer tenancy 2321, but the data plane mirror app tier 2340 may not exist in the data plane VCN 2318 or be owned or operated by the customer of the IaaS provider. The data plane mirror app tier 2340 may be configured to make calls to the data plane VCN 2318 but may not be configured to make calls to any entity contained in the control plane VCN 2316. The customer may desire to deploy or otherwise use resources in the data plane VCN 2318 that are provisioned in the control plane VCN 2316, and the data plane mirror app tier 2340 can facilitate the desired deployment, or other usage of resources, of the customer.

In some embodiments, the customer of the IaaS provider can apply filters to the data plane VCN 2318. In this embodiment, the customer can determine what the data plane VCN 2318 can access, and the customer may restrict access to public Internet 2354 from the data plane VCN 2318. The IaaS provider may not be able to apply filters or otherwise control access of the data plane VCN 2318 to any outside networks or databases. Applying filters and controls by the customer onto the data plane VCN 2318, contained in the customer tenancy 2321, can help isolate the data plane VCN 2318 from other customers and from public Internet 2354.

In some embodiments, cloud services 2356 can be called by the service gateway 2336 to access services that may not exist on public Internet 2354, on the control plane VCN 2316, or on the data plane VCN 2318. The connection between cloud services 2356 and the control plane VCN 2316 or the data plane VCN 2318 may not be live or continuous. Cloud services 2356 may exist on a different network owned or operated by the IaaS provider. Cloud services 2356 may be configured to receive calls from the service gateway 2336 and may be configured to not receive calls from public Internet 2354. Some cloud services 2356 may be isolated from other cloud services 2356, and the control plane VCN 2316 may be isolated from cloud services 2356 that may not be in the same region as the control plane VCN 2316. For example, the control plane VCN 2316 may be located in “Region 1,” and cloud service “Deployment 22,” may be located in Region 1 and in “Region 2.” If a call to Deployment 22 is made by the service gateway 2336 contained in the control plane VCN 2316 located in Region 1, the call may be transmitted to Deployment 22 in Region 1. In this example, the control plane VCN 2316, or Deployment 22 in Region 1, may not be communicatively coupled to, or otherwise in communication with, Deployment 22 in Region 2.

FIG. 24 is a block diagram 2400 illustrating another example pattern of an IaaS architecture, according to at least one embodiment. Service operators 2402 (e.g., service operators 2202 of FIG. 22) can be communicatively coupled to a secure host tenancy 2404 (e.g., the secure host tenancy 2204 of FIG. 22) that can include a virtual cloud network (VCN) 2406 (e.g., the VCN 2206 of FIG. 22) and a secure host subnet 2408 (e.g., the secure host subnet 2208 of FIG. 22). The VCN 2406 can include an LPG 2410 (e.g., the LPG 2210 of FIG. 22) that can be communicatively coupled to an SSH VCN 2412 (e.g., the SSH VCN 2212 of FIG. 22) via an LPG 2410 contained in the SSH VCN 2412. The SSH VCN 2412 can include an SSH subnet 2414 (e.g., the SSH subnet 2214 of FIG. 22), and the SSH VCN 2412 can be communicatively coupled to a control plane VCN 2416 (e.g., the control plane VCN 2216 of FIG. 22) via an LPG 2410 contained in the control plane VCN 2416 and to a data plane VCN 2418 (e.g., the data plane 2218 of FIG. 22) via an LPG 2410 contained in the data plane VCN 2418. The control plane VCN 2416 and the data plane VCN 2418 can be contained in a service tenancy 2419 (e.g., the service tenancy 2219 of FIG. 22).

The control plane VCN 2416 can include a control plane DMZ tier 2420 (e.g., the control plane DMZ tier 2220 of FIG. 22) that can include load balancer (LB) subnet(s) 2422 (e.g., LB subnet(s) 2222 of FIG. 22), a control plane app tier 2424 (e.g., the control plane app tier 2224 of FIG. 22) that can include app subnet(s) 2426 (e.g., similar to app subnet(s) 2226 of FIG. 22), a control plane data tier 2428 (e.g., the control plane data tier 2228 of FIG. 22) that can include DB subnet(s) 2430. The LB subnet(s) 2422 contained in the control plane DMZ tier 2420 can be communicatively coupled to the app subnet(s) 2426 contained in the control plane app tier 2424 and to an Internet gateway 2434 (e.g., the Internet gateway 2234 of FIG. 22) that can be contained in the control plane VCN 2416, and the app subnet(s) 2426 can be communicatively coupled to the DB subnet(s) 2430 contained in the control plane data tier 2428 and to a service gateway 2436 (e.g., the service gateway of FIG. 22) and a network address translation (NAT) gateway 2438 (e.g., the NAT gateway 2238 of FIG. 22). The control plane VCN 2416 can include the service gateway 2436 and the NAT gateway 2438.

The data plane VCN 2418 can include a data plane app tier 2446 (e.g., the data plane app tier 2246 of FIG. 22), a data plane DMZ tier 2448 (e.g., the data plane DMZ tier 2248 of FIG. 22), and a data plane data tier 2450 (e.g., the data plane data tier 2250 of FIG. 22). The data plane DMZ tier 2448 can include LB subnet(s) 2422 that can be communicatively coupled to trusted app subnet(s) 2460 and untrusted app subnet(s) 2462 of the data plane app tier 2446 and the Internet gateway 2434 contained in the data plane VCN 2418. The trusted app subnet(s) 2460 can be communicatively coupled to the service gateway 2436 contained in the data plane VCN 2418, the NAT gateway 2438 contained in the data plane VCN 2418, and DB subnet(s) 2430 contained in the data plane data tier 2450. The untrusted app subnet(s) 2462 can be communicatively coupled to the service gateway 2436 contained in the data plane VCN 2418 and DB subnet(s) 2430 contained in the data plane data tier 2450. The data plane data tier 2450 can include DB subnet(s) 2430 that can be communicatively coupled to the service gateway 2436 contained in the data plane VCN 2418.

The untrusted app subnet(s) 2462 can include one or more primary VNICs 2464(1)-(N) that can be communicatively coupled to tenant virtual machines (VMs) 2466(1)-(N). Each tenant VM 2466(1)-(N) can be communicatively coupled to a respective app subnet 2467(1)-(N) that can be contained in respective container egress VCNs 2468(1)-(N) that can be contained in respective customer tenancies 2470(1)-(N). Respective secondary VNICs 2472(1)-(N) can facilitate communication between the untrusted app subnet(s) 2462 contained in the data plane VCN 2418 and the app subnet contained in the container egress VCNs 2468(1)-(N). Each container egress VCNs 2468(1)-(N) can include a NAT gateway 2438 that can be communicatively coupled to public Internet 2454 (e.g., public Internet 2254 of FIG. 22).

The Internet gateway 2434 contained in the control plane VCN 2416 and contained in the data plane VCN 2418 can be communicatively coupled to a metadata management service 2452 (e.g., the metadata management system 2252 of FIG. 22) that can be communicatively coupled to public Internet 2454. Public Internet 2454 can be communicatively coupled to the NAT gateway 2438 contained in the control plane VCN 2416 and contained in the data plane VCN 2418. The service gateway 2436 contained in the control plane VCN 2416 and contained in the data plane VCN 2418 can be communicatively coupled to cloud services 2456.

In some embodiments, the data plane VCN 2418 can be integrated with customer tenancies 2470. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 2446. Code to run the function may be executed in the VMs 2466(1)-(N), and the code may not be configured to run anywhere else on the data plane VCN 2418. Each VM 2466(1)-(N) may be connected to one customer tenancy 2470. Respective containers 2471(1)-(N) contained in the VMs 2466(1)-(N) may be configured to run the code. In this case, there can be a dual isolation (e.g., the containers 2471(1)-(N) running code, where the containers 2471(1)-(N) may be contained in at least the VM 2466(1)-(N) that are contained in the untrusted app subnet(s) 2462), which may help prevent incorrect or otherwise undesirable code from damaging the network of the IaaS provider or from damaging a network of a different customer. The containers 2471(1)-(N) may be communicatively coupled to the customer tenancy 2470 and may be configured to transmit or receive data from the customer tenancy 2470. The containers 2471(1)-(N) may not be configured to transmit or receive data from any other entity in the data plane VCN 2418. Upon completion of running the code, the IaaS provider may kill or otherwise dispose of the containers 2471(1)-(N).

In some embodiments, the trusted app subnet(s) 2460 may run code that may be owned or operated by the IaaS provider. In this embodiment, the trusted app subnet(s) 2460 may be communicatively coupled to the DB subnet(s) 2430 and be configured to execute CRUD operations in the DB subnet(s) 2430. The untrusted app subnet(s) 2462 may be communicatively coupled to the DB subnet(s) 2430, but in this embodiment, the untrusted app subnet(s) may be configured to execute read operations in the DB subnet(s) 2430. The containers 2471(1)-(N) that can be contained in the VM 2466(1)-(N) of each customer and that may run code from the customer may not be communicatively coupled with the DB subnet(s) 2430.

In other embodiments, the control plane VCN 2416 and the data plane VCN 2418 may not be directly communicatively coupled. In this embodiment, there may be no direct communication between the control plane VCN 2416 and the data plane VCN 2418. However, communication can occur indirectly through at least one method. An LPG 2410 may be established by the IaaS provider that can facilitate communication between the control plane VCN 2416 and the data plane VCN 2418. In another example, the control plane VCN 2416 or the data plane VCN 2418 can make a call to cloud services 2456 via the service gateway 2436. For example, a call to cloud services 2456 from the control plane VCN 2416 can include a request for a service that can communicate with the data plane VCN 2418.

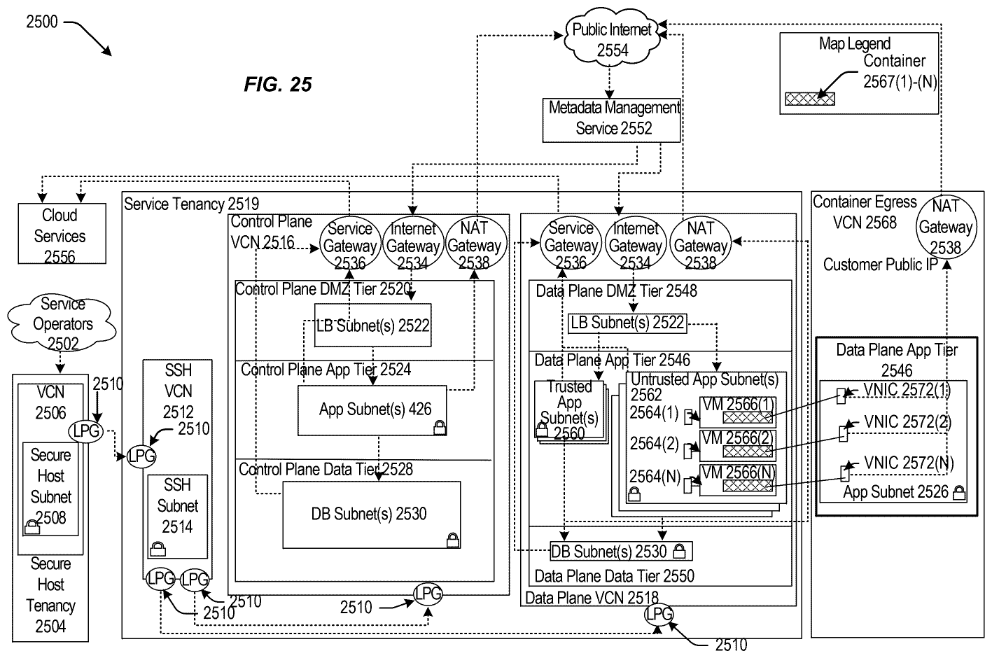

FIG. 25 is a block diagram 2500 illustrating another example pattern of an IaaS architecture, according to at least one embodiment. Service operators 2502 (e.g., service operators 2202 of FIG. 22) can be communicatively coupled to a secure host tenancy 2504 (e.g., the secure host tenancy 2204 of FIG. 22) that can include a virtual cloud network (VCN) 2506 (e.g., the VCN 2206 of FIG. 22) and a secure host subnet 2508 (e.g., the secure host subnet 2208 of FIG. 22). The VCN 2506 can include an LPG 2510 (e.g., the LPG 2210 of FIG. 22) that can be communicatively coupled to an SSH VCN 2512 (e.g., the SSH VCN 2212 of FIG. 22) via an LPG 2510 contained in the SSH VCN 2512. The SSH VCN 2512 can include an SSH subnet 2514 (e.g., the SSH subnet 2214 of FIG. 22), and the SSH VCN 2512 can be communicatively coupled to a control plane VCN 2516 (e.g., the control plane VCN 2216 of FIG. 22) via an LPG 2510 contained in the control plane VCN 2516 and to a data plane VCN 2518 (e.g., the data plane 2218 of FIG. 22) via an LPG 2510 contained in the data plane VCN 2518. The control plane VCN 2516 and the data plane VCN 2518 can be contained in a service tenancy 2519 (e.g., the service tenancy 2219 of FIG. 22).

The control plane VCN 2516 can include a control plane DMZ tier 2520 (e.g., the control plane DMZ tier 2220 of FIG. 22) that can include LB subnet(s) 2522 (e.g., LB subnet(s) 2222 of FIG. 22), a control plane app tier 2524 (e.g., the control plane app tier 2224 of FIG. 22) that can include app subnet(s) 2526 (e.g., app subnet(s) 2226 of FIG. 22), a control plane data tier 2528 (e.g., the control plane data tier 2228 of FIG. 22) that can include DB subnet(s) 2530 (e.g., DB subnet(s) 2430 of FIG. 24). The LB subnet(s) 2522 contained in the control plane DMZ tier 2520 can be communicatively coupled to the app subnet(s) 2526 contained in the control plane app tier 2524 and to an Internet gateway 2534 (e.g., the Internet gateway 2234 of FIG. 22) that can be contained in the control plane VCN 2516, and the app subnet(s) 2526 can be communicatively coupled to the DB subnet(s) 2530 contained in the control plane data tier 2528 and to a service gateway 2536 (e.g., the service gateway of FIG. 22) and a network address translation (NAT) gateway 2538 (e.g., the NAT gateway 2238 of FIG. 22). The control plane VCN 2516 can include the service gateway 2536 and the NAT gateway 2538.

The data plane VCN 2518 can include a data plane app tier 2546 (e.g., the data plane app tier 2246 of FIG. 22), a data plane DMZ tier 2548 (e.g., the data plane DMZ tier 2248 of FIG. 22), and a data plane data tier 2550 (e.g., the data plane data tier 2250 of FIG. 22). The data plane DMZ tier 2548 can include LB subnet(s) 2522 that can be communicatively coupled to trusted app subnet(s) 2560 (e.g., trusted app subnet(s) 2460 of FIG. 24) and untrusted app subnet(s) 2562 (e.g., untrusted app subnet(s) 2462 of FIG. 24) of the data plane app tier 2546 and the Internet gateway 2534 contained in the data plane VCN 2518. The trusted app subnet(s) 2560 can be communicatively coupled to the service gateway 2536 contained in the data plane VCN 2518, the NAT gateway 2538 contained in the data plane VCN 2518, and DB subnet(s) 2530 contained in the data plane data tier 2550. The untrusted app subnet(s) 2562 can be communicatively coupled to the service gateway 2536 contained in the data plane VCN 2518 and DB subnet(s) 2530 contained in the data plane data tier 2550. The data plane data tier 2550 can include DB subnet(s) 2530 that can be communicatively coupled to the service gateway 2536 contained in the data plane VCN 2518.

The untrusted app subnet(s) 2562 can include primary VNICs 2564(1)-(N) that can be communicatively coupled to tenant virtual machines (VMs) 2566(1)-(N) residing within the untrusted app subnet(s) 2562. Each tenant VM 2566(1)-(N) can run code in a respective container 2567(1)-(N), and be communicatively coupled to an app subnet 2526 that can be contained in a data plane app tier 2546 that can be contained in a container egress VCN 2568.

Respective secondary VNICs 2572(1)-(N) can facilitate communication between the untrusted app subnet(s) 2562 contained in the data plane VCN 2518 and the app subnet contained in the container egress VCN 2568. The container egress VCN can include a NAT gateway 2538 that can be communicatively coupled to public Internet 2554 (e.g., public Internet 2254 of FIG. 22).

The Internet gateway 2534 contained in the control plane VCN 2516 and contained in the data plane VCN 2518 can be communicatively coupled to a metadata management service 2552 (e.g., the metadata management system 2252 of FIG. 22) that can be communicatively coupled to public Internet 2554. Public Internet 2554 can be communicatively coupled to the NAT gateway 2538 contained in the control plane VCN 2516 and contained in the data plane VCN 2518. The service gateway 2536 contained in the control plane VCN 2516 and contained in the data plane VCN 2518 can be communicatively coupled to cloud services 2556.

In some examples, the pattern illustrated by the architecture of block diagram 2500 of FIG. 25 may be considered an exception to the pattern illustrated by the architecture of block diagram 2400 of FIG. 24 and may be desirable for a customer of the IaaS provider if the IaaS provider cannot directly communicate with the customer (e.g., a disconnected region). The respective containers 2567(1)-(N) that are contained in the VMs 2566(1)-(N) for each customer can be accessed in real-time by the customer. The containers 2567(1)-(N) may be configured to make calls to respective secondary VNICs 2572(1)-(N) contained in app subnet(s) 2526 of the data plane app tier 2546 that can be contained in the container egress VCN 2568. The secondary VNICs 2572(1)-(N) can transmit the calls to the NAT gateway 2538 that may transmit the calls to public Internet 2554. In this example, the containers 2567(1)-(N) that can be accessed in real-time by the customer can be isolated from the control plane VCN 2516 and can be isolated from other entities contained in the data plane VCN 2518. The containers 2567(1)-(N) may also be isolated from resources from other customers.

In other examples, the customer can use the containers 2567(1)-(N) to call cloud services 2556. In this example, the customer may run code in the containers 2567(1)-(N) that requests a service from cloud services 2556. The containers 2567(1)-(N) can transmit this request to the secondary VNICs 2572(1)-(N) that can transmit the request to the NAT gateway that can transmit the request to public Internet 2554. Public Internet 2554 can transmit the request to LB subnet(s) 2522 contained in the control plane VCN 2516 via the Internet gateway 2534. In response to determining the request is valid, the LB subnet(s) can transmit the request to app subnet(s) 2526 that can transmit the request to cloud services 2556 via the service gateway 2536.

It should be appreciated that IaaS architectures 2200, 2300, 2400, 2500 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

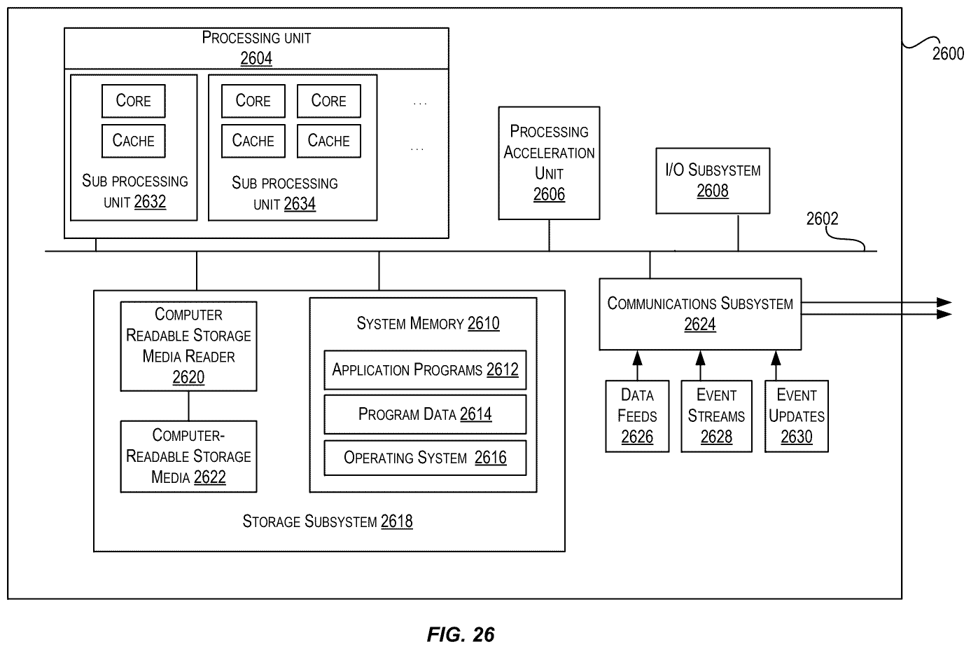

FIG. 26 illustrates an example computer system 2600, in which various embodiments may be implemented. The system 2600 may be used to implement any of the computer systems described above. As shown in the figure, computer system 2600 includes a processing unit 2604 that communicates with a number of peripheral subsystems via a bus subsystem 2602. These peripheral subsystems may include a processing acceleration unit 2606, an I/O subsystem 2608, a storage subsystem 2618 and a communications subsystem 2624. Storage subsystem 2618 includes tangible computer-readable storage media 2622 and a system memory 2610.

Bus subsystem 2602 provides a mechanism for letting the various components and subsystems of computer system 2600 communicate with each other as intended. Although bus subsystem 2602 is shown schematically as a single bus, alternative embodiments of the bus subsystem may utilize multiple buses. Bus subsystem 2602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2604, which can be implemented as one or more integrated circuits (e.g., a conventional microprocessor or microcontroller), controls the operation of computer system 2600. One or more processors may be included in processing unit 2604. These processors may include single core or multicore processors. In certain embodiments, processing unit 2604 may be implemented as one or more independent processing units 2632 and/or 2634 with single or multicore processors included in each processing unit. In other embodiments, processing unit 2604 may also be implemented as a quad-core processing unit formed by integrating two dual-core processors into a single chip.

In various embodiments, processing unit 2604 can execute a variety of programs in response to program code and can maintain multiple concurrently executing programs or processes. At any given time, some or all of the program code to be executed can be resident in processor(s) 2604 and/or in storage subsystem 2618. Through suitable programming, processor(s) 2604 can provide various functionalities described above. Computer system 2600 may additionally include a processing acceleration unit 2606, which can include a digital signal processor (DSP), a special-purpose processor, and/or the like.

I/O subsystem 2608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2600 may comprise a storage subsystem 2618 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2604 provide the functionality described above. Storage subsystem 2618 may also provide a repository for storing data used in accordance with the present disclosure.

As depicted in the example in FIG. 26, storage subsystem 2618 can include various components including a system memory 2610, computer-readable storage media 2622, and a computer readable storage media reader 2620. System memory 2610 may store program instructions that are loadable and executable by processing unit 2604. System memory 2610 may also store data that is used during the execution of the instructions and/or data that is generated during the execution of the program instructions. Various different kinds of programs may be loaded into system memory 2610 including but not limited to client applications, Web browsers, mid-tier applications, relational database management systems (RDBMS), virtual machines, containers, etc.

System memory 2610 may also store an operating system 2616. Examples of operating system 2616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2600 executes one or more virtual machines, the virtual machines along with their guest operating systems (GOSs) may be loaded into system memory 2610 and executed by one or more processors or cores of processing unit 2604.

System memory 2610 can come in different configurations depending upon the type of computer system 2600. For example, system memory 2610 may be volatile memory (such as random-access memory (RAM)) and/or non-volatile memory (such as read-only memory (ROM), flash memory, etc.) Different types of RAM configurations may be provided including a static random-access memory (SRAM), a dynamic random-access memory (DRAM), and others. In some implementations, system memory 2610 may include a basic input/output system (BIOS) containing basic routines that help to transfer information between elements within computer system 2600, such as during start-up.

Computer-readable storage media 2622 may represent remote, local, fixed, and/or removable storage devices plus storage media for temporarily and/or more permanently containing, storing, computer-readable information for use by computer system 2600 including instructions executable by processing unit 2604 of computer system 2600.

Computer-readable storage media 2622 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM

(EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2622 may include, but is not limited to, Zip® drives, flash memory cards, universal serial bus (USB) flash drives, secure digital (SD) cards, DVD disks, digital video tape, and the like. Computer-readable storage media 2622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2600.

Machine-readable instructions executable by one or more processors or cores of processing unit 2604 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2624 provides an interface to other computer systems and networks. Communications subsystem 2624 serves as an interface for receiving data from and transmitting data to other systems from computer system 2600. For example, communications subsystem 2624 may enable computer system 2600 to connect to one or more devices via the Internet. In some embodiments communications subsystem 2624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2624 can provide wired network connectivity (e.g., Ethernet) in addition to or instead of a wireless interface.

In some embodiments, communications subsystem 2624 may also receive input communication in the form of structured and/or unstructured data feeds 2626, event streams 2628, event updates 2630, and the like on behalf of one or more users who may use computer system 2600.

By way of example, communications subsystem 2624 may be configured to receive data feeds 2626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2624 may also be configured to receive data in the form of continuous data streams, which may include event streams 2628 of real-time events and/or event updates 2630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2624 may also be configured to output the structured and/or unstructured data feeds 2626, event streams 2628, event updates 2630, and the like to one or more databases that may be in communication with one or more streaming data source computers coupled to computer system 2600.

Computer system 2600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving, by a proxy service of a first identity realm, a request to perform an operation in a second identity realm, the request comprising identity data associated with a requestor of the request, the identity data indicating a respective identity of the requestor in one or more identity realms;
establishing, by the proxy service of the first identity realm with a proxy service of the second identity realm, a trusted connection;
identifying, by the proxy service of the first identity realm and from the identity data, an identity of the requestor in the second identity realm; and
transmitting, by the proxy service of the first identity realm to the proxy service of the second identity realm, request data indicating the identity of the requestor in the second identity realm and the operation being requested, wherein transmitting the request data causes the proxy service of the second identity realm to generate a resource principal object with which execution of the operation is attempted, the resource principal object corresponding to the identity of the requestor in the second identity realm.

2. The computer-implemented method of claim 1, wherein the proxy service of the first identity realm and the proxy service of the second identity realm are associated with a centralized cross-realm service.

3. The computer-implemented method of claim 2, wherein the trusted connection is established based at least in part on mutual authentication of the proxy service of the first identity realm and the proxy service of the second identity realm, the mutual authentication being performed based at least in part on a credential that is associated with the centralized cross-realm service.

4. The computer-implemented method of claim 1, wherein the trusted connection is established based at least in part on mutual authentication of the proxy service of the first identity realm and the proxy service of the second identity realm, the mutual authentication being performed based at least in part on a credential that is provided by the requestor.

5. The computer-implemented method of claim 1, wherein the proxy service of the second identity realm provides the resource principal object to a second service of the second identity realm, and wherein the second service of the second identity realm authorizes the execution of the operation using the resource principal object generated by the proxy service in the second identity realm.

6. The computer-implemented method of claim 5, further comprising:
receiving, by the proxy service of the first identity realm, the resource principal object generated by the proxy service of the second identity realm; and
providing, by the proxy service of the first identity realm to the requestor, the resource principal object generated by the proxy service of the second identity realm, wherein providing the requestor with the resource principal object configures the requestor to perform subsequent operations with the second service of the second identity realm via an additional trusted connection between the requestor and the second service of the second identity realm.

7. The computer-implemented method of claim 1, wherein the identity data is provided in the request as a map or a custom claim.

8. A computing device, comprising:
one or more processors; and
one or more memories storing computer-executable instructions that, when executed by the one or more processors, cause the one or more processors to:
receive, by a proxy service of a first identity realm that executes at the computing device, a request to perform an operation in a second identity realm, the request comprising identity data associated with a requestor of the request, the identity data indicating a respective identity of the requestor in one or more identity realms;
establish, by the proxy service of the first identity realm with a proxy service of the second identity realm, a trusted connection;
identify, from the identity data, an identity of the requestor in the second identity realm; and
transmit, to the proxy service of the second identity realm, request data indicating the identity of the requestor in the second identity realm and the operation being requested, wherein transmitting the request data causes the proxy service of the second identity realm to generate a resource principal object with which execution of the operation is attempted, the resource principal object corresponding to the identity of the requestor in the second identity realm.

9. The computing device of claim 8, wherein the proxy service of the first identity realm and the proxy service of the second identity realm are associated with a centralized cross-realm service.

10. The computing device of claim 9, wherein the trusted connection is established based at least in part on mutual authentication of the proxy service of the first identity realm and the proxy service of the second identity realm, the mutual authentication being performed based at least in part on a credential that is associated with the centralized cross-realm service.

11. The computing device of claim 8, wherein the trusted connection is established based at least in part on mutual authentication of the proxy service of the first identity realm and the proxy service of the second identity realm, the mutual authentication being performed based at least in part on a credential that is provided by the requestor.

12. The computing device of claim 8, wherein the proxy service of the second identity realm provides the resource principal object to a second service of the second identity realm, and wherein the second service of the second identity realm authorizes the execution of the operation using the resource principal object generated by the proxy service in the second identity realm.

13. The computing device of claim 12, wherein executing the computer-executable instructions further causes the one or more processors to:
receive the resource principal object generated by the proxy service of the second identity realm; and
provide, to the requestor, the resource principal object generated by the proxy service of the second identity realm, wherein providing the requestor with the resource principal object configures the requestor to perform subsequent operations with the second service of the second identity realm via an additional trusted connection between the requestor and the second service of the second identity realm.

14. The computing device of claim 8, wherein the identity data is provided in the request as a map or a custom claim.

15. A non-transitory computer-readable medium storing computer-executable instructions that, when executed by one or more processors of a computing device, cause the one or more processors to:
receive, by a proxy service of a first identity realm that executes at the computing device, a request to perform an operation in a second identity realm, the request comprising identity data associated with a requestor of the request, the identity data indicating a respective identity of the requestor in one or more identity realms;
establish, by the proxy service of the first identity realm with a proxy service of the second identity realm, a trusted connection;
identify, from the identity data, an identity of the requestor in the second identity realm; and
transmit, to the proxy service of the second identity realm, request data indicating the identity of the requestor in the second identity realm and the operation being requested, wherein transmitting the request data causes the proxy service of the second identity realm to generate a resource principal object with which execution of the operation is attempted, the resource principal object corresponding to the identity of the requestor in the second identity realm.

16. The non-transitory computer-readable medium of claim 15, wherein the proxy service of the first identity realm and the proxy service of the second identity realm are associated with a centralized cross-realm service.

17. The non-transitory computer-readable medium of claim 15, wherein the trusted connection is established based at least in part on mutual authentication of the proxy service of the first identity realm and the proxy service of the second identity realm, the mutual authentication being performed based at least in part on a first credential that is associated with a centralized cross-realm service or on a second credential that is provided by the requestor.

18. The non-transitory computer-readable medium of claim 15, wherein the proxy service of the second identity realm provides the resource principal object to a second service of the second identity realm, and wherein the second service of the second identity realm authorizes the execution of the operation using the resource principal object generated by the proxy service in the second identity realm.

19. The non-transitory computer-readable medium of claim 18, wherein executing the computer-executable instructions further causes the one or more processors to:
receive the resource principal object generated by the proxy service of the second identity realm; and
provide, to the requestor, the resource principal object generated by the proxy service of the second identity realm, wherein providing the requestor with the resource principal object configures the requestor to perform subsequent operations with the second service of the second identity realm via an additional trusted connection between the requestor and the second service of the second identity realm.

20. The non-transitory computer-readable medium of claim 15, wherein the identity data is provided in the request as a map or a custom claim.
